(19) United States
(12) Patent Application Publication
(10) Pub. No.: US 2011/0100328 A1
(43) Pub. Date: May 5, 2011

(54) ELECTROLYSIS APPARATUS AND RELATED DEVICES AND METHODS

(75) Inventor: Buddy Ray Paul, Slidell, LA (US)

(73) Assignee: Prime Core Tech LLC.

(21) Appl. No.: 12/909,813

(22) Filed: Oct. 21, 2010

Related U.S. Application Data
(60) Provisional application No. 61/256,129, filed on Oct. 29, 2009.
(60) Provisional application No. 61/258,102, filed on Nov. 4, 2009.
(60) Provisional application No. 61/258,103, filed on Nov. 4, 2009.
(60) Provisional application No. 61/320,380, filed on Apr. 2, 2010.
(60) Provisional application No. 61/321,165, filed on Apr. 6, 2010.

(51) Int. Cl. F02M 69/04; H01G 9/035; H01G 9/145; H01G 9/042; H02J 15/00; H01B 17/14; H02M 7/06; G01N 27/06; C25B 9/00; C25B 15/00; C25B 11/00; C02F 1/461; C25B 1/02; H01M 8/06; H01M 8/22; H01M 12/00; B23B 45/16; F04F 9/00; B05C 9/00; B05D 1/32

(52) U.S. Cl. 123/445; 361/505; 361/504; 307/45; 174/138 R; 363/126; 324/439; 204/242; 204/267; 204/278; 205/334; 204/280; 205/687; 205/742; 205/343; 204/270; 205/628; 429/422; 429/409; 429/502; 429/9; 173/209; 417/159; 118/504; 427/282

(57) ABSTRACT

A cell for use in an electrolysis unit includes a back wall, a side wall extending upwardly from and around a periphery of the back wall to define an inner region of the cell, an electrode disposed on the back wall within the inner region to divide at least a portion of the inner region into first and second regions is disclosed.

### CROSS-REFERENCE TO RELATED APPLICATIONS

This application claims priority to and is based upon U.S. provisional application No. 61/256,129, filed Oct. 29, 2009; U.S. provisional application No. 61/258,102, filed Nov. 4, 2009; U.S. provisional application No. 61/258,103, filed Nov. 4, 2009; U.S. provisional application No. 61/320,380, filed Apr. 2, 2010; and U.S. provisional application No. 61/321,165, filed Apr. 6, 2010, all of which are incorporated herein by reference.

### DESCRIPTION OF THE DISCLOSURE

1. Field of the Disclosure

This application relates to electrolysis apparatus and related devices and methods.

2. Background

Electrolysis may be used to produce gases via electrochemical reactions. For example, electrolysis of water will result in hydrogen and oxygen gas production. Electrolysis to produce hydrogen and oxygen is known in the art to involve several chemical reactions that can be expressed by the following equations:

Cathode (reduction): 2H₂O(l)+2e⁻→H₂(g)+2OH⁻(aq)

Anode (oxidation): 4OH⁻(aq)→O₂(g)+2H₂O(l)+4e⁻

Overall reaction: 2H₂O(l)→2H₂(g)+O₂(g).

FIG. 1 illustrates this set of reactions. A voltage supply 111 provides a positive potential to a cathode electrode 113 and a negative potential to an anode electrode 115 during electrolysis of a solution 117, for example, a water based solution further including an electrolyte, to facilitate the reactions. Hydrogen 119 is produced at cathode electrode 113 and oxygen 121 is produced at anode electrode 115. When electrolytes (e.g., salt) are present in the water, the production of hydrogen is improved due to the higher rate of transfer of electrons via the electrolytes, i.e., the conductivity of the electrolyte solution 117 is increased which facilitates electron flow necessary to complete the reactions during electrolysis.

Inexpensive and reliable hydrogen production is a prerequisite for moving from a petroleum-based to a hydrogen-based economy. Compression of hydrogen is cumbersome and energy intensive. An on demand hydrogen production provides safety advantages by minimizing transportation requirements, which reduces costs associated with production and then storage of compressed hydrogen. Production of on demand hydrogen using, for example, electrolysis to produce hydrogen and oxygen has historically failed to provide economically feasible production. Also, prior art methods have focused on the production and storage of hydrogen produced during electrolysis, rather than on hydrogen on demand. The need exists for reliable and cost effective production of gases, such as hydrogen and oxygen, using efficient, on demand apparatus. With such production, hydrogen and oxygen, as well as other gases, may be inexpensively and safely produced to be utilized in a multitude of applications.

### SUMMARY

In accordance with the disclosure, a cell for use in an electrolysis unit, comprising a back wall, a side wall extending upwardly from and around a periphery of the back wall to define an inner region of the cell, an electrode disposed on the back wall within the inner region to divide at least a portion of the inner region into first and second regions is provided.

An electrolysis unit comprising a first electrode having a first side and a second side, a second electrode having a first side and a second side, and a cell wall structure that defines first confined regions respectively adjacent the first sides of the first and second electrodes, the first confined regions having an opening therebetween, and second confined regions respectively adjacent the second sides of the first and second electrodes, the second confined regions being isolated from each other is also provided.

A method for producing a first gas and a second gas using a unit, the method comprising providing the unit including a first electrode in a first chamber, the first chamber having slots, a second electrode provided to a second chamber, and a conductive solution capable of being electrolyzed, wherein the first chamber and second chamber are provided adjacent to each other such that the solution can pass through the slots to contact both the first and second electrodes, and applying a voltage across the first and second electrodes to electrolyze the solution to produce the first and second gases, wherein the solution acts as an electrically conductive path is also provided.

A unit cell, the cell comprising a plurality of chambers including a first chamber including a cathode electrode coupled to a first terminal for providing a first electrical connection to the cell, a second chamber including an anode electrode connected to a second terminal for providing a second electrical connection to the cell, and a third chamber, provided between the first chamber and second chamber, the third chamber configured to confine a conductive solution to provide an electrically conductive path through the conductive solution and connection between the anode electrode and the cathode electrode, so that when a voltage is applied across the first terminal and second terminal and the conductive solution is provided in the third chamber, the conductive solution is electrolyzed to produce hydrogen and oxygen is provided.

A method of operating a unit for producing hydrogen and oxygen, the method comprising confining a conductive solution, capable of being electrolyzed, between a first electrode and a second electrode, applying a voltage across the first electrode and second electrode to electrolyze the solution to produce hydrogen and oxygen, and channeling the hydrogen and oxygen produced by the electrolyzed solution out of the unit, wherein the solution provides an electrically conductive path between the first and second electrodes is provided.

A method of obtaining power from a unit capable of generating and storing hydrogen and oxygen, the method comprising confining a conductive solution, capable of being electrolyzed, between a first electrode and a second electrode, the solution providing a conductive path between the first and second electrodes, each of the first and second electrodes having a cavity, applying a voltage across the first and second electrodes to electrolyze the solution and produce hydrogen and oxygen, storing the produced hydrogen and oxygen within the cavity in the first and second electrodes, respectively, removing the applied voltage, and applying an electrical load to the unit to power the load by a reverse electrolysis process driven by the stored hydrogen and oxygen is provided.

An electrode for use in a unit for storing a first gas and a second gas, the electrode comprising a first plurality of notches provided in a first side of the electrode for receiving the first gas, and a second plurality of notches provided in second side of the electrode for receiving the second gas is provided.

A deposition system for forming a structure on a substrate capable of receiving the structure, comprising a window having a two-dimensional shape consistent with a desired shape of the structure, and a deposition system for providing material used to form the structure, the deposition system being masked by the window on one side is provided.

A method for forming a structure using a deposition method, comprising forming a window having a shape consistent with a desired shape of the structure, masking a deposition system providing a material for forming the structure with the window, providing a substrate capable of receiving the structure, and depositing the material through the window for a time sufficient to form a desired thickness of the structure is provided.

An electrolyte amperage meter comprising a test chamber for receiving a conductive solution and having a known volume, electrically conductive terminals for receiving a voltage source to apply a known voltage across the test chamber, and an amperage meter having probes provided within the test chamber to contact the conductive solution when disposed therein, and to measure a magnitude of current flow through the conductive solution when disposed in the test chamber when the known voltage is applied, wherein a concentration of a foreign matter present in the conductive solution is determinable from the known volume, the known voltage, and the current magnitude measured by the amperage meter is provided.

A method of determining concentration of a foreign matter present within a conductive solution, comprising providing a conductive solution to a test chamber, the test chamber having a known volume, providing a voltage source to apply a known voltage across the test chamber, providing probes within the test chamber to contact the conductive solution, providing an amperage meter, connected to the probes provided in contact with the conductive solution, for measuring a magnitude of current flowing through the conductive solution, calculating a resistance of the conductive solution from the known volume, known voltage, and the measured current magnitude, and converting the resistance to a concentration of the foreign matter present within the conductive solution is provided.

An internal combustion engine, comprising a combustion chamber including, a hydrogen injector, an oxygen injector, a water ejector, and a spark plug configured to initiate combustion of a mixture of hydrogen and oxygen in the combustion chamber is provided.

An internal combustion engine method, comprising supplying hydrogen to a combustion chamber, supplying oxygen to a combustion chamber, and initiating combustion of a mixture of only hydrogen and oxygen supplied to the combustion chamber is provided.

A combustion chamber fluid pump, comprising a combustion chamber having a fluid provided therein, a supply tube for providing a combustible gas within the combustion chamber, an ignition source for igniting the gas provided to the combustion chamber, a neck portion in communication with the combustion chamber and having a first and a second check valve, the first check valve for coupling to a fluid supply to supply fluid to the neck portion via the first check valve and thereby supply fluid to the combustion chamber, and the second check valve for coupling to a fluid reservoir for receiving fluid flowing through the neck portion from the combustion chamber when combustible gas is provided in the combustion chamber and ignited is provided.

A method of operating a combustion chamber fluid pump, comprising providing a fluid within a combustion chamber, providing a combustible gas to the combustion chamber, providing an ignition source for igniting the combustible gas in the combustion chamber, igniting the gas to produce a heat wave that forces fluid through a neck portion attached to the combustion chamber and further through a first one-way valve to a fluid reservoir, and providing fluid from a fluid supply to the combustion chamber via a second one-way valve is provided.

A desalinization unit, comprising a first electrode and a second electrode for receiving a voltage applied there across, a tap to provide a supply of sea water between the first and second electrodes, wherein the sea water is capable of providing a conductive path between the first and second electrodes, and a collector for collecting matter precipitated out of the sea water when the voltage is applied across the first and second electrodes, wherein the collector is a removable portion of the unit is provided.

A method of operating a unit for removing foreign matter from a conductive solution, comprising providing a first electrode and a second electrode capable of a voltage, providing a conductive solution containing between the first and second electrodes, wherein the solution provides a conductive path between the first and second electrodes, applying a voltage across the first and second electrodes, precipitating out the foreign matter within the solution by electrolyzing the solution due to the voltage applied across the first and second electrodes, and collecting the foreign matter from the unit is provided.

A hydrogen filling station, comprising a unit capable of producing on demand hydrogen including a plurality of anode-cathode electrode pairs, a conductive solution confined between the plurality of electrode pairs and providing a conductive path therebetween, and a voltage supply for supplying a voltage across the electrode pairs to electrolyze the solution and produce on demand hydrogen, and a filling means coupled to the unit for receiving hydrogen produced by the unit is provided.

A method of producing a nitrogen rich compound, comprising operating an electrolysis unit to produce hydrogen, providing hydrogen and air to an engine, combusting the hydrogen and air within the engine, capturing an exhaust from the engine, and extracting the nitrogen rich compound from the exhaust is provided.

An oxygen generator, comprising a fuel cell, a unit capable of electrolyzing a conductive solution, and an oxygen line, wherein the fuel cell is configured to provide electricity to the unit and the unit is configured to provide hydrogen to the fuel cell and oxygen to the oxygen line is provided.

A method for operating an oxygen generator, comprising configuring a unit capable of electrolyzing a conductive solution to produce hydrogen and oxygen, supplying a fuel cell with the hydrogen produced by the unit and configuring the fuel cell to provide electrical power to the unit, and providing oxygen from the unit to an oxygen line is provided.

A system for load leveling an electrical grid, comprising a controller, and a unit configured to store hydrogen and oxygen and capable of supplying power when the hydrogen and oxygen recombine, wherein the controller is connected to the grid and the unit and the controller directs power to the unit when demand on the grid is low is provided.

A method for operating a system for load leveling an electrical grid, comprising monitoring an electrical demand on the grid, directing power to a unit capable of electrolyzing and storing hydrogen and oxygen when a demand on the grid is low, and supplying power to the grid from the unit when demand on the grid is high is provided.

A system, comprising a unit configured to produce electrical power using stored hydrogen and oxygen, and a power supply configured to provide power to the unit is provided.

An method of operating a system, comprising configuring a first unit to produce electrical power by reverse electrolysis of stored hydrogen and oxygen, supplying power to the first unit from a power supply and storing power therein, configuring a second unit to produce hydrogen and oxygen, powering the second unit using power stored by the first unit, and providing hydrogen and oxygen from the second unit to a load is provided.

An impact accelerator, comprising a housing including a combustion chamber including a hydrogen injector, and an oxygen injector, and a reciprocating hammer, and an anvil located at an end of the housing to receive an impact from the hammer resulting from combustion of hydrogen and oxygen provided to the combustion chamber by the hydrogen and oxygen injectors is provided.

A method of operating an impact accelerator, comprising providing a housing including a combustion chamber including an end plate, the end plate having openings for a hydrogen injector for providing hydrogen, and an oxygen injector for providing oxygen, a reciprocating hammer, and an anvil located to receive an impact from the hammer, combusting hydrogen and oxygen in the combustion chamber in a manner to cause the hammer to impact the anvil, and injecting hydrogen and oxygen after the hammer impacts the anvil to prevent the hammer from striking the end plate is provided.

An accelerator generator, comprising a housing including a first combustion chamber including a first hydrogen injector, and a first oxygen injector, a second combustion chamber including a second hydrogen injector, and a second oxygen injector, a reciprocating hammer, and a toroidal coil located to magnetically couple with the reciprocating hammer such that an electrical output is produced when the hammer is forced through the toroidal coil by combustion occurring in the first and second combustion chambers is provided.

A method of operating an accelerator generator, comprising providing a housing including a first combustion chamber including a first hydrogen injector, and a first oxygen injector, and a second combustion chamber including a second hydrogen injector, and a second oxygen injector, providing a reciprocating hammer formed of magnetic material within the housing between the first and second chamber, and providing a toroidal coil, such that the coil is magnetically coupled with the hammer when the hammer passes through the coil, providing hydrogen and oxygen within the first combustion chamber, and igniting the hydrogen and oxygen to propel the hammer towards the second combustion chamber and through the coil to produce electricity within the coil is provided.

An impact accelerator generator, comprising a housing including a combustion chamber including a hydrogen injector, and a oxygen injector, and a second combustion chamber including a second hydrogen injector, and a second oxygen injector, a reciprocating hammer, and a toroidal coil located to magnetically couple with the reciprocating hammer such that an electrical output is produced by the coil when the hammer is forced through the toroidal coil by combustions occurring in the first and second combustion chambers is provided.

A method of operating an impact accelerator generator, comprising providing a housing including a combustion chamber including a hydrogen injector, and an oxygen injector, and a reciprocating hammer, and providing a toroidal coil, such that the coil is magnetically coupled with the hammer when the hammer passes through the coil, providing hydrogen and oxygen within the combustion chamber, and igniting the hydrogen and oxygen to propel the hammer through the coil to produce electricity within the coil is provided.

A capacitor, comprising a plurality of electrodes, a conductive solution providing a conductive path between the plurality of electrodes, and a first terminal and a second terminal providing a voltage across the plurality of electrodes is provided.

A cell for use in a unit for producing a gas, comprising a back wall, a side wall extending upwardly from and around a periphery of the back wall to define an inner region of the cell, a first electrode and a second electrode each disposed in the back wall and within the inner region, the first electrode being spaced apart from the second electrode, a first ridge disposed on the back wall and extending from an end portion of the first ridge, a second ridge disposed on the back wall and extending from an end portion of the second ridge, the first ridge being spaced apart from the second ridge.

An electrode for use in an electrolysis unit, the unit including a plurality of electrodes arranged in sequence, the electrode comprising an electrode body having first and second adjacent through holes formed therein for passage therethrough of a fluid contained, and a notch communicating between one of the holes and an edge of the body for receiving the fluid.

An electrical insulator for use in an electrolysis unit, the unit including at least two electrodes in contact with and separated by the insulator, each of the two electrodes having first and second adjacent through holes formed therein, the insulator comprising an insulator body having a cross section generally corresponding to a cross section of the electrodes and having left side and right side portions, wherein the insulator body includes at least one pass-through orifice in one of the left side and right side portions and no pass-through orifice in the other of the left side and right side portions.

A voltage doubler circuit, comprising a transformer including a primary winding and a secondary winding, a first rectifier having first and second input terminals and positive and negative output terminals, a second rectifier having first and second input terminals and positive and negative output terminals, a first capacitor having first and second ends, a second capacitor having first and second ends, a third capacitor having first and second ends, a fourth capacitor having first and second ends, the second end of the first capacitor coupled to the first end of the second capacitor and to a second end of the transformer primary winding and the second input terminal of the first rectifier, the second end of the third capacitor coupled to the first end of the fourth capacitor and to a first end of the transformer secondary winding and the second input terminal of the second rectifier, a first end of the transformer primary winding for coupling to a first terminal of an AC input line and the first input terminal of the first rectifier for coupling to a second terminal of the AC input line, the first end of the first capacitor and the second end of the second capacitor respectively coupled to the positive and negative output terminals of the first rectifier, the first end of the third capacitor and the second end of the fourth capacitor respectively coupled to the positive and negative output terminals of the second rectifier, an electrolysis device having positive and negative terminals, a first diode being forward conductive from an anode terminal to a cathode terminal, the first diode cathode coupled to the positive terminal of the electrolysis device and the first diode anode coupled to the first end of the first capacitor and the positive terminal of the first rectifier, and a second diode being forward conductive from an anode terminal to a cathode terminal, the second diode cathode coupled to the positive terminal of the electrolysis device and the second diode anode coupled to the first end of the third capacitor and the positive terminal of the second rectifier is provided.

A driver circuit for driving electrolysis devices, comprising a first transformer including a primary winding and a secondary winding, a second transformer including a primary winding and a secondary winding, a first rectifier having first and second input terminals and positive and negative output terminals, a second rectifier having first and second input terminals and positive and negative output terminals, an electrical load having first and second terminals, an electrolysis device having positive and negative terminals, the first and second inputs of the first rectifier coupled between first and second ends of the first transformer secondary winding, respectively, the first and second inputs of the second rectifier coupled between first and second ends of the second transformer secondary winding, respectively, a first diode being forward conductive from an anode terminal to a cathode terminal, the first diode anode terminal for coupling to a first terminal of an AC power supply, the first diode cathode terminal coupled to a first end of the first transformer primary winding, a second diode being forward conductive from an anode terminal to a cathode terminal, a third diode being forward conductive from an anode terminal to a cathode terminal, the third diode cathode terminal coupled to the electrical load second terminal, the third diode anode terminal coupled to a second end of the first transformer primary winding and the anode of the second diode, the cathode of the second diode coupled to the first end of the first transformer primary winding, a fourth diode being forward conductive from an anode terminal to a cathode terminal, the cathode terminal of the fourth diode for coupling to the first terminal of the AC power supply, the anode terminal of the fourth diode coupled to a first end of the second transformer primary winding, a fifth diode being forward conductive from an anode terminal to a cathode terminal, a sixth diode being forward conductive from an anode terminal to a cathode terminal, the cathode terminal of the sixth diode coupled to a second end of the second transformer primary winding and to the cathode terminal of the fifth diode, the anode terminal of the sixth diode coupled to the second terminal of the electrical load, the anode terminal of the fifth diode coupled to the first end of the second transformer primary winding, the first terminal of the electrical load for coupling to a second terminal of the AC power supply, and the positive and negative terminals of the second electrolysis device respectively coupled to the first rectifier positive output terminal and the second rectifier negative output terminal is provided. An impact accelerator method, comprising supplying hydrogen to a combustion chamber, supplying oxygen to a combustion chamber, initiating combustion of a mixture of the hydrogen and oxygen supplied to the combustion chamber to force a hammer element against an anvil of the impact accelerator is provided.

A combustion chamber pump method, comprising supplying at least one combustible fluid to a combustion chamber, and initiating combustion of the combustible fluid supplied to the combustion chamber to force pumping fluid out of a pumping chamber is provided.

A combustion chamber pump, comprising a combustion chamber including at least one working fluid inlet, and an ignition source, and a pumping chamber including a pumping fluid inlet, and a pumping fluid outlet is provided.

An impact accelerator, comprising an housing including a combustion chamber including, a hydrogen injector, and an oxygen injector, a reciprocating hammer element, and an anvil located to receive an impact from the hammer resulting from combustion of only hydrogen and oxygen in the combustion chamber is provided.

Additional features and advantages of the disclosure will be set forth in part in the description which follows, and in part will be obvious from the description, or may be learned by practice. The features and advantages will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate embodiments of the disclosure and together with the description, serve to explain the principles of the invention.

### BRIEF DESCRIPTION OF THE DRAWINGS

FIG. 1 illustrates a set of reactions.

FIGS. 2A and 2B illustrate a unit from different orientations.

FIGS. 2C and 2D illustrate the inner working of an exemplary cell.

FIG. 3A illustrates an exploded view of an exemplary cell.

FIGS. 3B and 3C illustrate exemplary methods related to the assembly of a cell.

FIGS. 4A-4E provide additional detail of parts forming the subchambers comprising a cell.

FIGS. 5A and 5B illustrate exemplary methods of filling a cell.

FIGS. 5C-5F illustrate details of chambers of an exemplary cell.

FIG. 5G illustrates additional detail of a ridge.

FIG. 5H illustrates an exemplary clip.

FIGS. 6A-6B illustrate an electrolyte amp meter and methods of operating the same.

FIG. 7 illustrates an exemplary gas equilibrium sensor.

FIGS. 8A-8F illustrate exemplary electrodes and manufacturing methods of the same.

FIGS. 9A-9E illustrate exemplary modes of operation of a cell.

FIGS. 10A-10D illustrate an exemplary multi-electrode cell unit.

FIGS. 11A-11E illustrate an exemplary bore model cell unit.

FIG. 12A illustrates an exemplary internal combustion engine.

FIG. 12B illustrates an exemplary internal combustion engine used as a prime mover for a mobile machine.

FIG. 12C illustrates an exemplary embodiment of an internal combustion engine.

FIGS. 13A-13E illustrate a power cycle of operation of an exemplary internal combustion engine.

FIGS. 13F-13H illustrate a collection of cycle charts for an exemplary internal combustion engine.

FIGS. 14A and 14B illustrate a multi-chambered internal combustion engine.

FIGS. 15A-15H illustrate a power cycle of operation of a multi-chambered internal combustion engine.

FIGS. 16A-16B illustrate an exemplary combination of elements to form a power generation system.

FIGS. 17A-17C illustrates a combustion chamber fluid pump and a method of operating the same.

FIG. 18A-18G illustrate various combinations and modifications of exemplary embodiments discussed herein and methods and application thereof.

FIGS. 19A-19I illustrate numerous exemplary embodiments using cells in combination with various other exemplary embodiments illustrated in this disclosure.

FIGS. 20A-20O illustrate various exemplary electrical device configurations and circuits for the operation of the exemplary units are illustrated herein.

FIGS. 21A-21C illustrate an exemplary impact accelerator and the operation thereof.

FIGS. 22A and 22B illustrate an exemplary impact accelerator generator, its various components, and operation.

FIG. 23 illustrates an exemplary impact accelerator generator and the operation thereof.

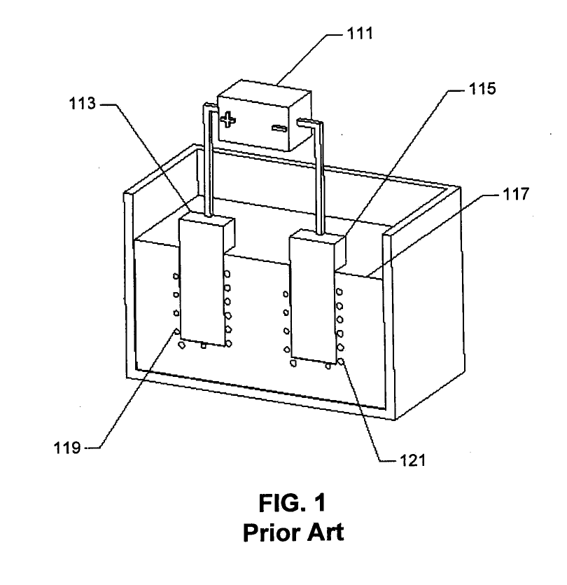

### DESCRIPTION OF THE EMBODIMENTS

Reference will now be made in detail to exemplary embodiments, examples of which are illustrated in the accompanying drawings. Wherever possible, the same reference numbers will be used throughout the drawings to refer to the same or like parts.

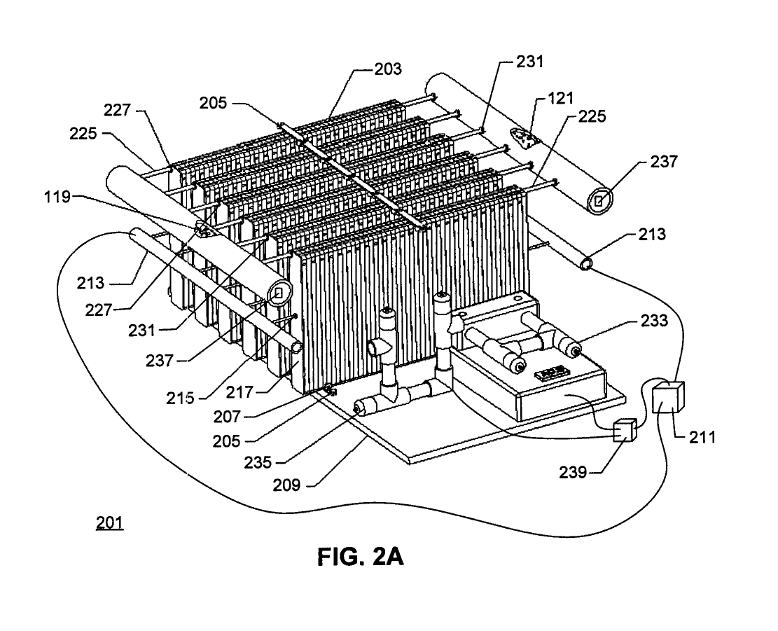

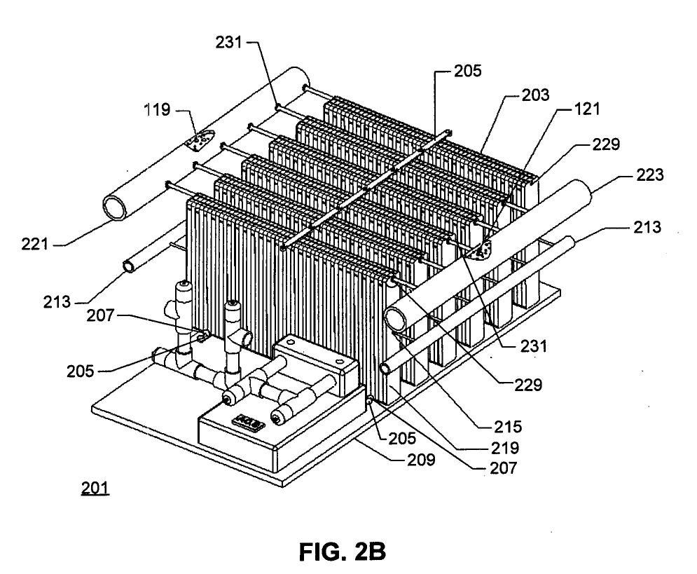

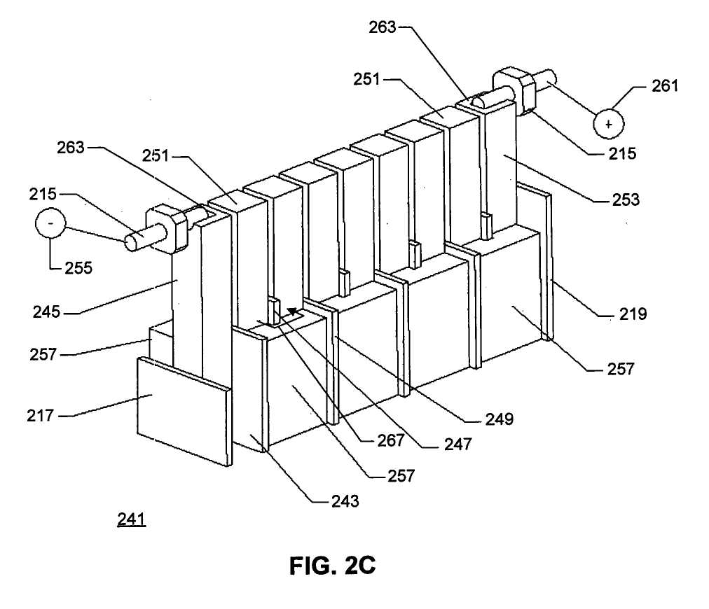

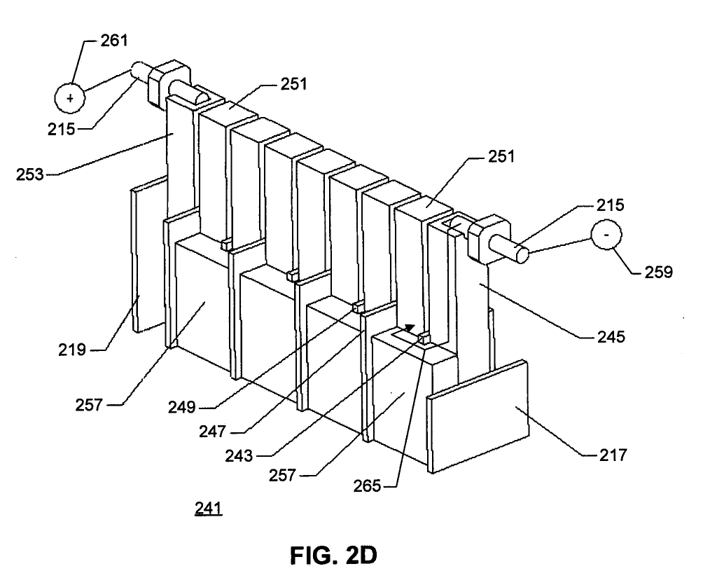

FIGS. 2A and 2B illustrate a unit 201 from different orientations. Unit 201 includes a plurality of cells 203 having a single electrode configuration. Cells 203 are clipped together using clips 205, which are provided, for example, along a single row provided on the top of cells 203 and two rows running along the bottom of cells 203 near the edges of cells 203. An additional securing means 207, for example a screw or similar fastener, may also be provided to secure clips 205 to a base plate 209.

With further reference to FIGS. 2A and 2B, a voltage is provided to cells 203 during operation of unit 201. For example, the appropriate voltage may be provided by a voltage source 211 and applied over bus bars 213 that are electrically connected to cells 203 via connection terminals 215. Terminals 215 are provided in contact with end plates of cells 203, for example, a cathode cap 217 and an anode endchamber 219. Bus bars 213 and terminals 215, and any additional electrical wiring required for connections therebetween, may be formed of any electrically conductive material, such as copper or aluminum. Alternatively, terminals 215 may be formed of brass.

When the appropriate voltage is supplied by voltage source 211 to unit 201, while cells 203 contain a suitable conductive solution, a first gas and a second gas, for example, hydrogen 119 and oxygen 121 gases, will be generated within cells 203. With further reference to FIGS. 2A and 2B, hydrogen 119 may be collected from within cells 203 and channeled via a hydrogen collection tube 221. Oxygen 121 may be collected from within cells 203 and channeled via an oxygen collection tube 223. In the exemplary embodiment illustrated in FIGS. 2A and 2B, hydrogen 119 and oxygen 121 may be channeled from cells 203 via tubing 225 that connects cells 203 with hydrogen collection tube 221 and oxygen collection tube 223 (collectively referred to as the “collection tubes” herein). In particular, tubing 225 is provided between a hydrogen connection orifice 227 provided on cathode cap 217, which forms part of one of cells 203, and hydrogen collection tube 221. Tubing 225 is also provided between an oxygen connection orifice 229 provided on anode endchamber 219, which forms another part of one of cells 203, and oxygen collection tube 223. Hydrogen connection orifice 227 and oxygen connection orifice 229 are also referred to as the “connection orifices” or “connection orifice” in the discussion herein. Tubing 225 may be provided through exemplary washers 231, which provide a seal at the interface of tubing 225 with connection orifices 227 and 229 and collection tubes 221 and 223.

During the operation of unit 201, a conductive solution capable of being electrolyzed is present in cells 203 and is electrolyzed to produce hydrogen and oxygen. The resistance of the conductive solution may be monitored to maintain a desired concentration of electrolyte within the solution. In addition, the pressure of gases produced by unit 201 may be monitored. Again with reference to FIGS. 2A and 2B, an electrolyte amp meter (EAM) 233 may be provided to monitor the electrolyte concentration within the conductive solution. For example, during operation of unit 201 the conductive solution provided within cells 203 may also be provided to EAM 233 by a tap (not shown) provided to cells 203. A gas equilibrium sensor (GES) 235 may be connected (not shown), for example, to collection tubes 221 and 223 to monitor the relative pressures of the gases produced by cells 203. In addition, a gas flow or pressure monitoring means 237 may be provided, for example, within collection tubes 221 and 223 to monitor the flow and/or pressure of, for example hydrogen 119 and oxygen 121 during operation of unit 201. Voltage source 211, EAM 233, GES 235, and monitoring means 237 may all be connected or provide information to a controlling means 239, such as a computer or another appropriate combination of hardware and/or software, which can control operation of unit 201.

FIGS. 2C and 2D illustrate the inner working of an exemplary single cell 241 of cells 203 and illustrate perspectives of cell 241 from opposite sides with various portions of the cell walls omitted for clarity. Moving from left to right in FIG. 2C, cathode cap 217 is provided adjacent to a cathode endchamber 243, with a cathode electrode 245 disposed therebetween. Cathode-anode midchambers 247 (generically referred to as “midchamber 247” or “midchambers 247” herein) and anode-cathode midchambers 249 (generically referred to as “midchamber 249” or “midchambers 249” herein) are arranged alternatively. Midchambers 247 and 249 are provided in combination to comprise the bulk of the internal chambers of cell 241. Midchambers 247 and 249 are also provided so as to sandwich electrodes 251. At the opposite end of cell 241, an anode electrode 253 is provided adjacent to anode endchamber 219. A conductive solution 257, for example, a mixture of water and electrolyte (e.g., salt) is provided within cell 241, and is confined within the subchambers formed by cathode cap 217, endchamber 243, the plurality of midchambers 247 and 249, and anode endchamber 219, as illustrated in FIGS. 2C and 2D.

Conductive solution 257 may be any of a number of suitable solutions. For example, water may be used as conductive solution 257. An exemplary conductive solution 257 including an electrolyte may be a solution including water and an electrolyte, which comprises 30% by weight NaCl, dissolved in the water. Such solution may be used to obtain high efficiency hydrogen and oxygen production by unit 201. Other conductive solutions 257 will now be apparent to one of ordinary skill in the art based on desired operating conditions and output of cell 241. For example, alternative electrolytes, such as potassium, sodium, lye, or other electrolytes known to one of ordinary skill in the art may also be used. Such electrolytes should be dissolvable in water to form the conductive solution. Other dissolving liquids besides water may alternatively be used to form the conductive solution.

As discussed above, a voltage is applied over cell 241 during operation of unit 201. With further reference to FIGS. 2A-2D, voltage source 211 provides potentials to cathode electrode 245 and anode electrode 253 via terminals 215. For example, exemplary negative potential 259 and positive potential 261 are illustrated symbolically in FIGS. 2C and 2D. Terminals 215 may be provided to, for example, orifices 263 formed within electrodes 245 and 253. Orifices 263 may, for example, be threaded to receive appropriately threaded terminals 215. Alternatively, orifices 263 may be prepared to receive needle or spring-type formed terminals 215.

The voltage applied across terminals 215 results in current flowing within cell 241. The current will flow through a portion of the inner regions of the cell subchambers and through confined regions between adjacent electrodes that share an opening. For example, current will flow from cathode electrode 245, through conductive solution 257, into the nearest side of one of electrodes 251, symbolically illustrated as arrow 265 in FIG. 2D. Current will then continue to flow through the opposite side of the nearest side of the one of electrodes 251 through conductive solution 257 to the higher potential side (i.e., more positive side) of a next one of electrodes 251, symbolically illustrated as arrow 267 in FIG. 2C. Current will continue to flow through cell 241 in a similar manner, flowing from lower potential sides to higher potential sides of successive electrodes 251, using conductive solution 257 as a conductive path. The path of current flow reaches anode electrode 253, and exits cell 241 via terminal 215.

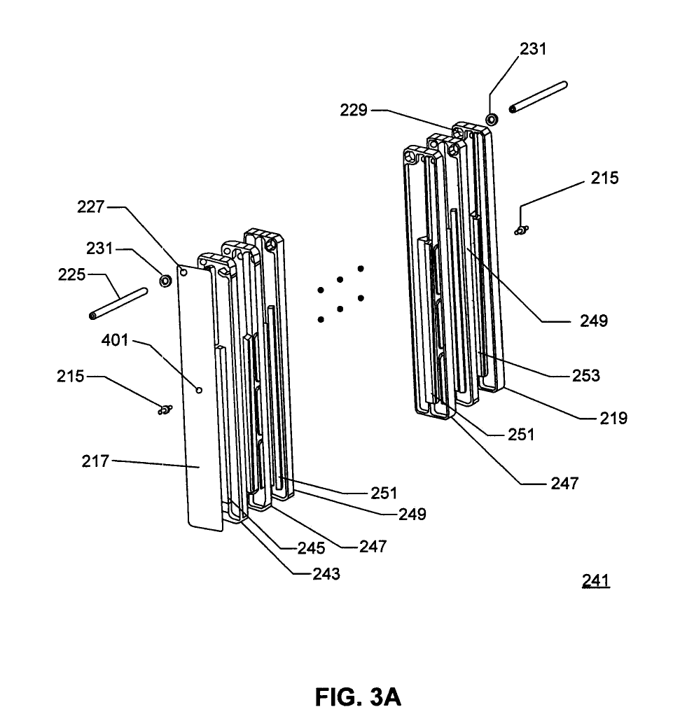

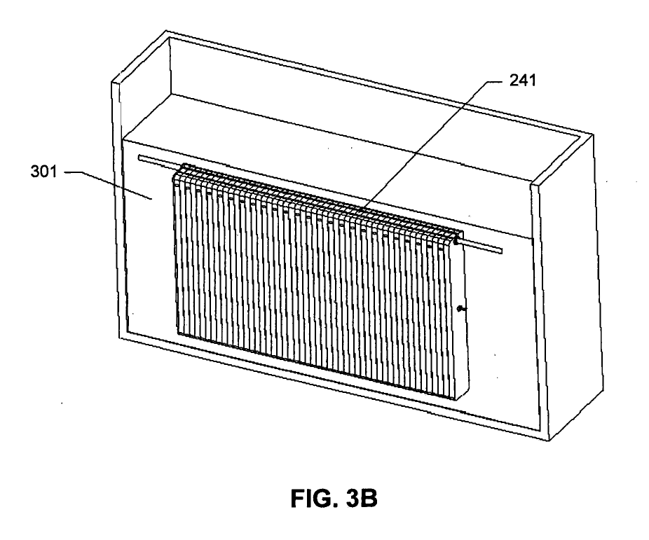

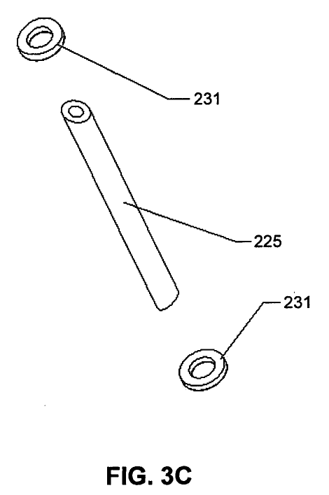

Additional discussion regarding cell 241 is provided with reference to FIGS. 3A-3C.

FIG. 3A illustrates an exploded view of exemplary cell 241. Moving from left to right, tubing 225 is connected to hydrogen connection orifice 227, with one of washers 231 provided to seal the connection. Cell 241 includes cathode cap 217 and cathode endchamber 243 that sandwich cathode electrode 245. Cathode endchamber 243 is provided adjacent to a first one of the plurality of alternatively provided cathode-anode midchambers 247 and anode-cathode midchambers 249, that form some of the subchambers. Electrodes 251 are provided between pairs of adjacent cathode-anode midchambers 247 and anode-cathode midchambers 249 to form a bulk of cell 241. Electrodes 251 are electrically connected to adjacent electrodes 251 via conductive solution 257. At the opposite end of cell 241, a final one of cathode-anode midchambers 247 is provided adjacent to anode endchamber 219, so as to sandwich anode electrode 253 therebetween. Tubing 225 is provided to oxygen connection orifice 229 provided in anode endchamber 219 and one of washers 231 is provided to seal the connection.

Cell 241 may be formed to have any desired number of subchambers by employing an appropriate number of cathode-anode midchambers 247 and anode-cathode midchambers 249, by providing a corresponding number of electrodes 251 therein, and by applying an appropriate voltage to cell 241 to achieve desired the operation. The number of subchambers illustrated herein is merely exemplary.

Terminals 215 are provided at each end of cell 241 and connect to the first and last electrode of the cell 241, for example, cathode electrode 245 and anode electrode 253. It will be apparent from the figures and description herein that the connection terminals 215 provide connections to bus bars 213, but that conductive solution 257, which may be any conductive solution capable of being electrolyzed, provides the electrical connection between electrodes disposed within cell 241.

It will further be apparent from FIGS. 2C, 2D, and 3A that electrodes 251 may operate as both cathode and electrode during operation of cell 241. In particular, in the exemplary cells 241 of unit 201 having the single electrode configuration, the first and last electrodes of the cell 241, respectively being the cathode electrode 245 and anode electrode 253, may be the only electrodes electrically connected to the bus bars 213 via the terminals 215. The remainder of the electrodes provided within cell 241 may be electrically connected via electrolyte solution 257. Thus, electrodes 251 function as complementary anode and cathode electrodes based on their relative potential to other adjacent electrodes 251.

Except for the various electrodes, cell 241 and its components may be formed of any non-conductive material that can withstand the operating pressure and temperatures required during operation of cell 241. For example, cell 241 and its components may be formed of Acrylonitrile Butadiene Styrene (ABS) material. When cell 241 is so formed, cell 241 may be operated at pressures between −5 to +5 PSI and up to temperatures of approximately 190° F. For example, when cell 241 is formed of ABS material it may be operated at a pressure of −2 PSI and operating temperature of approximately 130° F. In another embodiment, cell 241 may be formed of a ceramic material, particularly when higher operating temperature and/or operating pressure requirements are present. When cell 241 is formed of ceramic material, operation may generally be conducted at pressures between −10 to +30 PSI and up to temperatures of approximately 1000° F. One of ordinary skill in the art will now realize that any non-conducting material may be a material suitable for forming cell 241. It will also now be apparent to one of ordinary skill in the art that depending on the selection of the material for cell 241, different tubing and sealing methods and device may be required, as dictated by operating temperature and pressure, without departing from the scope of the exemplary embodiments discussed herein.

FIGS. 3B and 3C illustrate exemplary methods related to the assembly of cell 241. FIG. 3B illustrates an exemplary sealing process of cell 241. Once cell 241 is assembled, a sealing coat is applied to cell 241 to prevent pressure leaks and improve system integrity. In this embodiment, a coating seal solution 301 is provided in a tank and cell 241 is immersed therein. A thin coat of coating seal solution 301 remains on cell 241 after cell 241 is removed from the tank, thus sealing cell 241. When cell 241 is formed of ABS material, coating seal solution 301 may be a solution of 10% ABS by weight concentration dissolved in Methyl Ethyl Ketone (“MEK”, collectively “MEKABS 10”) used to seal and coat, for example, all ABS material parts. Coating seal solution 301 may alternatively be applied via a spray or other methods. If cell 241 is formed of a ceramic material, a glaze including powered glass may instead be applied and baked to form the coating seal. One of ordinary skill in the art will now understand that other combinations of suitable materials and solvents may comprise the coating seal.

FIG. 3C illustrates tubing 225 and washers 231. Each section of tubing 225 may be inserted through washers 231 to seal orifices and provide a suitable means of conveying produced gases to their respective collection tubes 221 and 223. As discussed above, tubing 225 and washers 231 are provided in combination to provide a seal at the interface of tubing 225 with orifices 227 and 229 and collection tubes 221 and 223. For example, washers 231 may be provided abutted to orifices 227 and 229 and collection tubes 221 and 223, such that tubing 225 passes through washers 231.

Each orifice 227 and 229 of cell 241 may, for example, be provided with washers 231 that are affixed, e.g., by plastic welding or glued using a chemically reactive glue that atomically bonds the washer in place, around orifices 227 and 229. Washers 231 may be, for example, a bottom flat ABS washer secured using 2% ABS by weight concentration dissolved in Methyl Ethyl Ketone solvent (MEK) (collectively “MEKABS-2”). Other washers 231 may be welded or glued to collection tubes 221 and 223. Other exemplary ABS washers may be used to facilitate sealing. For example, a flat washer may be used to provide a seal for flat surfaces, such as against a cell end plate. In addition, a convex or concave shaped washer may be used to create the seal when a concave or convex receptacle, e.g., orifice, is provided for washers 231 on an outside wall of cell 241 or collection tubes 221 and/or 223. As discussed above, cells 241, orifices 227 and 229, tubing 225, and collection tubes 221 and 223, may be coated with a coating seal solution 301 after assembly, as illustrated in FIG. 3B. One of ordinary skill in the art will now understand that other combinations of suitable materials, solvents, and methods for affixing may be used without deviating from the scope of the disclosure. For example, materials, solvents, and methods for affixing consistent with ceramic materials may be used to secure washers 231 when cell 241 comprises a ceramic material rather than the exemplary ABS material discussed above.

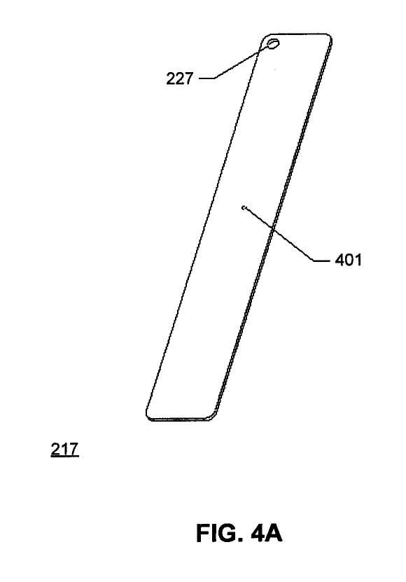

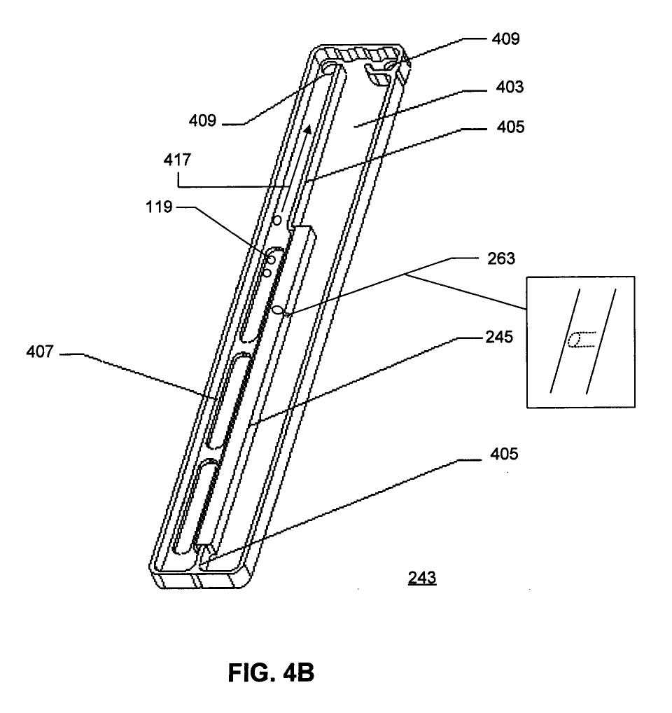

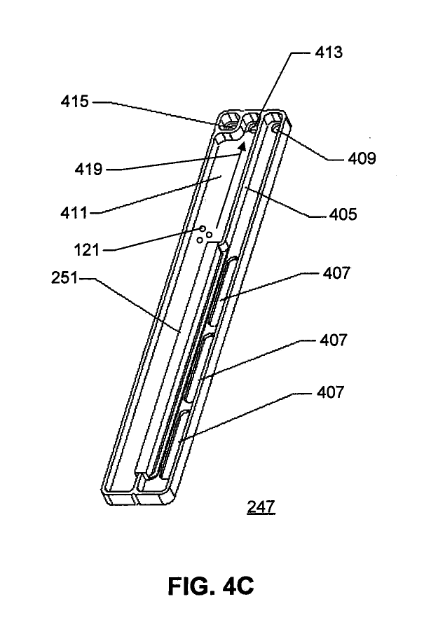

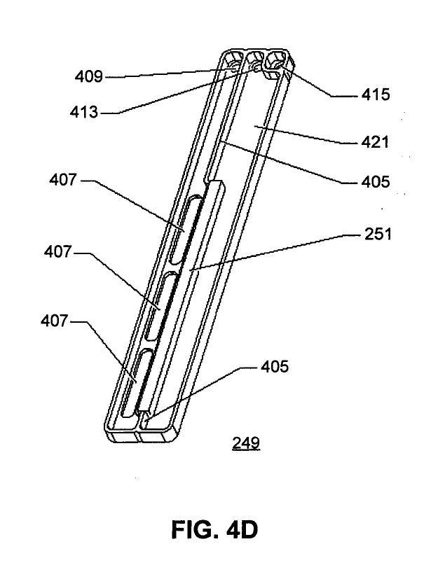

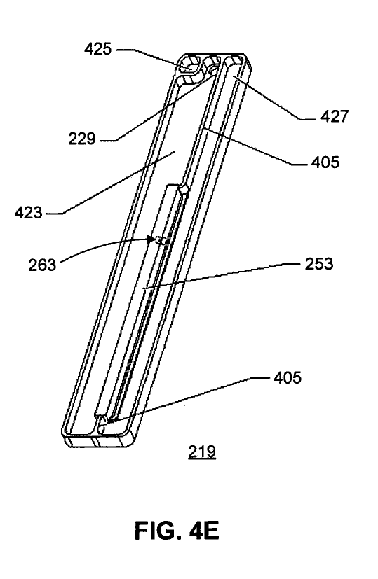

FIGS. 4A-4E provide additional detail of parts forming the subchambers comprising cell 241. As illustrated in FIGS. 4A-4E, the adjacent chamber and midchambers that form subchambers making up cell 241 are provided such that oxygen and hydrogen orifices for channeling oxygen and hydrogen through the cell are aligned. Chamber and midchamber walls are also provided such that an electrode provided therein may be provided flush with the top of a sidewall arising from the back wall thereof, such that the sidewall forms a periphery that defines an inner region within the chamber and midchamber portions discussed below. Cement, such as MEKABS-2 discussed above, is used to electrodes to chamber and midchamber walls when the walls are formed of ABS material. Cement may also be used to seal chambers and subchamber pieces to each other. The sealing coat, also discussed above, may also be used to ensure integrity of the seals between the chamber and subchamber pieces.

FIG. 4A illustrates cathode cap 217 in greater detail. Cathode cap 217 illustrated in FIG. 4A includes hydrogen connection orifice 227 for hydrogen 119 collection that may be connected to hydrogen collection tube 221. Cathode cap 217 also includes a hole 401 that allows one of connection terminals 215 to pass through cap 217 and provide, for example, negative potential 259 illustrated in FIGS. 2C and 2D.

FIG. 4B illustrates cathode endchamber 243 in greater detail. Cathode endchamber 243 is provided to abut and be capped by cathode cap 217 in cell 241. Cathode electrode 245 is secured to a back wall portion of the subchamber, such as cathode endchamber wall 403, using, for example, MEKABS-2 when cell 241 is comprised of ABS material. It will now be apparent from the foregoing description that chambers and endchambers provided within cell 241 include a sidewall extending upward from the back wall, such as wall 403, where this sidewall also extends around a periphery of the back wall to define an inner region of the portion of the cell including the aforementioned chamber pieces. MEKABS-2 provides a compatible, homogeneous bonding material for affixing ABS parts or electrodes to ABS material within cell 241. Hole 401 in cathode cap 217 aligns with orifice 263 in cathode electrode 245 for receiving a portion of one of terminals 215 therein to provide an electrical connection between cathode electrode 245 and bus bar 213. Cathode electrode 245, in combination with a ridge 405, divides cathode end chamber 243 into a first and second region. Openings, such as slots 407 are provided on one side of cathode endchamber 243. Hydrogen collection orifices 409 (generically referred to as “collection orifice 409” or “collection orifices 409” herein) are provided at opposing corners at one end of cathode endchamber 243. Hydrogen collection orifices 409 may be provided at the top of any chamber configuration to allow hydrogen 119 to rise to rise to the top of the chamber, and to facilitate collection of hydrogen 119 during operation of cell 241.

FIG. 4C illustrates a single one of cathode-anode midchambers 247 in greater detail. One of electrodes 251 is affixed to a cathode-anode midchamber wall 411 of cathode-anode midchamber 247. Electrode 251 may be secured using methods and materials such as those discussed above. In combination with ridge 405, one of electrodes 251 may divide the inner region of cathode-anode midchamber 247. A single one of hydrogen collection orifices 409 is provided right adjacent of ridge 405 in cathode-anode midchamber 247, allowing hydrogen 119 collection during operation of cell 241. An oxygen collection orifice 413 (generically referred to as “collection orifice 413” or “collection orifices 413” herein) is provided on the opposite side of ridge 405 from hydrogen collection orifice 409 and centered at the top of midchamber 247. A hydrogen pass-through orifice 415 is provided left adjacent to oxygen collection orifice 413 provided to cathode-anode midchamber 247. Slots 407 are provided on the same side of electrodes 251 as hydrogen collection orifice 409 in cathode-anode midchamber 247.

With reference to FIG. 3A, one cathode-anode midchambers 247 is provided abutted to cathode endchamber 243 and other cathode-anode midchambers 247 are provided abutted to anode-cathode midchambers 249 to form subchambers comprising the bulk of cell 241.

With reference to FIG. 4B, when cathode-anode midchamber 247 is provided to abut cathode endchamber 243, slots 407 provide for the flow of conductive solution 257, between cathode electrode 245 and electrode 251 provided in the abutting cathode-anode midchamber 247. In combination, cathode endchamber 243 including cathode electrode 245, cathode-anode midchamber 247 including electrode 251, and ridges 405 confine conductive solution 257 provided therebetween. Hydrogen 119 will form in cathode endchamber 243 from electrolysis of conductive solution 257 during operation of cell 241. This hydrogen 119 will rise and be channeled to hydrogen collection orifices 409, symbolically illustrated by arrow 417. With further reference to FIGS. 2A, 3A, and 4A, this channeled hydrogen 119 may be further transported through tubing 225 provided to hydrogen connection orifice 227 and to hydrogen collection tube 221.

With reference to FIG. 4C, when cathode-anode midchamber 247 is provided abutted to cathode endchamber 243, the conductive solution 257 is confined between cathode electrode 245 and the adjacent electrode 251 having a higher potential than cathode electrode 245, consistent with the current flow symbolically illustrated as arrow 265 in FIG. 2D. Oxygen 121 will form in cathode-anode midchamber 247 from electrolysis of conductive solution 257 during operation of cell 241. This oxygen 121 will rise and be guided by the combined electrode 251 and ridge 405 provided in cathode-anode midchamber 247 and channeled through a subportion of midchamber 247 to oxygen collection orifices 413 provided therein. The flow of this oxygen 121 is symbolically illustrated by arrow 419. Oxygen 121 may then be transported via oxygen collection orifices 413 through tubing 225 connecting cell 241 to oxygen connection orifice 229 and to oxygen collection tube 223. Again with reference to when cathode-anode midchambers 247 are provided abutted to cathode endchamber 243, oxygen flow can proceed through oxygen collection orifices 413 because the flow path is confined by cathode endchamber wall 403 provided abutted to a face of cathode-anode midchambers 247.

FIG. 4D illustrates a single one of anode-cathode midchambers 249. One of electrodes 251 is affixed to a anode-cathode midchamber wall 421 of anode-cathode midchamber 249. Electrode 251 may be secured using methods such as those discussed above. In combination with ridge 405, electrode 251 divides midchamber 249 illustrated in FIG. 4D. A single one of hydrogen collection orifices 409 is provided in the left adjacent of ridge 405 in midchamber 249, allowing hydrogen 119 collection during operation of cell 241. Oxygen collection orifice 413 is provided in the top center of anode-cathode midchamber 249, on the opposite side of ridge 405 from hydrogen collection orifice 409. A hydrogen pass-through orifice 415 is provided right adjacent to oxygen collection orifice 413 provided to anode-cathode midchambers 249. With reference also to FIG. 4C, the combination of orifices 409, 413, and 415 present in cathode-anode midchambers 247 and anode-cathode midchambers 249 are mirror images of each other, i.e., orifices 415, 413, and 409 are provided in opposite sequences in cathode-anode midchambers 247 and anode-cathode midchambers 249 as viewed in FIGS. 4C and 4D. Slots 407 are provided on the same side of electrode 251 as hydrogen collection orifice 409 in anode-cathode midchamber 249.

As discussed briefly above and with reference to FIG. 3A, cathode-anode midchambers 247 are abutted to anode-cathode midchambers 249 to form subchambers comprising the bulk of cell 241. When cathode-anode midchamber 247 abuts anode-cathode midchamber 249, conductive solution 257 is confined between electrodes 251 provided to cathode-anode midchamber 247 and anode-cathode midchamber 249, and may flow through slots 407. Hydrogen 119 and oxygen 121 are generated by electrolyzing conductive solution 257 confined between electrodes 251 of cathode-anode midchambers 247 and anode-cathode midchambers 249.

With further reference to FIGS. 2C and 2D, current flows between lower to higher potential electrodes 251, as illustrated symbolically by arrow 267. Conductive solution 257 provides a conductive path between electrodes 251. Electrodes 251 act as both cathode and anode for the electrolysis reactions occurring on different sides of electrodes 251, depending on the relative potential present on the different sides of electrodes 251. Hydrogen 119 will form on the lower potential side and oxygen 121 on the higher potential side of electrodes 251. Hydrogen 119 and oxygen 121 generated by electrolysis of conductive solution 257 using electrodes 251 may flow to the appropriate hydrogen collection orifices 409 and oxygen collection orifices 411, respectively, provided within cathode-anode midchambers 247 and anode-cathode midchambers 249.

FIG. 4E illustrates an exemplary anode endchamber 219. Anode electrode 253 is secured to an anode endchamber wall 423 in a manner consistent with the discussion above. Anode endchamber 219 also includes a hole (not shown) formed in anode endchamber wall 423, which is aligned with orifice 263 provided in anode electrode 253. Orifice 263 may receive one of terminals 215, thus electrically connecting anode electrode 253 with, for example, positive potential 261 illustrated in FIGS. 2C and 2D.

With further reference to FIG. 4E, anode endchamber 219 is divided by the combination of anode electrode 263 and ridge 405. Oxygen connection orifice 229 is provided at the top center of anode endchamber 219, on one side of ridge 405. A hydrogen cap 425 is provided left adjacent to oxygen collection orifice 413 provided in anode endchambers 219. A hydrogen cap chamber 427 is provided right adjacent to oxygen collection orifices 413 provided in anode endchambers 219. During production of hydrogen 119 and oxygen 121, oxygen 121 passes into anode endchamber 219 and is channeled through endchamber 219 to oxygen connection orifice 229. Oxygen connection orifice 229 may be connected via tubing 225 to oxygen collection tube 223, consistent with the exemplary embodiments illustrated in FIGS. 2A and 2B. Hydrogen 119 flow will be confined by hydrogen cap 425 and hydrogen cap chamber 427 in anode endchamber 219.

With further reference to FIGS. 4D and 4E, anode endchamber 219 is provided abutting one of cathode-anode midchambers 247. Conductive solution 257 is confined between electrode 251 provided in cathode-anode midchamber 247 and anode electrode 253. By applying an appropriate voltage to electrode 251 provided in cathode-anode midchamber 247 and anode electrode 253, conductive solution 257 may be electrolyzed to produce hydrogen 119 and oxygen 121, which will be respectively channeled in a manner consistent with the description above.

In view of the foregoing description, it will now be apparent to one of ordinary skill in the art that, in combination with cathode electrode 245, electrodes 251, and anode electrode 253, ridge 405 confines conductive solution 257, thereby preventing current flow outside of conductive solution 257. Moreover, ridge 405 guides hydrogen 119 and oxygen 121 produced by electrolysis of conductive solution 257 within the chambers formed by the combination of cathode cap 217, cathode endchamber 243, cathode-anode midchambers 247, anode-cathode midchambers 249, and anode endchamber 219. Surface tension of hydrogen 119 and oxygen 121 bubbles formed along their respective electrodes also assists in the collection of hydrogen 119 and oxygen 121.

In order to join cathode cap 217, cathode end chamber 243, cathode-anode midchamber 247, anode-cathode mid chamber 249, and anode end chamber 219 to abut each other in the matter described above, abutting surfaces are prepared to be substantially flat and all surfaces that will abut on any face of any of the chambers are prepared to be coplanar. As described above, after abutment the various electrodes, ridges, sidewalls and back surfaces define regions that confine conductive solution 257 and with which hydrogen 119 and oxygen 121 are generated. Thus, the abutting surfaces are prepared to be substantially flat and within each chamber, coplanar to ensure that after bonding, the defined confining regions are sufficiently liquid and gas tight to enable operation of cell 241.

In the exemplary embodiments discussed above, it is assumed that unit 201 is operated in an environment providing gravitational pull. If unit 201 is used in an environment with low or no gravity, an artificial gravity force, such as a centrifugal force may be applied to unit 201 to ensure hydrogen 119 and oxygen 121 rise to collection orifices 409 and 413, respectively. In another exemplary embodiment of cell 241, a fine mesh may be provided in slots 407 to assist in preventing bubbles of hydrogen 119 and oxygen 121 from flowing out of the chamber in which they are produced.

As also discussed above, conductive solution 257 is provided within cells 203 during operation. A suitable level of conductive solution 257 throughout cells 203 is required for operation. For example, the level of conductive solution 257 that fully immerses cathode electrode 245, electrodes 251, and anode electrode 253 during operation of unit 201 may be used. A minimum level of conductive solution 257 should be no lower than the top of slots 407 to prevent intermixing of hydrogen 119 and oxygen 121 between subchambers.

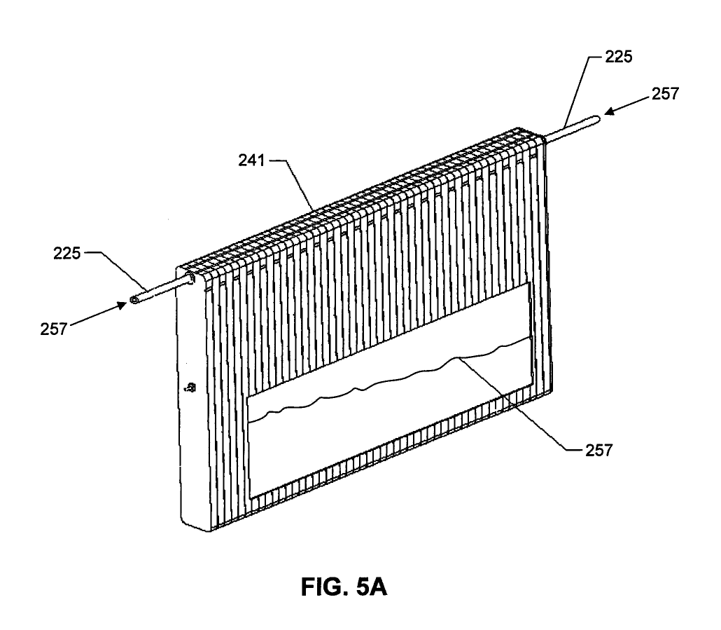

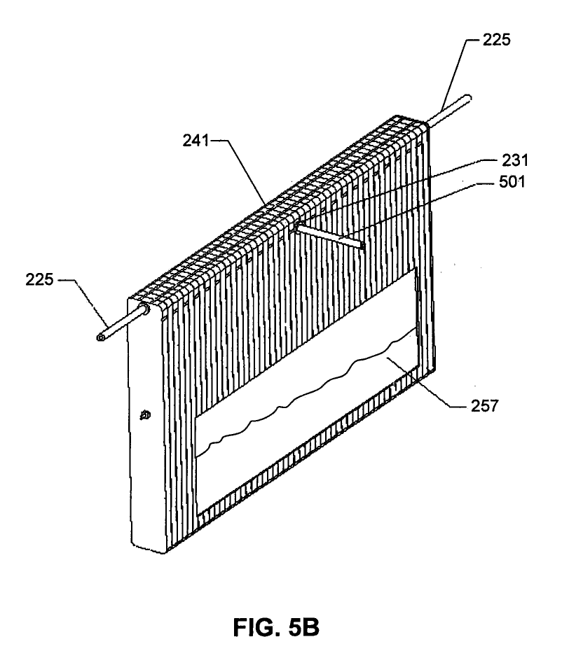

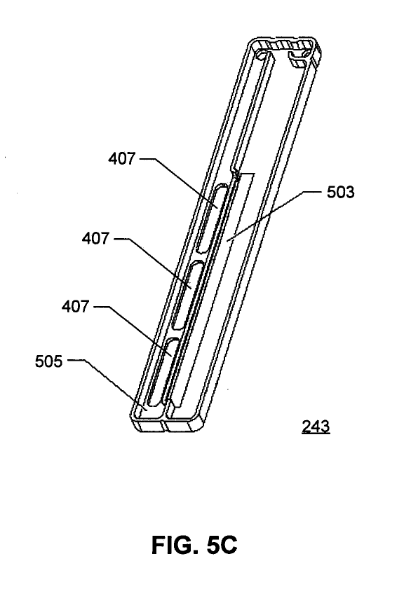

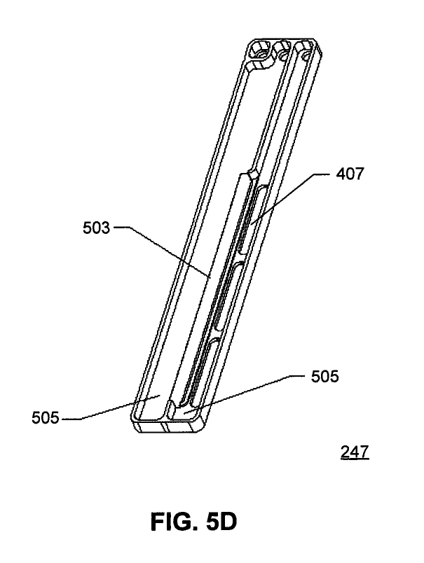

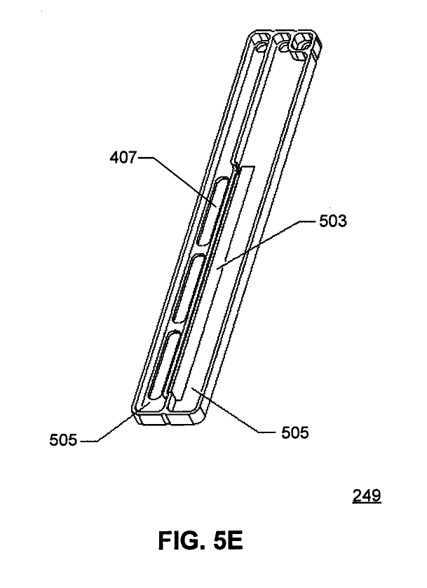

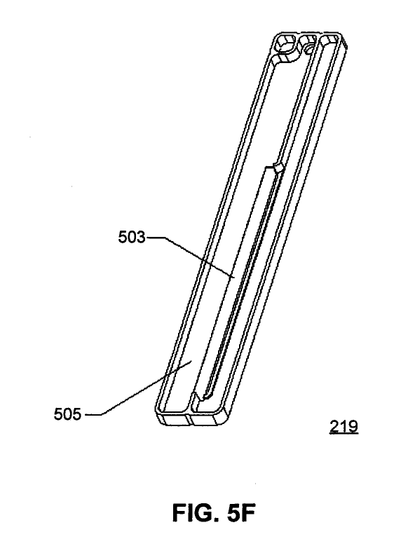

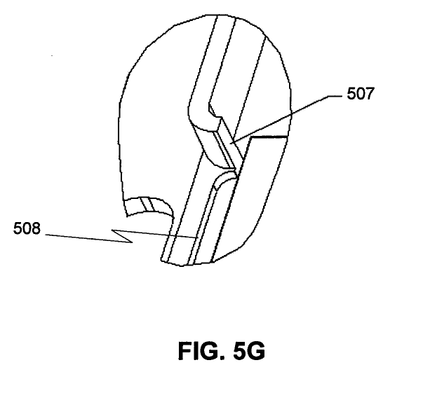

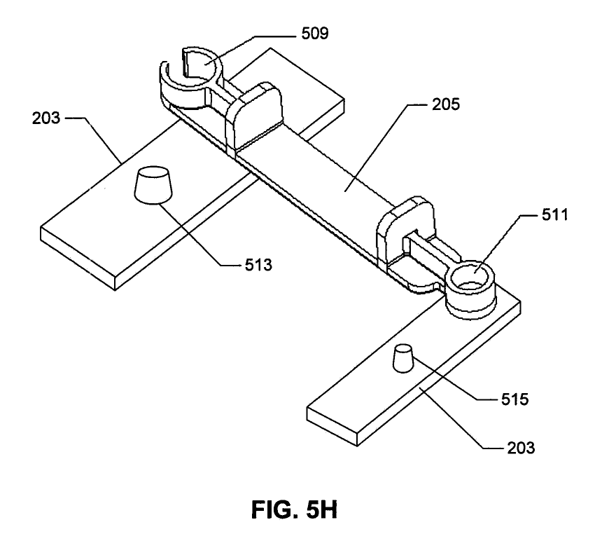

Conductive solution 257 may be provided to cells 203 using a variety of filling methods. FIG. 5A illustrates one such filling method. In FIG. 5A, cell 241 is shown with a cut away and with electrodes and chambers removed. Conductive solution 257 is provided to cell 241 via tubing 225, which allows conductive solution 257 to pass through connection orifices 227 and 229. After passing through connection orifices 227 and 229, conductive solution 257 can flow through collection orifices 411 and 413, provided within cell 241 and connected to the subchambers formed by the combined cathode cap 217, cathode endchamber 243, cathode-anode midchambers 247, anode-cathode midchambers 249, and anode endchamber 219. Conductive solution 257 may be provided continuously during operation or periodically as part of the scheduled maintenance of unit 201.

FIG. 5B illustrates an alternative method of filling cell 241 with conductive solution 257. Again, FIG. 5B includes a cut away as with FIG. 5A. Consistent with the exemplary embodiment illustrated in FIG. 5A, conductive solution 257 may be provided to chambers formed by the combined cathode cap 217, cathode endchamber 243, cathode-anode midchambers 247, anode-cathode midchambers 249, and anode endchamber 219 using tubing 225 to flow conductive solution 257 through collection orifices 409 and 413. In addition or in the alternative, a fill tap 501 is provided in a manner to tap a portion of midchambers 247 and/or 249 above slots 407 illustrated in FIGS. 4C and 4D. Conductive solution 257 provided to such a portion of one of midchambers 247 and/or 249 can then flow through the cell via collection orifices 409 and 413 through cell 241. Methods and apparatus for sealing tap 501, consistent with the discussion above regarding washers 231, may be applied to tap 501.

FIGS. 5C-5F illustrate certain aspects of cathode endchamber 243, cathode-anode midchambers 247, anode-cathode midchambers 249, and anode endchamber 219 in greater detail. As discussed above, cathode electrode 245, electrodes 251, and anode electrode 253 may be provided in chambers 243, 247, 249, and 219, consistent with exemplary embodiment discussed above. Electrodes 245, 251, and 253 may be secured using a cement 503, provided as illustrated in FIGS. 5C-5F. Cement 503 may be, for example, MEKABS-2 discussed above. Cement 503 may be applied manually or, in an automated production line, and may be provided using an atomizer sprayer or other means that provides for selective application of cement 503. MEKABS-2 provides a compatible, homogeneous bonding material when cell 241 is formed of ABS material. One of ordinary skill in the art will now understand that other combinations of suitable materials and solvents may comprise cement 503.

Slots 407 are also illustrated in FIGS. 5C-5F. As discussed above, slots 407 allow conductive solution 257 to flow between adjacent electrodes. Slots 407 also allow for the flow of conductive solution 257 throughout cell 241 during filling operations discussed above. Although three slots 407 are provided in the exemplary figures, this is merely an exemplary number of slots. The number of slots 407 provided in any single chamber may be greater than or less than three in number, so long as conductive solution 257 can form the conductive path between electrodes. Providing multiple slots 407 rather than a single slot may provide additional structural support for cell 241. In addition, the open surface area, i.e., the combined area of one or multiples slots making up slots 407, may be an area approximately equal to the area of a face of the electrode in contact with conductive solution 257, i.e., the exposed side face of the electrode when the electrode is provided adjacent to slot 407. The distance between slots 407 and their adjacent electrodes may be minimized to decrease resistance within cell 241, but the distance should be sufficient to allow for gas accumulation. For example and without limitation, an exemplary distance between slots 407 and their adjacent electrode may be in the range of 10% of the width of the electrode with a variation of +/−1%.

FIGS. 5C-5F also illustrate a bottom collector 505. During electrolysis of conductive solution 257 in cell 241, foreign matter, such as an electrolyte provided in conductive solution 257, will precipitate out of conductive solution 257 over time. Precipitated matter may collect in bottom collector 505.

FIG. 5G illustrates additional details of ridge 405. In particular, FIG. 5G provides additional detail of a curved lip 507. Providing curved lip 507 on ridge 405 allows for a minimal distance between slots 407 and cathode electrode 245, electrodes 251, and anode electrode 253. Curved lip 507 may also be provided when longer electrodes are desired. A ridge 508 is a non-functional machining artifact.

FIG. 5H illustrates an exemplary one of clips 205 in greater detail. Exemplary clip 205 may be used to secure cells 203 forming unit 201. Clip 205 includes a head 509 and a tail 511 that mate with a corresponding head ridge 513 and a corresponding tail ridge 515, respectively. Ridges 513 and 515 may be provided on a top or bottom surface of adjacent cells 203. As illustrated in FIG. 5H, clip 205 may be used to tie a number of cells 203 together, depending on various operation requirements including, for example, when assistance of heat dissipation of cells 203 is required. Clip 205 may be made of any material of suitable strength by manufacturing methods known in the art. It will now be apparent to one of ordinary skill in the art that a variety of other methods and devices may be used to secure cells 203.

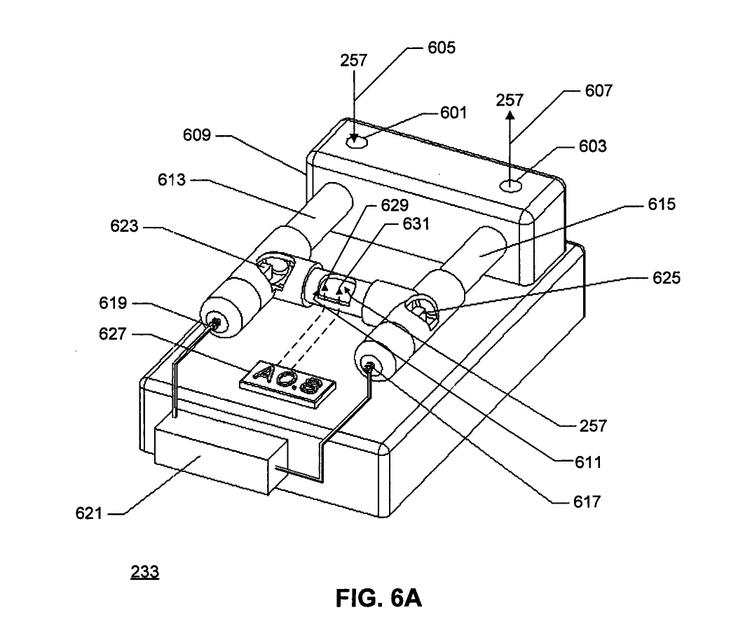

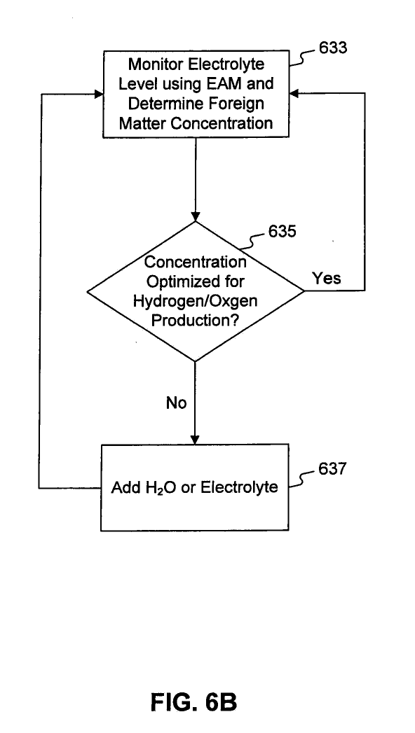

FIGS. 6A-C illustrate EAM 233 and methods of operating the same. As discussed above, EAM 233 may be used to monitor the resistance of conductive solution 257 and determine a concentration of, for example, foreign matter present in conductive solution 257.

FIG. 6A illustrates an exemplary EAM 233. EAM 233 includes an in-flow orifice 601 and an out-flow orifice 603 for conductive solution 257 provided from cell 241, the flow of which is symbolically illustrated by arrows 605 and 607, respectively. A flow control valve 609 is provided to control the flow of conductive solution 257 through a test chamber 611. Flow control valve 609 may pump conductive solution 257 through EAM 233. Alternatively, conductive solution 257 may be provided to EAM 233 via a gravity feed arrangement. Test chamber 611 has a known volume. In-flow orifice 601 is coupled to test chamber 611, which receives conductive solution 257 through an in-flow connector pipe 613. Conductive solution 257 flows through test chamber 611 to an out-flow connector pipe 615 that connects to out-flow orifice 603. A first voltage terminal 617 is provided at one end of test chamber 611 and a second voltage terminal 619 is provided on an opposite side of test chamber 611. A known voltage is applied across terminals 617 and 619 by a voltage supply 621. The potential applied across conductive solution 257 may be provided, for example, by a first voltage probe 623 and a second voltage probe 625. An amperage meter 627 is also provided and is connected to a first amp probe 629 and a second amp probe 631 provided spaced apart within test chamber 611 and in contact with conductive solution 257 provided therein.

During operation of EAM 233, a known voltage is applied across a known volume of conductive solution 257 present in test chamber 611. For example, a known voltage provided by voltage source 621 is applied to voltage probes 623 and 625, provided in contact with conductive solution 257. Amperage present in conductive solution 257 is measured by amperage meter 627 via amp probes 629 and 631. By applying the known voltage over the known volume of conductive solution 257 resident in electrolyte test chamber 611, and by monitoring the resulting amperage via amperage meter 627, the resistance of conductive solution 257 can be obtained. This resistance corresponds to concentration of foreign material in conductive solution 257, for example, minerals and electrolytes. Thus, the concentration of foreign matter present in conductive solution 257 can be monitored.

FIG. 6B illustrates a flow chart of an embodiment of a system for maintaining an optimal concentration of electrolyte during operation of cells 203. During a first step 633, a concentration of an electrolyte present in conductive solution 257 is obtained using EAM 233. In a second step 635, the concentration determined from the resistance of conductive solution 257, consistent with the discussion above, is compared to an optimal concentration, for example, for hydrogen and oxygen production. If the concentration of electrolyte is comparable to the optimal level for production, monitoring of the electrolyte continues. A third step 637 is undertaken if the concentration is not optimal and additional H₂O or electrolyte is added to conductive solution 257. It will now be apparent to one of ordinary skill in the art that the above embodiment is merely exemplary and monitoring and/or adjusting concentration of an electrolyte present in conductive solution 257 may be undertaken by other means consistent with desired goals and operation. A concentration of other foreign matter may also be achieved using methods and apparatuses consistent with the above embodiment.

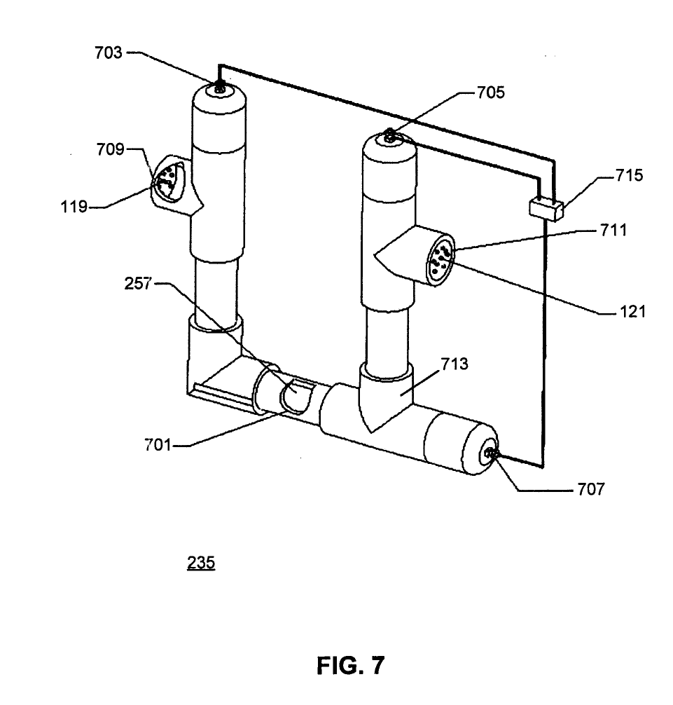

FIG. 7 illustrates GES 235 in greater detail. GES 235 allows the relative equilibrium pressures of a first gas and a second gas, e.g., hydrogen 119 and oxygen 121 gases present in cells 203, to be monitored during operation of unit 201. GES 235 includes a U-shaped switch flow chamber 701. Chamber 701 contains a conductive fluid, for example, conductive solution 257. GES 235 further includes a hydrogen electrical connection terminal 703, an oxygen electrical connection terminal 705, and a common electrical connection terminal 707. Terminal 703 is connected to chamber 701 by a hydrogen pressure inlet 709 disposed between terminal 703 and chamber 701. Terminal 705 is connected to chamber 701 by an oxygen pressure inlet 711 disposed between terminal 705 and chamber 701. Hydrogen 119 and oxygen 121 are provided to chamber 701 via inlets 709 and 711, respectively. Terminal 707 may be provided, for example, at an intersection 713 with chamber 701. A combined voltage source/circuit monitoring system 715 provides a common voltage to terminals 703 and 705 and a lower potential, e.g., ground, to terminal 707.

During operation of unit 201, hydrogen 119 and oxygen 121 are provided to GES 235 from one or more cells 203. As the relative pressures of hydrogen 119 and oxygen 121 vary, conductive solution 257 present in switch flow chamber 701 is pushed towards terminal 703 or 705, depending on which of hydrogen 119 or oxygen 121 is provided at a greater pressure. Conductive solution 257 will flow in the direction opposite of the greater pressure within chamber 701. If one pressure of hydrogen 119 or oxygen 121 is sufficiently greater than the other, conductive solution 257 will be forced to flow past inlets 709 or 711 and into contact with terminal 703 or 705. When this occurs, conductive solution 257 will complete an electrical circuit between common terminal 707 and whichever of terminals 703 and 705 is in contact with conductive solution 257. Closing the circuit between either terminal 703 or terminal 705 and common terminal 707 will signal to system 715 that the relative pressure of hydrogen 119 or oxygen 121 being produced by cells 203 is sufficiently unbalanced and, for example, trigger an alarm to take corrective action to restore the balance of the gases. Such corrective action may be, for example, taken either by an operator or by using known automated methods. Corrective action may include increased siphoning off of the higher pressure hydrogen 119 or oxygen 121, activation of a flow control valve that will allow evacuation of the higher pressure hydrogen 119 or oxygen 121, or diverting the higher pressure hydrogen 119 or oxygen 121 to over-flow storage tanks.

Unit 203 may be operated under pressure and GES 235 will continue to function. In particular, because GES 235 monitors relative pressure differences in the gases, it is suitable for use at pressure or atmosphere. Further, the actual shape of switch flow chamber 701 need only allow conductive solution 257 to flow in response to pressure of hydrogen 119 or oxygen 121, such that the circuit between terminal 707 and both terminals 703 and 705 may be completed using conductive solution 257 as a conductive path. In another exemplary embodiment of GES 235, terminals 703, 705, and 707, as well as inlets 709 and 711, may be disposed at other positions with respect to chamber 701, so long as conductive solution 257 can flow within chamber 701 and complete a circuit between terminal 707 and both terminals 703 and 705. Alternative fluids other than conductive solution 257 may also be provided to chamber 701 and GES 235 can be operated with such fluids, so long as the fluids are conducting.

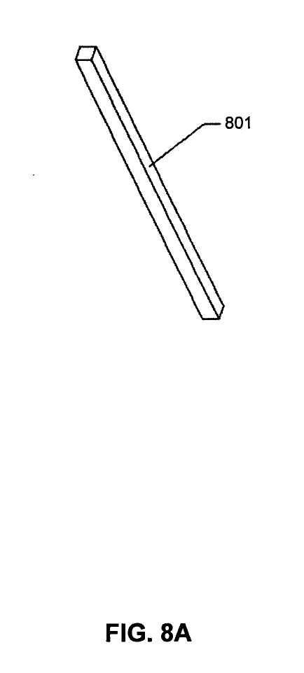

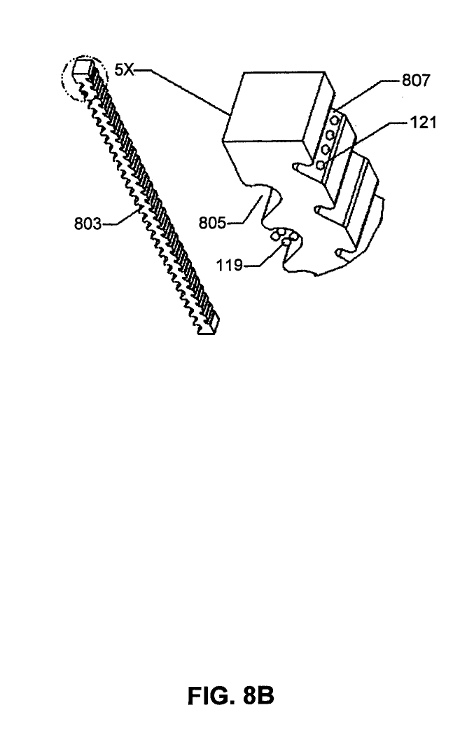

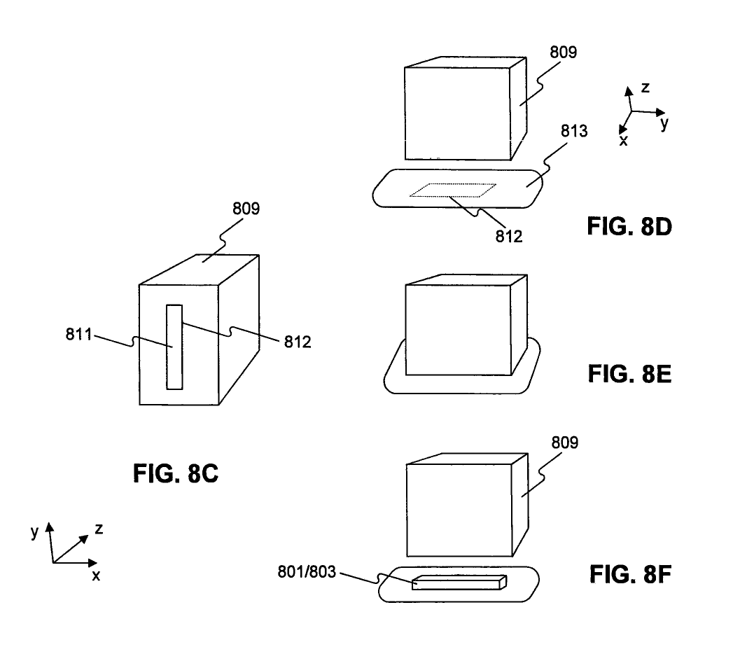

FIGS. 8A-8F provide additional details on electrodes consistent with embodiments discussed herein and the manufacturing of the same.

FIG. 8A illustrates an exemplary electrode 801. Electrode 801 may be provided as cathode electrode 245, electrodes 251, or anode electrode 253. In one embodiment, electrode 801 is formed of carbon. In another embodiment, electrode 801 may be comprised of 98% carbon and 2% silicon by chemical composition. While electrode 801 has been described as being primarily composed of carbon, other electrically conductive materials may also be used to form electrode 801 such as allotropes of carbon, carbonados, and n- or p-type silicon. Further, electrode 801 may comprise other electrically conductive metal, semimetal, and semiconductor materials.

FIG. 8B illustrates an alternative embodiment being a notched electrode 803. FIG. 8B illustrates an entire electrode 803, as well as a magnified (5×) portion of an upper end thereof. Electrode 803 may be provided as cathode electrode 245, electrodes 251, or anode electrode 253. As shown in FIG. 8B, notched electrode 803 includes hydrogen cavities 805 and oxygen cavities 807 on opposite sides of electrode 803. Cavities 805 and 807 allow gases, for example, hydrogen 119 and oxygen 121 to be stored therein, respectively. In one embodiment, larger cavities 805 may be provided to store hydrogen 119 and smaller cavities 807 may be provided to store oxygen 121.

In one embodiment, electrodes 801 and 803 may be provided as ¼″×¼″×6″ carbon electrodes. Other size electrodes may also be used without deviating from the exemplary embodiments discussed herein. Exemplary dimensions of endchambers 219 and 243 and midchambers 247 and 249 in which such electrodes may be mounted are 10″ high by ½″ wide and 5/16″ deep. In an alternative embodiment, electrode 801 or 803 can be provided as ¼″×¼″×2″ carbon electrode. In such alternative embodiment, endchambers 219 and 243 and midchambers 247 and 249 exemplary dimensions of those chambers are 4½″ high by ½″ wide and 5/16″ deep. In such alternative embodiment, a single slot for slots 407 may be provided.

Consistent with the description set forth above, electrodes 801 and 803 provided to the exemplary cells may act as anode electrodes, cathode electrodes, cathode-anode electrodes, or anode-cathode electrodes, depending on placement of electrode 801 or 803 within the cell and its relationship to other electrodes provided therein, as well as electrode placement with respect to electrolyte solution provided within the cell.

If electrodes 801 or 803 are formed of certain materials other than carbon, carbonados, or n- or p-type silicon, or conductive solution 257 includes certain foreign matter, additional gases besides hydrogen 119 and oxygen 121 may result when electrolyzing conductive solution 257. If higher purity hydrogen 119 and oxygen 121 are desire when using such electrodes or conductive solutions, the gases may be filtered using filtering techniques, such as cryogenic based filter systems.

Electrodes 801 and 803 may be formed by extruding carbon. Once extruded, electrodes 801 and 803 may be further finished, for example, machined to form the electrode in the desired shape. One of ordinary skill in the art will now understand that other methods of forming electrodes 801 and 803 may be used without deviating from the exemplary embodiments discussed herein.

In an exemplary method of formation, electrodes 801 and 803 may be formed from a carbon source, e.g., graphite, that is mixed with silicon and heated to 3000° F. This mixture of carbon and silicon may be then be extruded and cut to a desired length for the electrodes. In particular, electrodes may be machined from a billet extrusion at the desired length.

FIG. 8C illustrates an alternative method of manufacturing electrodes 801 and 803. As discussed above, cells 203 may be formed of a variety of materials. When high heat and/or pressure resistance materials, for example, ceramic is used to form cells 203, electrodes 801 and 803 may be deposited onto such cells. FIG. 8C illustrates an exemplary deposition system including, a thermal vapor deposition (TVD) system 809 provided with a window 811 formed in a two-dimensional shape 812 consistent with the desired shape of a structure, such as electrode 801 or 803.

FIGS. 8D-8F illustrate a method of manufacturing electrodes 801 and 803 using a TVD system. As illustrated in FIGS. 8D and 8E, TVD system 809 is provided with appropriate source materials, e.g., carbon and silicon forming gases, and electrode material is deposited on a cell wall 813 through window 811. In particular, window 811 is used to mask the TVD system 809, and electrode material is therefore deposited confined to two-dimensional shape 812 of the desired electrode 801 or 803. Although two-dimensional shape 812 is illustrated as a rectangular shape consistent with electrode, other shapes, such as notches, may be formed using an appropriately shaped window 811 and two-dimensional shape 812. With further reference to FIG. 8E, TVD system 809 may be brought into contact with cell wall 813 and deposition of the source material begins. Deposition continues until a desired thickness of electrode 801 or 803 is achieved. As illustrated in FIG. 8E, TVD system 809 is retracted and electrode 801 or 803 is formed on cell wall 813.

It will now be apparent to one of ordinary skill in the art that a similar TVD system may use for deposition of materials to form electrodes or other structures on other materials, such as substrates in other industrial applications. Other deposition systems, e.g., chemical vapor deposition systems, may also be used without deviating from the disclosure here.

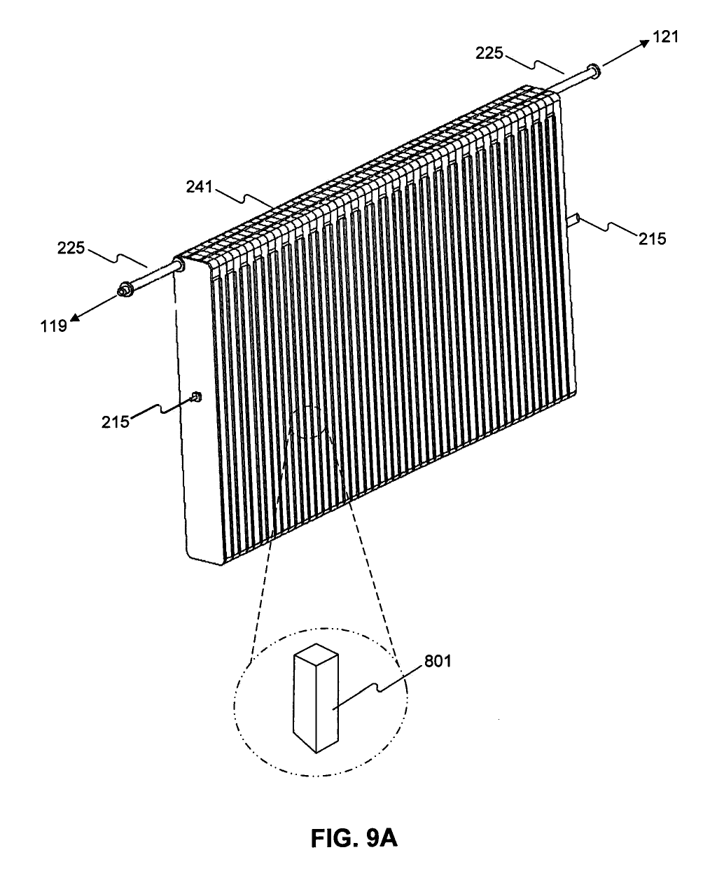

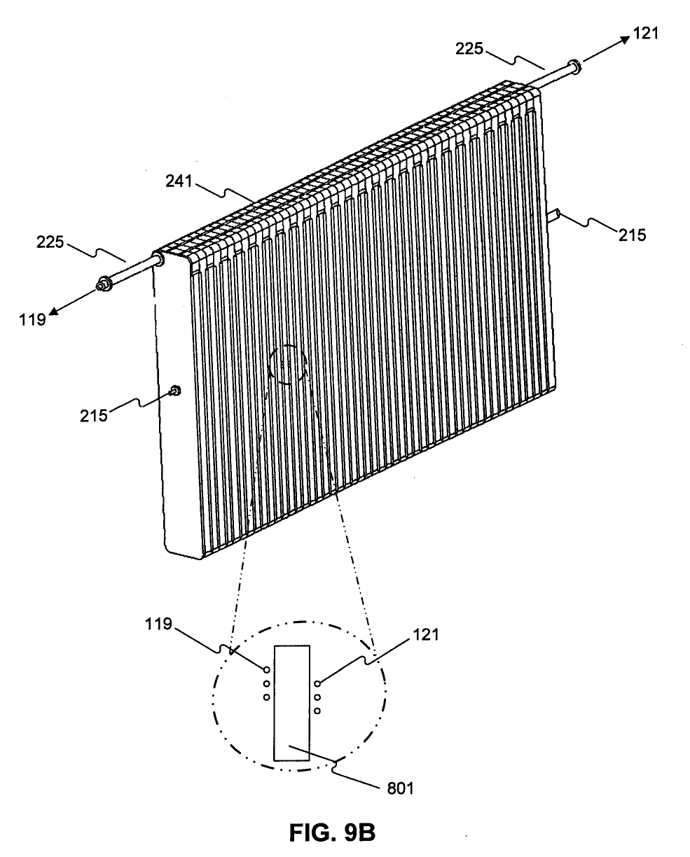

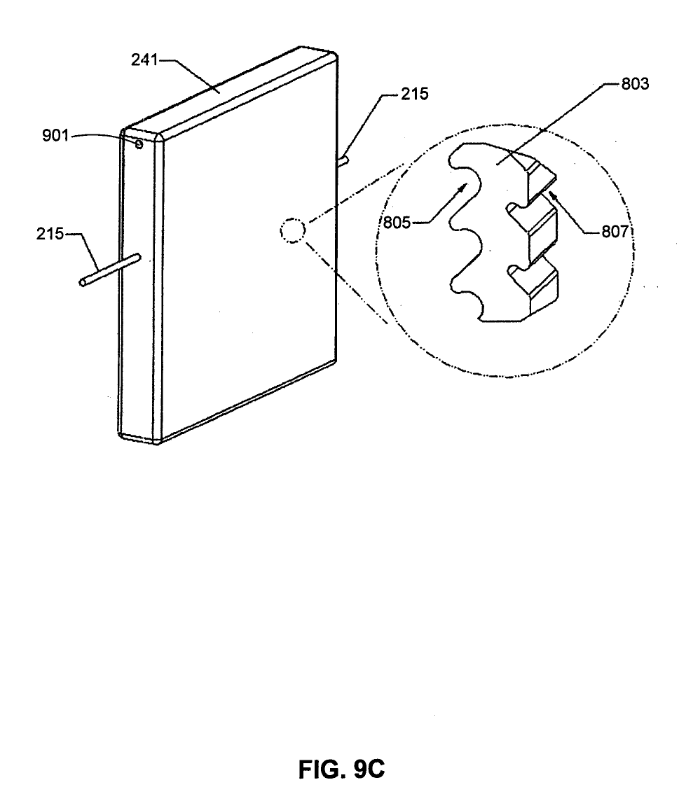

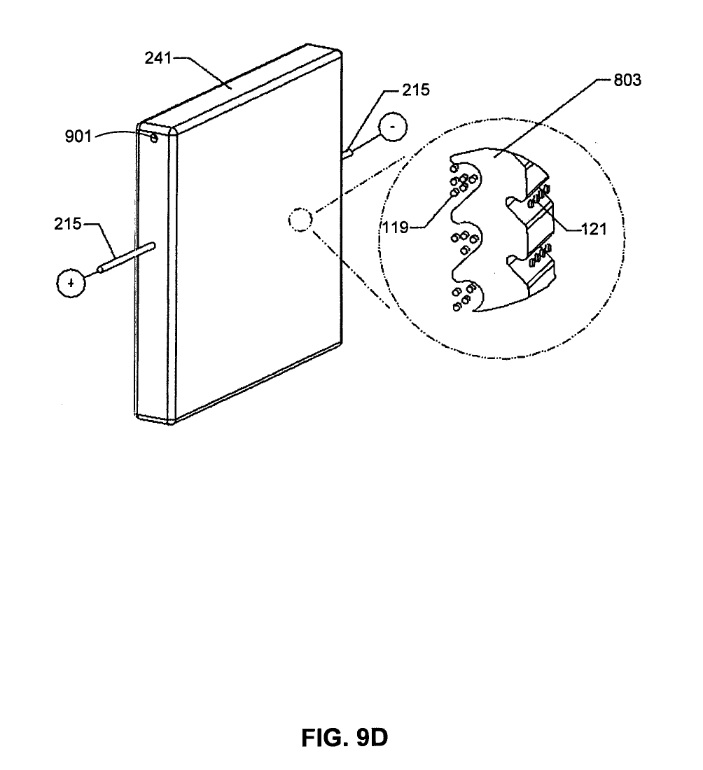

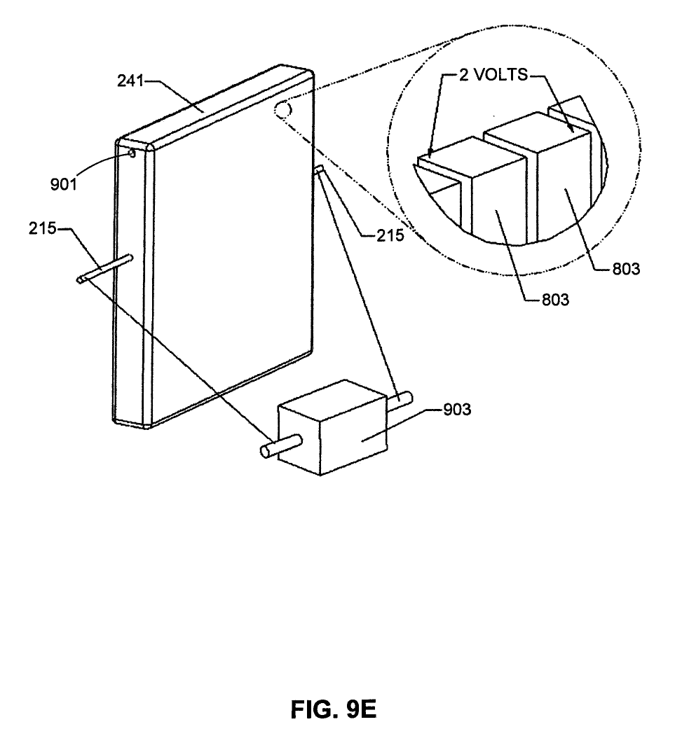

FIGS. 9A-9E illustrate exemplary modes of operation of cell 241. Cell 241 may be operated in a production mode, in which hydrogen 119 and oxygen 121 are produced, and provided to systems and apparatuses outside of cell 241. Cell 241 may also be operated in a storage or power source mode, in which hydrogen 119 and oxygen 121 are produced and stored in cell 241. By storing gases in cell 241, cell 241 may act similar to a rechargeable battery or fuel cell and provide power. Further discussion of these exemplary modes is provided here.

FIGS. 9A-9B illustrate cell 241 configured for production mode operation. As discussed above, hydrogen 119 and oxygen 121 may be produced by cell 241 with appropriate electrode and conductive solution selection.

FIG. 9A illustrates an exemplary configuration of cell 241 for use in production mode operation. For example, if cell 241 is provided with carbon electrodes 801 and conductive solution 257, for example, a solution of water with 30% NaCl by weight, and a voltage potential is applied, hydrogen 119 and oxygen 121 may be produced. Terminals 215 are provided to cell 241 for receiving the applied voltage consistent with use of cell 241 in production mode. Hydrogen 119 and oxygen 121 may be channeled out of cell 241 through tubing 225, that may connect cell 241 to, for example, collection tubes 221 and 223, as illustrated in FIGS. 2A and 2B.

FIG. 9B is an exemplary illustration of cell 241 during production mode operation. A voltage is applied across cell 241 via terminals 215. For example, assuming the use of electrodes 801 composed of carbon, the presence of conductive solution 257 composed of water with 30% NaCl by weight, and the presence of a voltage of approximately 2 volts for every anode/cathode pair of electrodes 801, i.e., between one side of one electrode and another side of another adjacent electrode forming one pair, cell 241 may produce hydrogen 119 and oxygen 121. For example, when one cathode electrode 245, forty-nine electrodes 251, and one anode electrode 253, are present in cell 241, collectively forming 50 anode/cathode electrode pairs, 100 volts is the required voltage to be applied across cell 241 via terminals 215 for operation. Electrodes 801 present in cell 241 are in contact with conductive solution 257, which is electrolyzed while the voltage supplied through terminals 215 is applied. Hydrogen 119 is produced on the lower potential side of electrode 801 and oxygen 121 is produced on the higher potential side. With reference to the exemplary embodiments illustrated in FIGS. 2A-2D, 3A, and 4A-4D, hydrogen 119 and oxygen 121 produced by electrolyzing conductive solution 257 are channeled through cell 241 to their respective connection orifices 227 and 229, which may be connected to collection tubes 221 and 223 via tubing 225. Hydrogen 119 and oxygen 121 produced within cell 241 pass through cell 241, e.g., through collection orifices 409 and 413 provided within cell 241, as illustrated in FIGS. 3A and 4A-4D.

In production mode operation, hydrogen and oxygen may, for example, be collected while being produced by cell 241 and used immediately or stored for later use. During operation in production mode, a negative pressure may be applied to cell 241 to maximize gas production. Additional collection control may be provided to unit 201 to facilitate gas collection. As discussed above, although hydrogen and oxygen are discussed as exemplary produced gases here, by selecting alternative electrodes and conductive solution and by supplying an appropriate voltage to cell 241, other gases, such as chlorine, may also be produced in production mode operation.

FIGS. 9C-9E diagrammatically illustrate an exemplary embodiment of cell 241 configured to operate in the storage or power source mode. When configured in power source mode, cell 241 acts similar to a rechargeable battery or membrane-less fuel cell.

FIG. 9C illustrates cell 241 in an exemplary configuration for operation in power source mode. In this exemplary embodiment, notched electrodes 803 may be provided in order to store hydrogen 119 and oxygen 121. Because hydrogen 119 and oxygen 121 are stored in cell 241 during power source mode, connection orifices 227 and 229 may be plugged or sealed using, for example, plugs 901 provided in connection orifices 227 and 229. Plugs 901 prevent hydrogen 119 and oxygen 121 from leaving cell 241. Plugs 901 may be sealed using sealing coat, consistent with embodiments discussed herein. Tubing 255 and associated collection tubes 221 and 223 may be omitted when configuring cell 241 in power source mode. Terminals 215 remain in place for operation in power source mode.

FIG. 9D illustrates an exemplary operation during the charging stage of the power source mode operation. As shown in FIG. 9D, a voltage is applied across terminals 215. Electrolysis of conductive solution 257 provided in cell 241 occurs and hydrogen 119 and oxygen 121 are produced. Hydrogen 119 and oxygen 121 are confined within cell 241. In particular, electrode 803 may receive hydrogen 119 and oxygen 121 in cavities 805 and 807, consistent with the exemplary embodiment discussed above. Cell 241 may be operated under pressure to allow additional storage of hydrogen 119 and oxygen 121. When operated under pressure, either higher strength material or reinforcing bands may be provided to ensure the integrity of cell 241 during pressurized operation.

As shown in FIG. 9E, once electrodes 803 provided within cell 241 are sufficiently filled with hydrogen 119 and oxygen 121, the applied voltage can be removed from cell 241. As further illustrated in FIG. 9E by the magnified view of two adjacent electrodes 803, a potential of approximately 2 volts is present at every anode/cathode pair of electrodes 803. For example, when one cathode electrode 245, forty-nine electrodes 251, and one anode electrode 253, are present in cell 241, collectively forming 50 anode/cathode electrode pairs, 100 volts is the required voltage to be applied across cell 241 via terminals 241 for operation. Thus, when an electrical load 903 is connected to terminals 215, power will be provided to load 903. In particular, when load 903 is connected across terminals 215, a reverse electrolysis reaction begins. During the reverse electrolysis reaction, hydrogen 119 and oxygen 121 stored in cell 241 recombine, producing water and current.

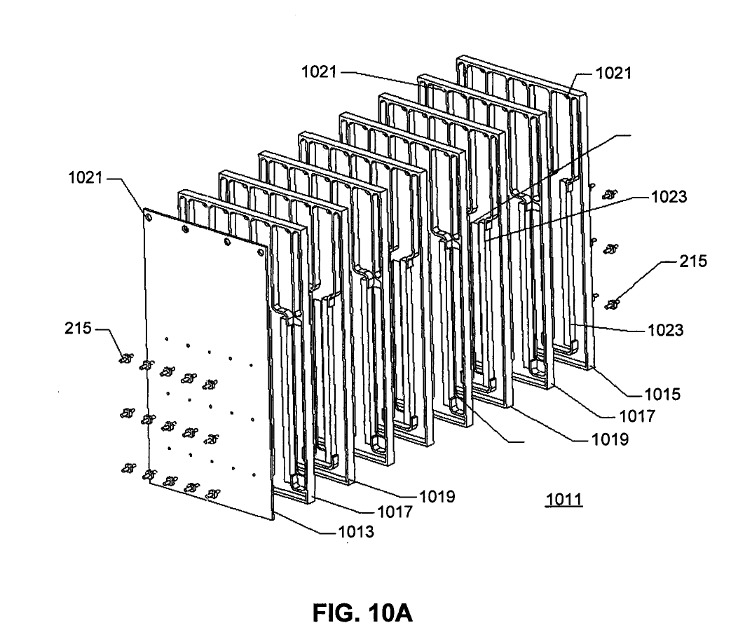

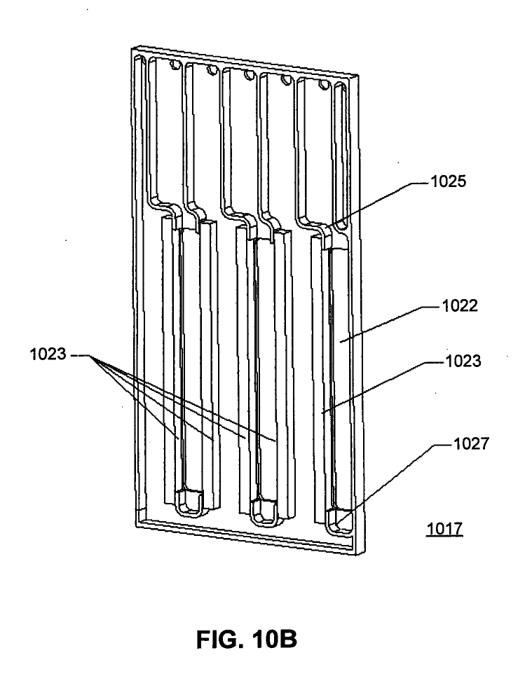

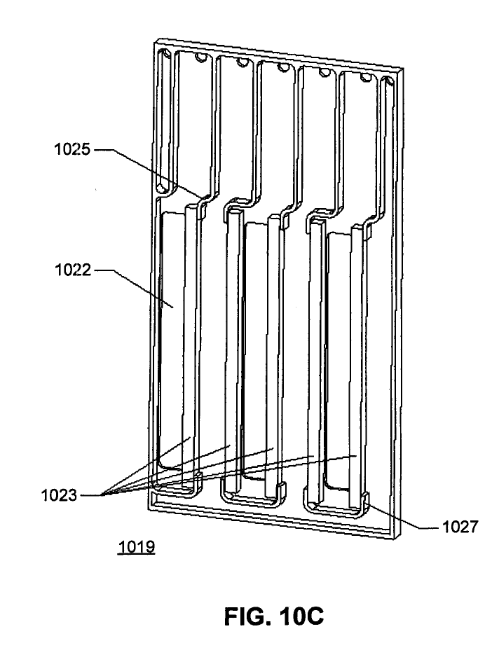

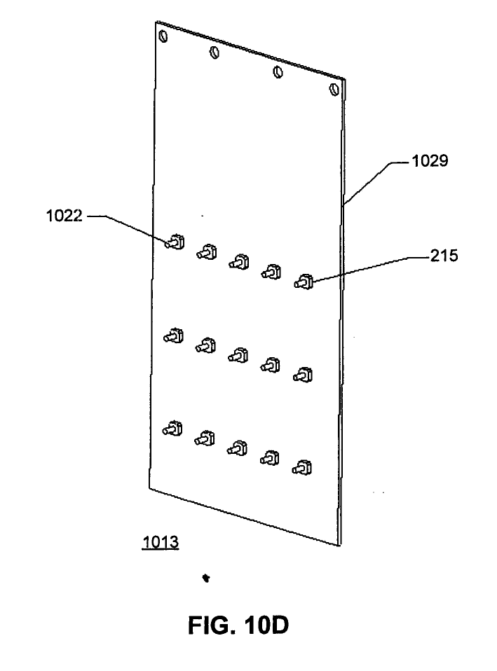

Other embodiments of unit 201 using different electrode configurations are also possible without departing from the scope of the invention discussed above. For example, an embodiment of a multi-electrode cell unit 1011 is illustrated in FIGS. 10A-D.

FIG. 10A illustrates an exploded view of multi-electrode cell unit 1011. Multi-electrode cell unit 1011 includes a cathode endplate 1013 and an anode endplate 1015 and may contain a plurality of complementary cathode-anode plates 1017 and anode-cathode plates 1019 arranged in an alternating sequence. A plurality of hydrogen and oxygen collection orifices 1021 are provided along the top of each of plates 1013, 1015, 1017, and 1019 to facilitate hydrogen 119 and oxygen 121 flow and collection during operation of unit 1011. Terminals 215 and other components discussed with respect to unit 201 may also be provided to unit 1011.

FIG. 10B illustrates an exemplary cathode-77anode plate 1017 and FIG. 10C illustrates an exemplary cathode-anode plate 1019. As shown in FIGS. 10B and 10C, each of plates 1017 and 1019 includes slots 1022 as well as electrodes 1023, slots 1022 being positioned to provide a complementary construction of plates 1017 and 1019. In this manner, slots 1022 are formed in backwalls of cathode-anode plates 1017 and anode-cathode plates 1019 to facilitate the controlled flow of conductive solution 257 between complementary plates 1017 and 1019 and electrodes 1023. Slots 1022 may, for example, be substantially the same length as electrodes 1023 in this exemplary embodiment. Electrodes 1023 are provided within plates 1017 and 1019 and adjacent to slots 1022.

Each electrode 1023 is secured to a portion of a top ridge 1025 that channels hydrogen 119 and oxygen 121 produced during operation of the unit. Each electrode 1023 is also secured at a bottom ridge 1027 which, in the present embodiment, is formed to have a relatively wide U-shape. Each top ridge 1025, bottom ridge 1027, and electrode 1023 form a barrier that confines conductive solution 257 between complementary anode/cathode pairs of electrodes 1023 provided on plates 1017 and 1019, respectively. Similar to other exemplary embodiments discussed herein, conductive solution 257 may provide the conductive path between complementary anode/cathode pairs of electrodes 1023 provided on plates 1017 and 1019.

Plates 1017 and 1019 may also be abuttingly joined in such a manner as to align the plurality of hydrogen and oxygen collection orifices 1021 of adjacent plates 1017 and 1019 to facilitate transport of hydrogen 119 and oxygen 121 during operation of multi-electrode cell unit 1011. Alternatively, the plurality of hydrogen and oxygen collection orifices 1021 may provide hydrogen 119 and oxygen 121 to plates 1017 and 1019 during operation in another exemplary mode of operation. Electrodes 1023, endplates 1013 and 1015, and plates 1017 and 1019 may be abuttingly joined and secured in the arrangement shown in FIG. 10A, using a cement, such as the MEKABS-2 cement described above, when the endplates 1013 and 1015 and plates 1017 and 1019 are formed of ABS. The multi-electrode cell unit 1011 is sealed using a coating seal, such as MEKABS-10. As described above with regard to cell 241, abutting surfaces are prepared to be substantially flat and within each plate 1017 and 1019, coplanar.

FIG. 10D illustrates an exemplary endplate 1013 which may be used as either endplate 1013 or 1015. Exemplary endplate 1013 includes a plurality of terminals 215 for providing or receiving a voltage from an adjacent plate 1017 or 1019. Endplate 1013 and 1015 may include a plurality of connection terminals 215 that contact electrodes 1023 provided in adjacent plate 1017 or 1019 abutting endplate 1013. Exemplary endplate 1013 may provide either a positive or negative voltage to electrodes 1023 present in adjacent plate 1017 or 1019. Alternatively, as illustrated in FIG. 10A, endplate 1015, which combines elements of plate 1017 or 1019, without slots for passage of conductive solution, with endplate 1013, may be used.

The configuration of connection terminals 215 provided in FIGS. 10A and 10D is merely exemplary and any configuration of endplates that allows terminals 215 to contact each of electrodes 1023 provided in abutting plate 1017 or 1019 may be used. Exemplary end plate 1013 illustrated in FIG. 10D includes three horizontal rows of five connection terminals 215. In this exemplary embodiment, it is assumed that the number of connection terminals 215 provided in each row are equal to the number of electrodes 1023 present in abutting plate 1017 or 1019. In this particular exemplary embodiment, five electrodes require five connection terminals. However, any number of connection terminals 215 may be used so long as electrodes 1023 in abutting plate 1017 or 1019 can be provided with a voltage connection via terminals 215. For example, a single connection terminal 215 may be used so long as additional wiring or other conductive medium is provided such that a voltage can be applied to each electrode 1023 in abutting plate 1017 or 1019 in production mode, or a voltage can be derived in power source mode.

FIGS. 10B and 10C also further illustrate complementary plates 1017 and 1019, which in combination form complete anode-cathode electrode pairs. Slots 1022 shown in exemplary plate 1017 provide for flow of conductive solution 257 between electrodes 1023 present in plate 1017 and complementary electrodes 1023 present in plate 1019. Similar to single electrode cell 25 discussed above, a physical connection between electrodes 1023 present in the first and last plates 1017 and 1019, i.e., plates abutting endplates 1013 and 1015 respectively, may provide the electrical connection to connection terminals 215. A voltage may then be applied to connection terminals 215 provided at either end via connection terminals 215 provided on exemplary endplate 1013. The conductive solution 257 may provide electrical connection between electrodes 1023 provided in the plurality of plates 1017 and 1019 in the bulk of the cell.

As discussed above, complementary plates 1017 and 1019 also allow for hydrogen 119 and oxygen 121 gases to flow from electrodes 1023 during operation and may be transported through the plurality of collection orifices 1021 provided along an edge of each of plates 1013, 1015, and the plurality of plates 1017 and 1019 in the exemplary multi-electrode cell unit 1011. Collection tubes similar to those discussed above may be connected to collection orifices 1021 present in end plates 1013 and 1015.

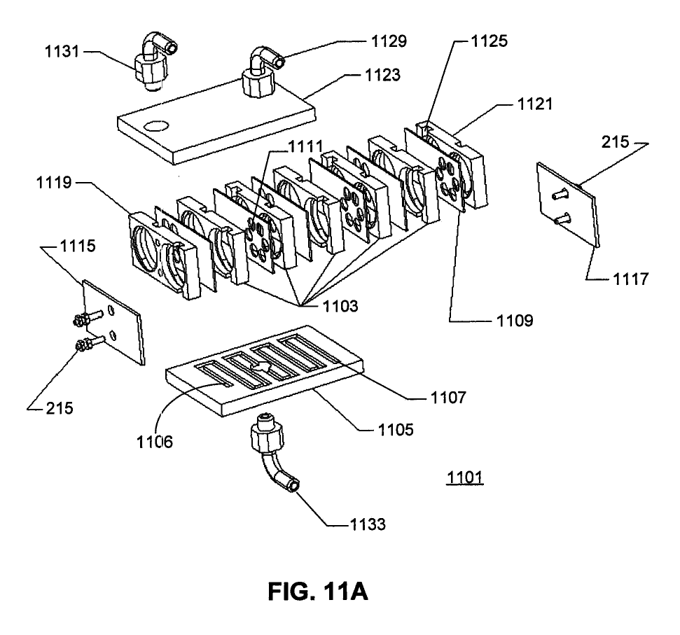

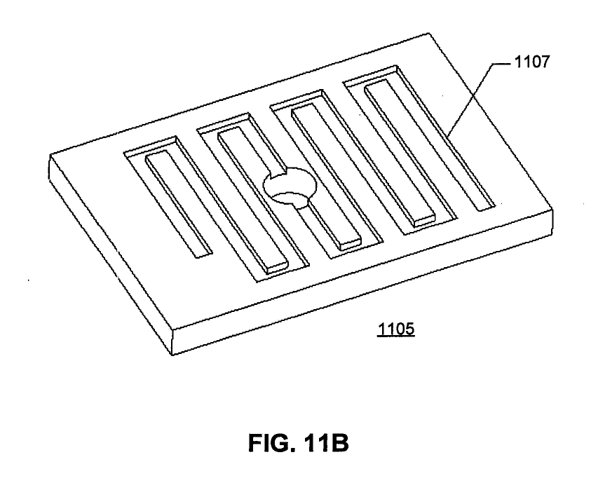

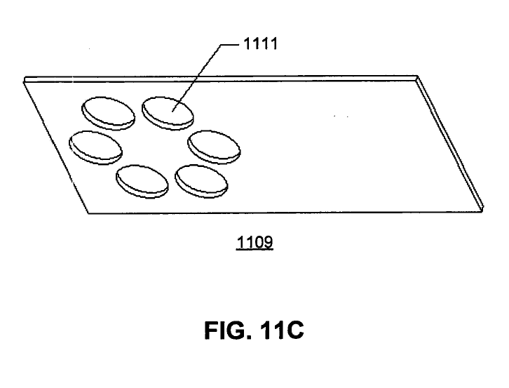

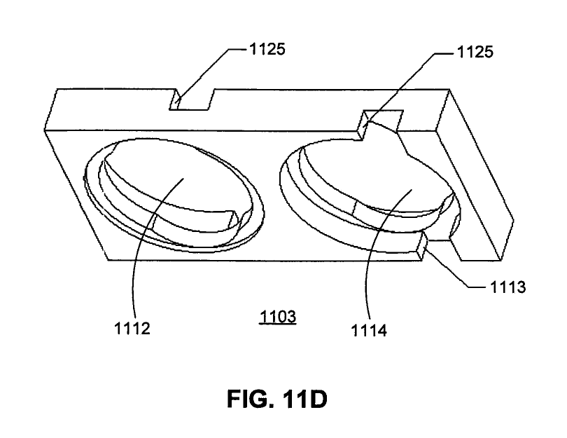

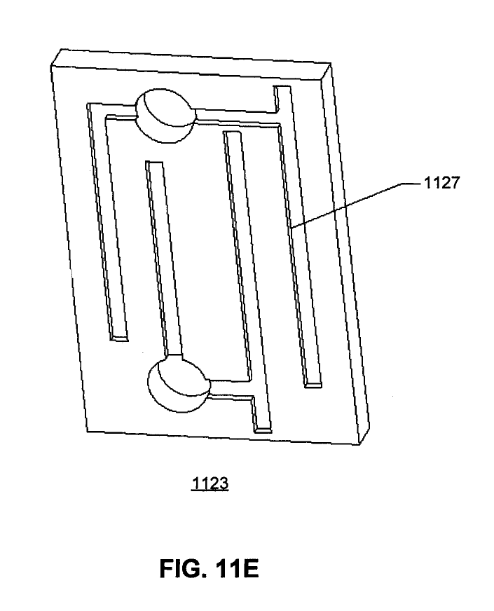

Another exemplary embodiment is illustrated in FIGS. 11A-11E. In particular, FIG. 11A illustrates an exemplary model of another production unit configuration in which the electrodes are bored, generically referred to herein as a bore model 1101.

FIG. 11A illustrates bore model 1101 characterized by two holes bored in alternating positive and negative electrodes 1103 that make up the bulk of chambers. A water disseminator plate 1105, also illustrated in FIG. 11B, forms a base support of bore model 1101. Water disseminator plate 1105 may disperse water 1106 through bore model 1101 via a groove 1107. In another exemplary embodiment, an electrolyte solution or slurry, provided as a conductive solution, made be used instead of water. Alternating positive and negative electrodes 1103 are mounted on water dissemination plate 1105. The alternating positive and negative electrodes 1103 are electrically isolated from each other by insulators 1109 provided between each positive and negative electrode 1103. As illustrated in FIG. 11C, insulators 1109 may be provided with pass-through orifices 1111 on one of a left side and right side thereof. Insulators 1109 may be formed of, for example, a polyvinyl chloride material. As illustrated in FIG. 11D, each electrode 1103 include two generally circular adjacent throughholes 1112 and 1114 through which the above noted electrolyte solution or slurry may pass. Water 1106 is provided within the electrodes 1103 via notches 1113 provided in the electrodes 1103 to align with groove 1107. Water 1106 provides an electrical connection between abutted negative and positive electrodes 1103 separated by insulators 1109. Electrodes 1103 may be formed of similar materials as electrodes 801 and 803 discussed.

A positive electrical connection endcap 1115 and a negative electrical connection endcap 1117 are provided at either end of the abutted plurality of positive and negative electrodes 1103. Positive electrical connection endcap 1115 may be provided with one or more connection terminals 215 that are provided such that connection terminals 215 pass through positive electrical connection endcap 1115 to physically connect to a positive electrode 1119 provided abutting positive electrical connection endcap 1115. Similarly, negative electrical connection endcap 1117 is provided with one or more connection terminals 215 that pass through negative electrical connection endcap 1117 and provide a physical electrical connection to a negative electrode 1121 that abuts negative electrical connection endcap 1117. A gas collector 1123, illustrated in FIG. 11E, is mounted on the plurality of positive and negative electrodes 1103, as well as electrodes 1119 and 1121. With reference to FIG. 11E, hydrogen 119 and oxygen 121 are channeled through gas notches 1125 provided at the top of positive and negative electrodes 1103 via gas transportation grooves 1127 in gas collector 1123. An external hydrogen connection 1129 and an external oxygen connection 1131 are affixed to gas collector 1123. Based on the mode of operation, hydrogen 119 and oxygen 121 may be collected and removed from bore model 1101 via external hydrogen connection 1129 and external oxygen connection 1131, through appropriate configuration of gas transportation grooves 1127. Alternatively, hydrogen 119 and oxygen 121 may be provided to bore model 1101 for a reverse electrolysis reaction resulting in pure water, which is collected in water disseminator 1105 and dispersed via line 1133.

It will now be apparent to one of ordinary skill in the art that units may use a combination of any elements of the multi-electrode cell unit, the bore model, and the single electrode cell in the exemplary operation modes discussed above. The discussion of methods of operation and manufacturing each of these exemplary cell models may be applicable to other exemplary cell models discussed herein or apparent from the discussion herein. One of ordinary skill in the art will now also understand that any unit that includes complementary electrodes, in which at least two electrodes share an electrical connection provided via conductive solution optimized for one of the exemplary modes of operation discussed above, may provide the basis for other exemplary embodiments of the production units discussed above.

Other devices and methods related to the exemplary hydrogen and oxygen production units discussed above will now be described

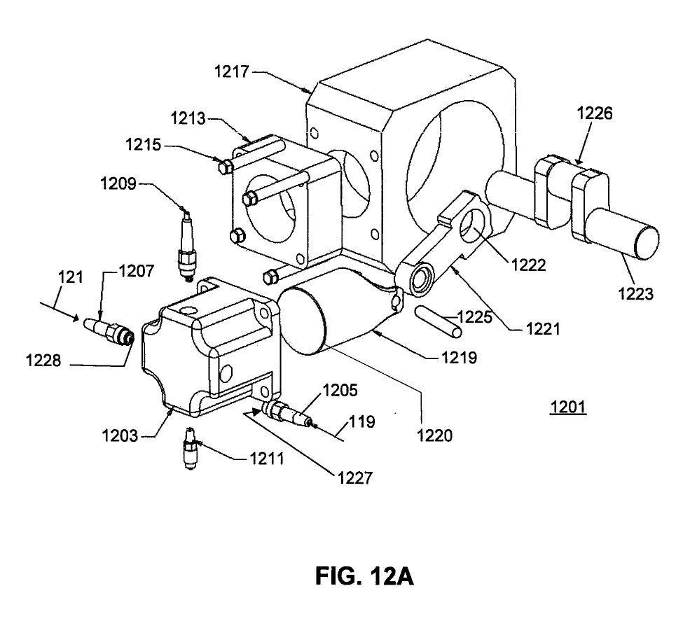

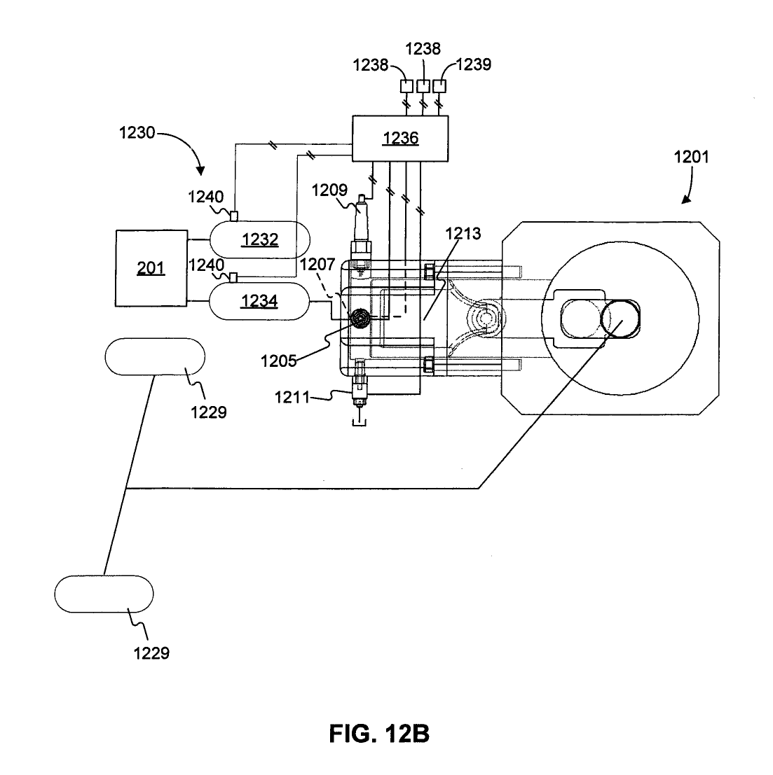

FIG. 12A illustrates an exploded view of an exemplary internal combustion engine 1201 that operates on hydrogen and oxygen, such as hydrogen 119 and oxygen 121 produced by unit 201 (FIG. 2A). Engine 1201 includes a cylinder head 1203 to which hydrogen 119 and oxygen 121 are provided via a hydrogen injector 1205 and an oxygen injector 1207, respectively inserted into openings in opposite sides of cylinder head 1203. Cylinder head 1203 has openings in top and bottom surfaces thereof, to receive a spark plug 1209 and a water ejector 1211, respectively. Cylinder head 1203 is affixed to a cylinder 1213 by bolts 1215. Bolts 1215 also affix the combined cylinder head 1203 and cylinder 1213 to a housing 1217. A piston 1219 provided with seal 1220, a piston rod 1221, and a crankshaft 1223 are provided within a chamber formed by cylinder head 1203, cylinder 1213, and housing 1217. Piston 1219 is secured to piston rod 1221 by a pin 1225. Piston rod 1221 includes an opening 1222 for receiving a middle portion 1226 of crankshaft 1223 to connect piston rod 1221 and crankshaft 1223.

Hydrogen injector 1205 and oxygen injector 1207 are configured as check valves biased to allow fluid flow into the cylinder 1213, but prohibit the flow of fluid out of the cylinder 1213. Alternatively, the hydrogen injector 1205 and oxygen injector 1207 may be configured as a hydraulically, pneumatically, or electronically actuated valve that is controlled with an appropriate valve controller (not shown). The hydrogen injector 1205 and oxygen injector 1207 are coupled to the cylinder head 1203 in any conventional manner, for example, by a threaded engagement. Further, hydrogen injector 1205 and oxygen injector 1207 include respective discharge orifices 1227, 1228 that are numbered and/or sized to provide a desired ratio of fluid volume injected into the cylinder 1213 (i.e., to provide for the formulation of only water or water vapor from the combustion of the hydrogen and oxygen). For example, hydrogen injector 1205 and oxygen injector 1207 may include equally sized orifices in a ratio of two orifices in the hydrogen injector 1205 to a single orifice of the oxygen injector 1207. It is understood, however, that the desired ratio of hydrogen and oxygen injected into the cylinder 1213 could alternatively or additionally be obtained by controlling the injection pressures of the hydrogen and oxygen supply and/or control of the injection timing and/or duration of the hydrogen and oxygen injectors 1205, 1207. In a system where hydrogen 119 and oxygen 121 are supplied to the cylinder 1213 by unit 201 (FIG. 2A), the desired ratio is achieved due to output ratio of the unit 201. It is understood, that one or more sensors (not shown) may be associated with water ejector 1211 to determine whether excess hydrogen 119 or oxygen 121 is exiting the cylinder 1213. If such excess hydrogen 119 or oxygen 121 is being ejected from the cylinder 1213, the supply and/or injectors could be adjusted to provide the desired ratio to the cylinder 1213.

The spark plug 1209 includes a conventional design and receives initiation signals from a controller (shown in FIG. 12B). The spark plug 1209 is coupled to the cylinder head 1203 in any conventional manner, for example, by a threaded engagement. Water ejector 1211 includes a hydraulically, pneumatically, or electronically actuated valve that is controlled with an appropriate valve controller (not shown) to open the water ejector 1211 when it is desired to relieve the cylinder 1213 of water and/or water vapor. Such control of the water ejector 1211 may be time based, cycle based, and/or in response to detected water in cylinder 1213. In addition, water ejector 1211 may include a cooler (not shown) to facilitate formation of water or water vapor.

The materials making up internal combustion engine 1201 are designed for the forces and temperatures of the engine. For example, the housing 1217 may be formed from cast iron, and components such as the cylinder 1213, cylinder head 1203, and the piston 1219 may be formed of steel.

As shown in FIG. 12B, internal combustion engine 1201 may be used as a prime mover for a mobile machine, such as a vehicle having wheels 1229. In such a use, internal combustion engine could be associated with a fuel supply system 1230 including a hydrogen supply plenum 1232, an oxygen supply plenum 1234, and a controller 1236 that receives input from various sensors 1238 and operator controls 1239 to control the internal combustion engine 1201 as desired. The fuel supply system 1230 controls the timing, pressure, and/or amount of hydrogen and oxygen supplied to the cylinder 1213 by way of the hydrogen and oxygen injectors 1205, 1207, and controls the timing of the spark generated by the spark plug 1209 and the timing of the opening of the water injector 1211, all as a function of the sensed conditions and desired power from the sensors 1238 and the operator controls 1239. For example, the controller 1236 controls the pressure of the fluid within the hydrogen supply plenum 1232 and the oxygen supply plenum 1234 by way of plenum control valves 1240, and controls the opening and closing of the hydrogen and oxygen injectors 1205, 1207 to vary the timing and amount of fluid delivered to the cylinder 1213. This provides for a controlled variation in the power supplied by the internal combustion engine 1201. The fuel supply system 1230 may also include one or more fluid supply pumps (not shown) to raise the pressure of the hydrogen and/or oxygen to desired levels. As illustrated, the hydrogen and oxygen is supplied to the fuel system by the unit 201 described above. Alternatively, the hydrogen and oxygen can be supplied to the fuel supply system 1230 by an external source, such as a hydrogen and oxygen filling station (not shown), and stored in the hydrogen and oxygen plenums 1232 and 1234. It is understood that engine 1201 could be configured without one or more of the components/control of the fuel supply system 1230 described above.

It is also understood that internal combustion engine 1201 may include any number of cylinders 1213 coupled to a common crankshaft 1223 to provide the desired power. For example, as shown in FIG. 12C, internal combustion engine 1201′ may be in the form of a 6-cylinder engine. Further, as noted above, the internal combustion engine 1201 may be used in any system where a prime mover is utilized. For example, the internal combustion engine 1201 may be used as a prime mover in a mobile machine to drive traction devices such as wheels 1229 depicted in FIG. 12B, including as part of a hybrid power system for a mobile machine. Alternatively, internal combustion engine 1201 may be used as part of a generator system to produce electrical power. In addition, it is understood that this disclosure is not limited to the particular type of reciprocating piston internal combustion discussed above, but rather can be incorporated in various types of internal combustion engines including, for example, rotary engines and compression ignition engines.

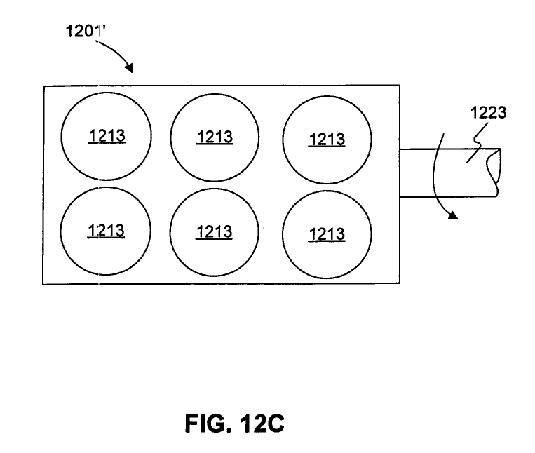

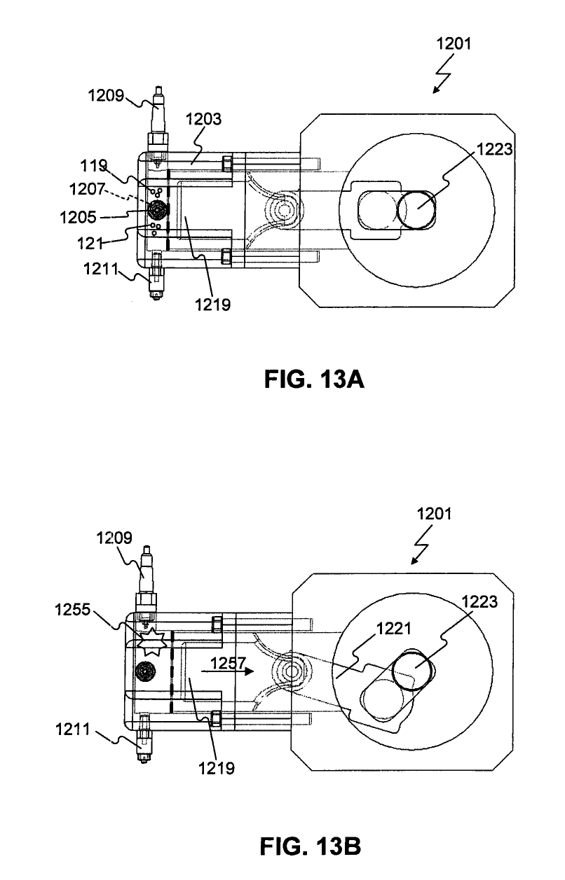

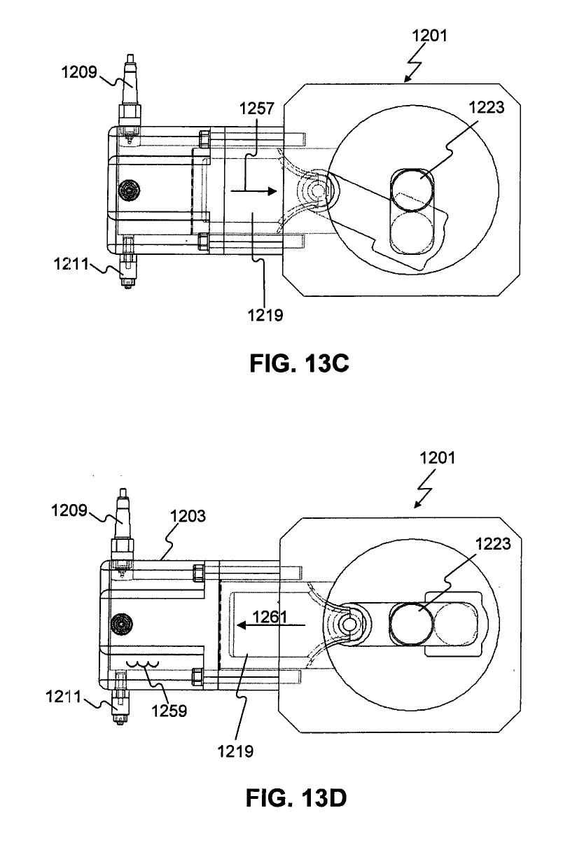

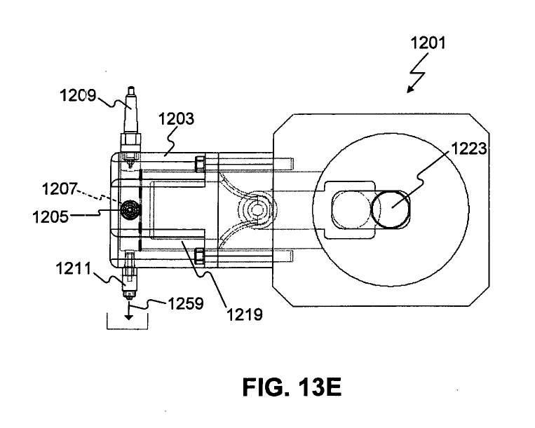

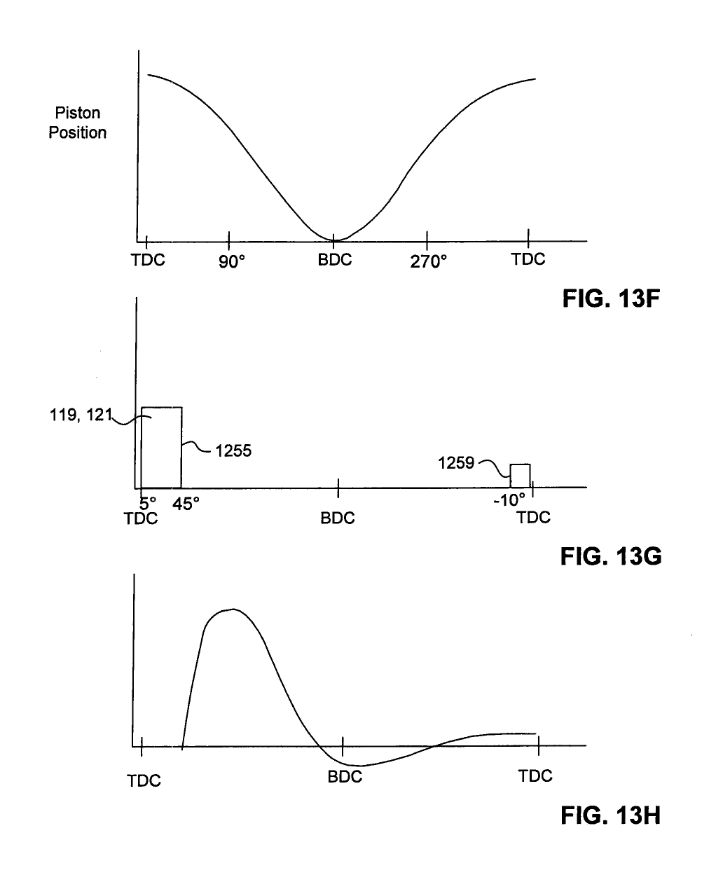

FIGS. 13A-13E are a sequence of side-schematic views of engine 1201 that illustrate a power cycle of operation. Dashed lines are used to delineate the position of the top of piston 1219. As is conventional in internal combustion engines, movement of the piston 1219 is initiated by a starter motor or equivalent device (not shown) that initially drives the crankshaft 1223 to the proper speed and position so that the one or more pistons 1219 are properly situated to be propelled by the combustion of the hydrogen 119 and oxygen 121. In FIG. 13A, hydrogen 119 and oxygen 121 are injected into cylinder head 1203 via hydrogen injector 1205 and oxygen injector 1207, respectively. An exemplary injected ratio of hydrogen 119 to oxygen 121 is one that will achieve a post-combustion 2:1 ratio of hydrogen to oxygen, i.e., equal to the molecular composition of water. In FIG. 13B, the mixture of injected hydrogen and oxygen are ignited by spark 1255 from the spark plug 1209. The ignited mixture combusts to generate a force symbolically shown in FIG. 13B as a force 1257 that drives piston 1219 toward the right, thereby exerting force on piston rod 1221, which conveys force 1257 to crankshaft 1223. As shown in FIG. 13C, force 1257 of the combusted mixture continues to drive piston 1219 to the right.

FIG. 13D illustrates the portion of the power cycle at which combustion is completed. Any residual hydrogen and oxygen remaining in the chamber after combustion is complete recombines to form water or water vapor 1259. The formation of water or water vapor 1259 results in a partial vacuum within cylinder head 1203 and cylinder 1213 and a pressure difference across piston 1219 represented by a force 1261 to the left. Force 1261 provides a pull or suction on piston 1219 toward the left in FIG. 13D. As illustrated in FIG. 13E, the piston 1219 continues to move to the left. During the end of this portion of the power cycle, water ejector 1211 is opened and water and/or water vapor 1259 is forced out of cylinder head 1203 and cylinder 1213 through water ejector 1211. For example, water ejector 1211 may be operated during the motion of piston 1219 through an ending 10 crankshaft degrees of the power cycle. Piston 1219 continues its movement through cylinder head 1203, arriving at the starting position illustrated in FIG. 13A, and the cycle illustrated in FIGS. 13A-13E is repeated. Water ejector 1211 is then closed at the end of the cycle.

FIGS. 13F-H shows a collection of cycle charts for internal combustion engine 1201, where FIG. 13F shows piston movement from top-dead-center, to bottom-dead-center, and back up to top-dead-center, and FIG. 13G indicates exemplary timing of the injection of hydrogen 119 and oxygen 121, sparking 1255 of the mixture, and ejection of water or water vapor 1259. FIG. 13H shows the approximate pressure within the cylinder 1213 during the piston movement of FIG. 13F. As indicated in FIG. 13H, the combustion of the hydrogen 119 and oxygen 121 mixture creates a negative pressure within the cylinder 1213 that aids in moving the piston 1219 back toward top-dead-center.

It will now be apparent to one of ordinary skill in the art that the engine 1201 is different from a traditional internal combustion engine. One difference is that the standard intake and exhaust valves of an internal combustion engine are not required. Another difference is that two forces contribute to the power cycle of engine 1201. First, force 1257 is provided by combustion of hydrogen and oxygen. Second, force 1261 is provided by the negative pressure occurring within the chamber 1213 during the recombination of hydrogen and oxygen as water or water vapor are formed. The negative pressure may aid gas input during operation and also create momentum during the power stroke cycle. Third, one of ordinary skill in the art will now appreciate that engines consistent with the above discussion produce substantially higher torque at lower RPMs than traditional internal combustion engines. For example, a similarly sized traditional internal combustion engine running at 3600 RPM will produce approximately the same torque as the engine 1201 discussed here running at 5 RPM. Moreover, when additional torque is desired, additional hydrogen and oxygen, or multiple combustions, may be provided during the power stroke, for example, during low RPM operation. Fourth, the engine discussed above provides advantages related to heat dissipation compared to traditional internal combustion engines. If desired, additional gas can be routed through the engine to assist in heat dissipation.

A further difference is that the exhaust of engine 1201 is primarily comprised of water or water vapor 1259 as the combustion of the hydrogen 119 and oxygen 121 results in little residual waste. In addition, combustion within engine 1201 is quieter than combustion of traditional engines. Therefore, engine 1201 operates more quietly than traditional combustion engines. For example, when operated without a muffler, engine 1201 may provide a noise reduction of approximately 70% over an unmuffled traditional internal combustion engine.

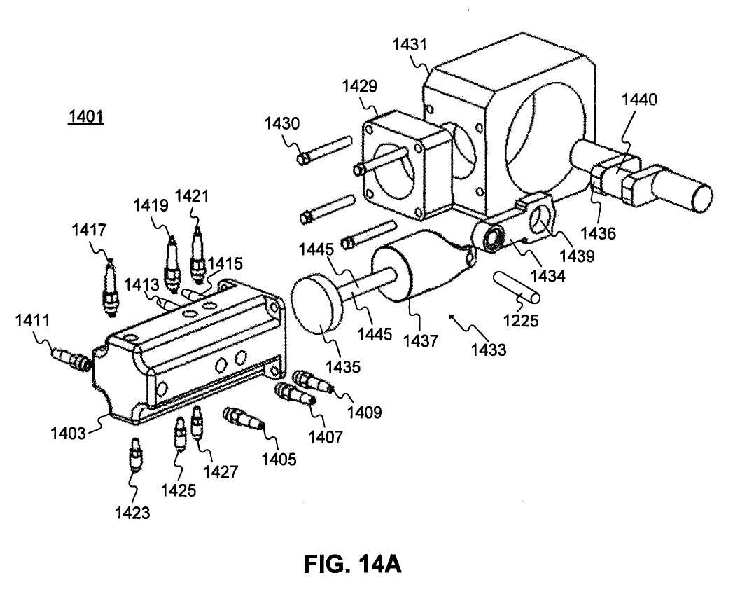

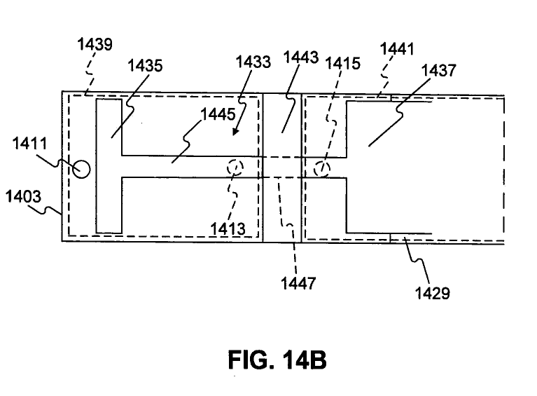

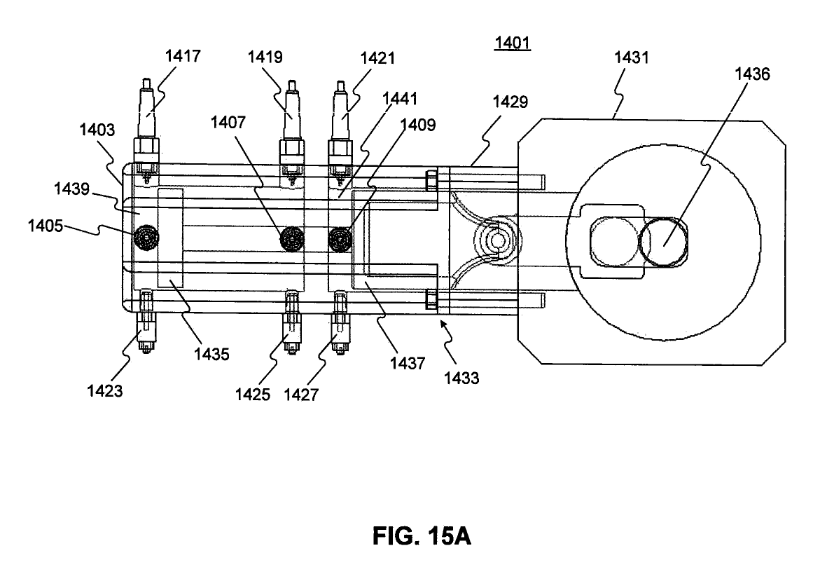

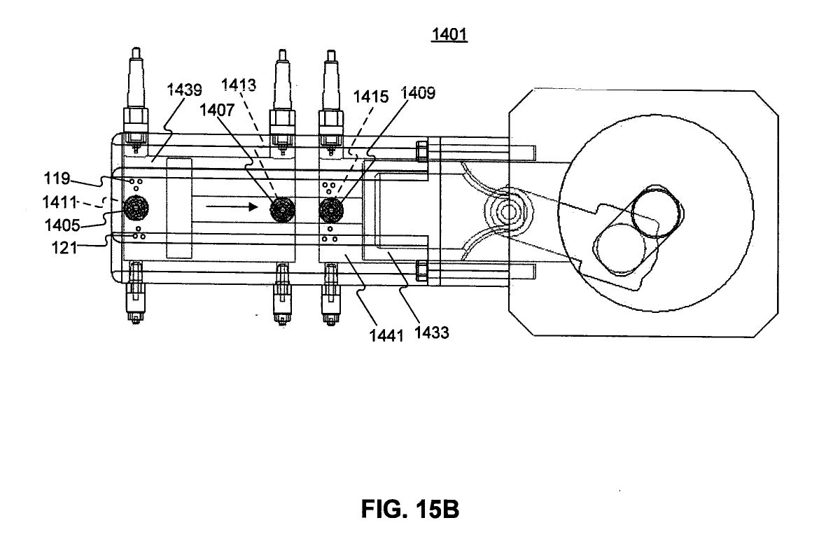

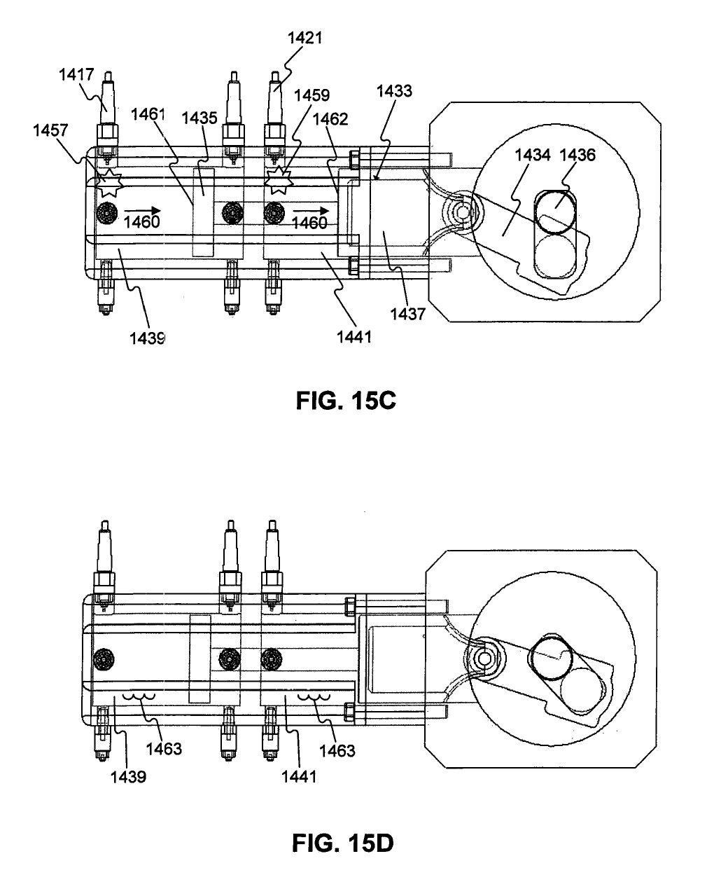

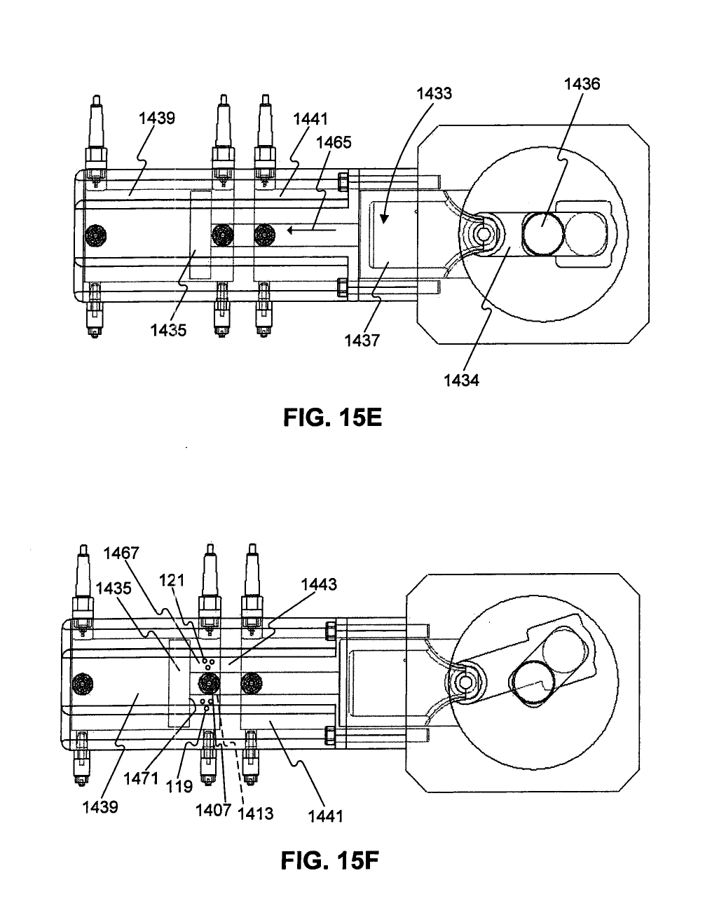

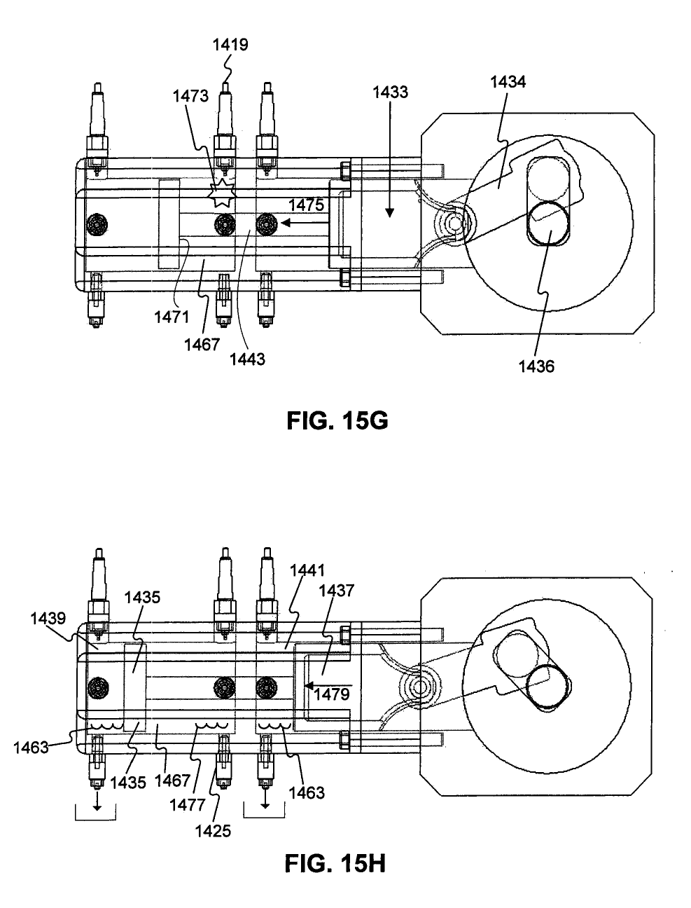

Other embodiments of a hydrogen and oxygen engine are also contemplated. For example, FIGS. 14A, 14B, and 15A-H illustrate a multi-chambered internal combustion engine 1401 that operates on hydrogen and oxygen, such as hydrogen 119 and oxygen 121 produced by unit 201.

FIG. 14A illustrates an exploded view of engine 1401. Cylinder head 1403 is provided with more than one hydrogen injector and oxygen injector for providing hydrogen 119 and oxygen 121 to cylinder head 1403, respectively. More particularly, cylinder head 1403 includes openings to receive, on one side, hydrogen injectors 1405, 1407, 1409 and, on the opposite side, oxygen injectors 1411, 1413, and 1415, to enable injection of hydrogen 119 and oxygen 121 into cylinder head 1403. Cylinder head 1403 also has openings in top and bottom surfaces to receive multiple spark plugs 1417, 1419, and 1421 in the top surface and water ejectors 1423, 1425, and 1427 in the bottom surface. The structure, control, alternatives, and operation of hydrogen injectors 1405, 1407, 1409, oxygen injectors 1411, 1413, 1415, spark plugs 1417, 1419, 1421, and water ejectors 1423, 1425, 1427 are the same in this engine 1401 as in the corresponding components described above in connection with the internal combustion engine 1201 of FIG. 12A. Thus, reference is made to the discussion of these components in FIG. 12A for this engine embodiment. Similarly, all of the various embodiments, structures, alternatives, and operations of engine 1201 of FIG. 12A are equally applicable to this engine 1401.

Cylinder head 1403 is affixed to a cylinder 1429 via bolts 1430. Bolts 1430 also affix cylinder head 1403 and cylinder 1429 to a housing 1431. A piston assembly 1433, piston rod 1434, and crankshaft 1436 are provided in a chamber formed by cylinder head 1403, cylinder 1429, and housing 1431. Piston rod 1434 is coupled to piston assembly via a pin 1225, and piston rod 1434 includes an opening 1439 for receiving a middle portion 1440 of crankshaft 1436 to connect piston rod 1434 to crankshaft 1436. This configuration enables piston assembly 1433 to traverse cylinder head 1403 and cylinder 1429, to drive power through piston rod 1434 to crankshaft 1436.

With reference to FIG. 14B, piston assembly 1433 further comprises two piston heads, 1435 and 1437, which are respectively confined to subchambers 1439 and 1441. In particular, cylinder head 1403 is divided to include subchamber 1439 and subchamber 1441 by a guide or wall 1443. Pistons heads 1435 and 1437 are configured to reciprocatingly traverse subchambers 1439 and 1441, respectively. A connecting rod 1445, which connects piston heads 1435 and 1437, passes through a hole 1447 formed in wall 1443. As shown in FIG. 15A, subchamber 1439 has coupled thereto via the above described openings in cylinder head 1403, hydrogen injectors 1405 and 1407, oxygen injectors 1411 and 1413 (not shown), spark plugs 1417 and 1419, and water ejectors 1423 and 1425. Piston head 1435 is confined within subchamber 1439. Subchamber 1441 has coupled thereto via the above described openings in head 1403, hydrogen injector 1409, oxygen injector 1415 (not shown), spark plug 1421, and water ejector 1427.

FIGS. 15A-15H depict a sequence of side views of engine 1401 that illustrate a power cycle of operation. As is conventional in internal combustion engines, movement of the piston assembly 1433 is initiated by a starter motor or equivalent device (not shown) that initially drives the crankshaft 1436 to the proper speed and position so that the piston assembly 1433 is properly situated to be propelled by the combustion of the hydrogen 119 and oxygen 121. In FIG. 15A, the starting position of piston assembly 1433, including piston heads 1435 and 1437, within head 1403 and cylinder 1429 is illustrated.

As illustrated in FIG. 15B, hydrogen 119 and oxygen 121 are injected into subchamber 1439 via hydrogen injectors 1405 and oxygen injectors 1411, respectively as the subchamber 1439 expands by movement of piston assembly 1433 to the right in the figure. Hydrogen 119 and oxygen 121 may be simultaneously injected into expanding subchamber 1441 via hydrogen injector 1409 and oxygen injector 1415, respectively. The approximate volumetric ratio of injected hydrogen 119 to oxygen 121 may be 2:1.

FIG. 15C illustrates a first combustion step of the power cycle. Spark plugs 1417 and 1421 provide sparks 1457 and 1459 in subchambers 1439 and 1441, respectively, igniting the injected mixture of hydrogen and oxygen. The ignited mixture combusts to generate a forces symbolically shown in FIG. 15C as a force 1460 in subchambers 1439 and 1441 against front face 1461 and 1462 of piston heads 1435 and 1437, respectively. Forces 1460 are transferred through piston assembly 1433 to piston rod 1434, driving crankshaft 1436.

FIG. 15D illustrates the end of the first combustion step. After the first combustion step, any residual hydrogen and oxygen in subchambers 1439 and 1459 begins to recombine to form water or water vapor 1463.

With reference to FIG. 15E, a vacuum forms in subchambers 1439 and 1441 as a result of hydrogen and oxygen recombining at the end of the first combustion step, creating a pressure difference against each of piston heads 1435 and 1437 represented by a force 1465 to the left. Force 1465 is transferred through piston assembly 1433 to rod 1434, driving crankshaft 1436.

FIG. 15F illustrates the next step of the power cycle in which hydrogen injector 1407 and oxygen injector 1413 inject hydrogen 119 and oxygen 121, respectively, into a variable size midchamber 1467. Midchamber 1467 is defined by a variable space between wall 1443 and a backface 1471 of piston head 1435. Variable midchamber 1467 varies in size and overlaps with a portion of subchamber 1439 during the exemplary power cycle of engine 1401.

FIG. 15G illustrates a second combustion step that occurs during the exemplary power cycle of engine 1401. The mixture of hydrogen 119 and oxygen 121 provided to variable midchamber 1467 is combusted by a spark 1473 provided by spark plug 1419 in variable midchamber 1467. The combustion of the mixture between wall 1443 and back face 1471 in variable midchamber 1467 produces a 1475 force to the left in the figure against back face 1471. In particular, force 1475 is provided through piston assembly 1433 to piston rod 1434, driving crankshaft 1436.

FIG. 15H illustrates the end of a single power cycle of engine 1401. Water or water vapor 1477 forms as any residual hydrogen and oxygen combine within variable midchamber 1467. Previously formed water 1463 within subchambers 1439 and 1441 is swept by piston heads 1435 and 1437 as piston assembly 1433 traverses to the left in the figure as designated by arrow 1479.

The power cycle of engine 1401 illustrated above continues, returning to the phase of the power cycle illustrated in FIG. 15A. Water ejection also occurs during the power cycle. Water ejectors 1423 and 1427 are opened, allowing ejection of water or water vapor 1463, prior to injection of hydrogen 119 and oxygen 121 in subchambers 1439 and 1441. Water ejector 1425 is opened, allowing ejection of water or water vapor 1477, prior to the injection hydrogen 119 and oxygen 121 in variable midchamber 1467.

While the internal combustion engine 1401 is described above in connection with the supply of oxygen and hydrogen as the fuel source, it is understood that that engine 1401 could be modified to operate on standard fuels such as gasoline, natural gas, or diesel fuel. Such modifications would be within the knowledge of one of ordinary skill in the art and would include the addition of inlet and exhaust valves, and the omission of the water ejectors.

It will now be apparent to one skilled in the art that the embodiments of engines 1201 and 1401 discussed above, as well as methods of their operation, are merely exemplary and that other embodiments consistent with the above exemplary devices and methods may be achieved. For example, the placement of the various hydrogen and oxygen injectors, water ejectors, and spark plugs may be varied. Moreover, it will now be appreciated by one of ordinary skill in the art that multi-chambered internal combustion engine 1401, and engines formed consistent with the exemplary embodiment discussing it above, will exhibit improved heat dissipation when compared to traditional internal combustion engines. In particular, embodiments consistent with multi-chambered internal combustion engine 1401 allow for smaller diameter cylinders that provide greater surface area for dissipating heat, as compared to traditional internal combustion engines. In addition, the multi-chambered design can be used with water or gas flow to facilitate cooling of the engine during operation.

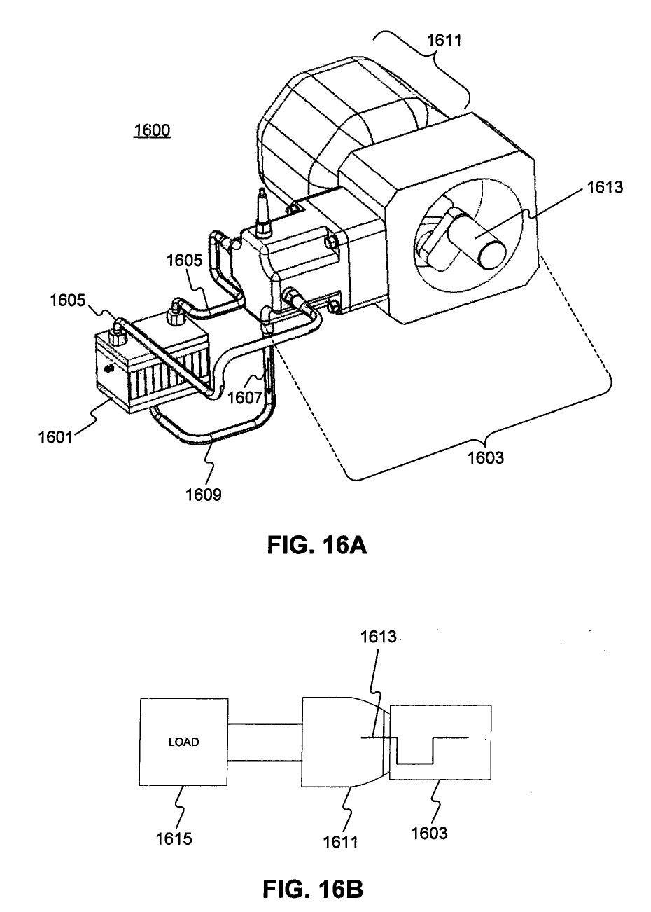

Other exemplary combinations of devices that utilize engines such as engine 1201 or 1401 are also contemplated. One exemplary combination includes a unit, such as unit 201 described above, combined with engine 1201 or 1401 and an electrical energy conversion apparatus. FIG. 16A illustrates such an exemplary combination of elements to form a power generation system 1600. Specifically, FIG. 16A illustrates system 1600 that includes a production unit 1601, consistent with the exemplary unit 201 configured for hydrogen and oxygen production, discussed herein. An internal combustion engine 1603, for example engine 1201 or 1401, is connected to production unit 1601. Production unit 1601 provides hydrogen and oxygen to engine 1603 via supply lines 1605. Production unit 1601 may be configured to produce hydrogen and oxygen in a manner consistent with the exemplary methods and devices discussed herein. Water 1607 generated during operation of engine 1603 may be returned to production unit 1601 via a water return line 1609, thus providing for a closed-loop system operation. Engine 1603 is connected to mechanically drive an alternator 1611 via a crankshaft 1613 that corresponds to crankshaft 1223 or 1436 described above.

With reference to FIG. 16B, crankshaft 1613, which is driven by power provided by engine 1603, is connected to alternator 1611. Alternator 1611 may provide an alternating current to an electrical load 1615, for example, lights or other electrically powered devices.

It will now be apparent to one skilled in the art that system 1600 including production unit 1601, engine 1603, and alternator 1611 may be operated in a variety of modes consistent with the exemplary embodiments discussed herein. For example, alternator 1611 may be provided with a mechanical coupling to another mechanically driven device. Thus, crankshaft 1613 may drive more than one device using power from engine 1603.

System 1600 operates as an environmentally friendly system which generates little or no pollution. In addition, as discussed above, the low noise of the system may be desirable in certain circumstances, particular those where conventional electrical power plants are not desired or feasible.

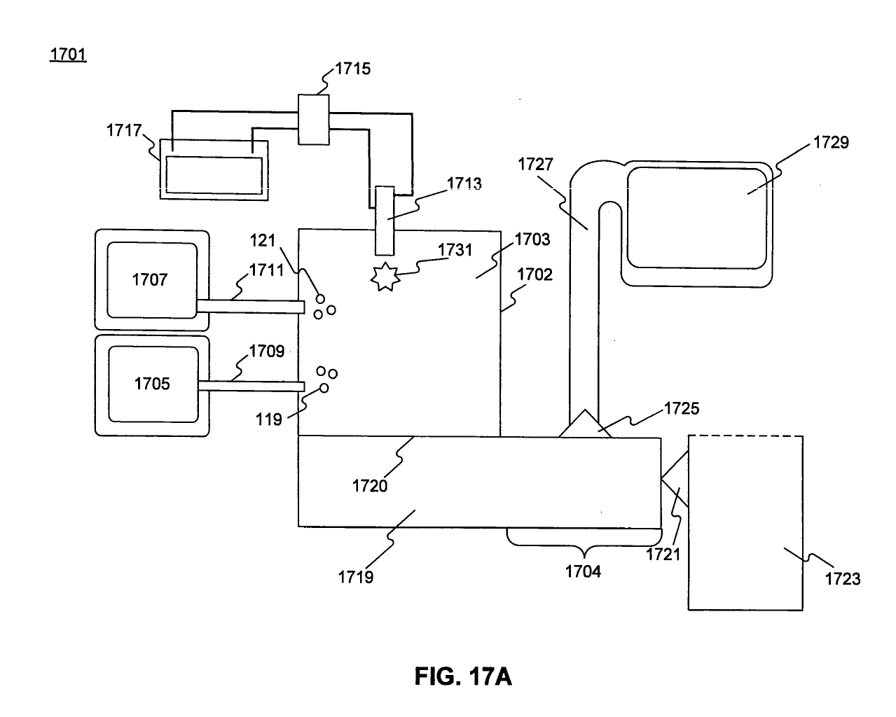

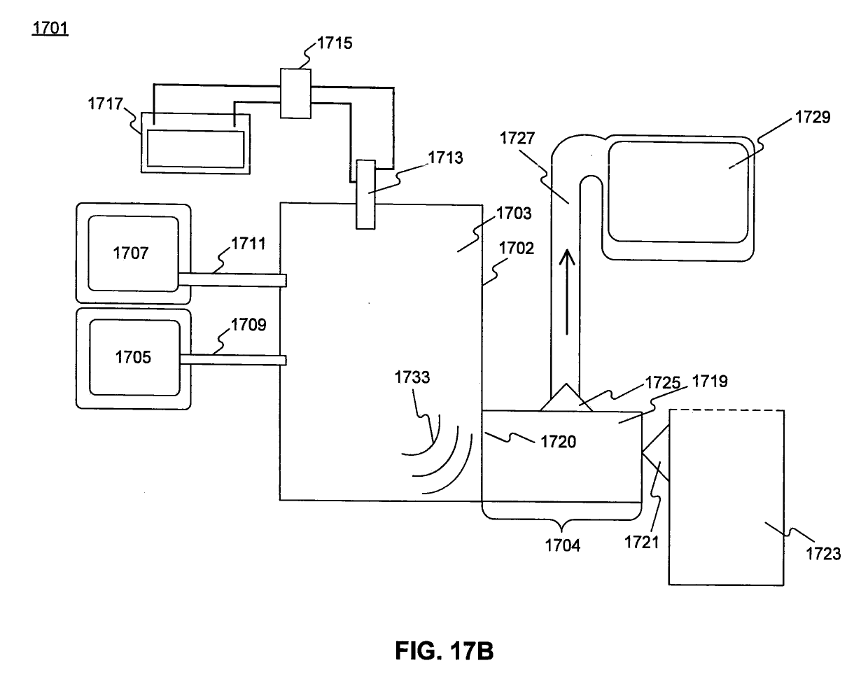

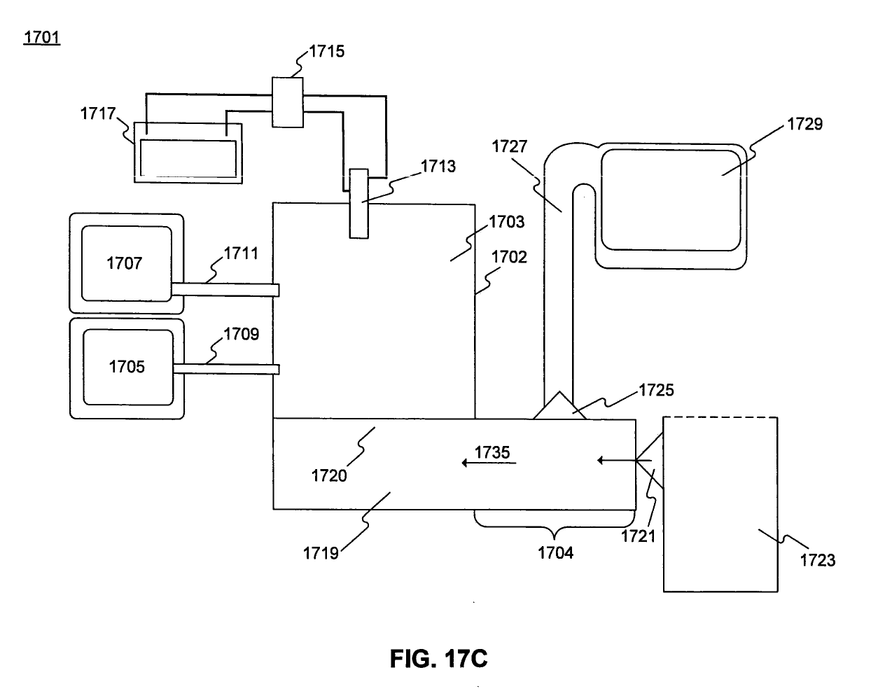

FIG. 17A illustrates a combustion chamber fluid pump 1701. Combustion chamber fluid pump 1701 includes a housing 1702 forming a combustion chamber 1703 including a neck portion 1704. Working fluids, such as hydrogen 119 and oxygen 121 are supplied to the combustion chamber 1703 via a hydrogen supply 1705 and an oxygen supply 1707. For example, hydrogen 119 and oxygen 121 may be provided from one of the exemplary hydrogen and oxygen production units discussed above, such as unit 201. Hydrogen 119 and oxygen 121 may be transported from hydrogen supply 1705 and oxygen supply 1707, respectively, via a hydrogen inlet 1709 and an oxygen inlet 1711, respectively. It is understood that these inlets 1709 and 1711 may include any of the configurations discussed above in connection with the systems of FIGS. 12A and 14A, including hydrogen and oxygen injectors and appropriate control thereof. An ignition source, such as spark plug 1713, is included to provide a spark for combusting a mixture of hydrogen 119 and oxygen 121 provided in combustion chamber 1703. Spark plug 1713 may be connected to a controller 1715, which controls electrical current provided to spark plug 1713 from a battery 1717.

A pumping fluid 1719, for example water, is provided within a lower portion of housing 1702 forming an interface 1720 between the workings fluid 119 and 121 in the combustion chamber 1703 and the pumping fluid 1719 in neck portion 1704. Neck portion 1704 includes a pumping fluid inlet via a one-way valve, such as supply check valve 1721, supply check valve 1721 being provided between housing 1702 and a pumping fluid supply 1723, e.g., a water supply. Neck portion 1704 includes a pumping chamber outlet via a transfer check valve 1725, transfer check valve 1725 being provided between a transfer tube 1727 and neck portion 1704 of housing 1702. Transfer tube 1727 connects to a reservoir 1729 of fluid, e.g., water, and provides a conduit for conveying fluid 1719 to fluid reservoir 1729.

Operation of the combustion chamber fluid pump 1701 is explained with reference to FIGS. 17A-C. FIG. 17A illustrates a first phase of the operation of combustion chamber fluid pump 1701. Hydrogen 119 and oxygen 121 are provided to combustion chamber 1703 from hydrogen supply 1705 and oxygen supply 1707 via hydrogen inlet 1709 and oxygen inlet 1711, respectively. Hydrogen 119 and oxygen 121 may be provided in a volumetric ratio to achieve an atomic ratio of 2:1 to facilitate formation of water after combustion. After a sufficient amount of hydrogen 119 and oxygen 121 are provided within combustion chamber 1703, a spark 1731 is provided by spark plug 1713. Controller 1715 may provide automatic or manual control of the frequency of spark 1731 generation by spark plug 1713. Upon introduction of spark 1731, the mixture of hydrogen 119 and oxygen 121 will combust.

FIG. 17B illustrates a second phase of the operation, involving the movement of fluid 1719 within housing 1702 after combustion of hydrogen 119 and oxygen 121. The combustion produces a heat wave 1733 that forces fluid 1719 into a right side portion of neck portion 1704. Based on the pressure of heat wave 1733, which proceeds through neck portion 1704, fluid 1719 is forced through transfer check valve 1725, through transfer tube 1727, and into fluid reservoir 1729.

FIG. 17C illustrates a third phase of operation of the combustion chamber fluid pump 1701. After combustion of hydrogen 119 and oxygen 121 is complete, heat wave 1733 dissipates. In addition, any residual hydrogen 119 and oxygen 121 recombine to form water, causing a pressure drop in combustion chamber 1703 and, thereby, a pressure difference illustrated as a force 1735 that pulls fluid 1719 back through neck portion 1704. Force 1735 also results in transfer check valve 1725 closing and supply check valve 1721 opening, allowing additional fluid 1719 from pumping fluid supply 1723 to enter housing 1702. Fluid 1719 may then be restored to its previous level within the lower portion of housing 1702. As force 1735 dissipates and pressure within combustion chamber 1703 returns to the pre-combustion level, the operation cycle of combustion chamber fluid pump 1701 is complete. The operation cycle may be repeated to effect a continuous operation of pumping fluid 1719 from pumping fluid supply 1723 to reservoir 1729.

In view of the above discussion of FIG. 17A-17C, other embodiments and applications will now be apparent to one skilled in the art. For example, pumping fluids (liquid or gas) other than water may be conveyed from pumping fluid supply 1723 to fluid reservoir 1729. A flexible baffle or other similar device may be used in place of supply check valve 1721 and/or transfer check valve 1725. Alternatively, a flexible baffle may be provided to divide neck portion 1704 to facilitate transfer of pumping fluid 1719 from supply 1723 to reservoir 1729. In this alternative embodiment, the baffle confines a portion of a fluid on one side of the neck portion and the combustive pump will operate on another portion or another fluid confined on the other side of the divided neck portion including the check valves. Moreover, fluid supply 1723 may be, for example, a pipe including a check valve or equivalent device, provided to a free body of fluid, such as a lake or stream.

Other embodiments applicable to other technical problems will now also be apparent to one skilled in the art and may be realized without substantially deviating from the exemplary embodiment discussed above. For example, any gas that will not combust during the operation of the combustion chamber fluid pump 1701, as discussed above, may be substituted for pumping fluid 1719. In such an exemplary embodiment, similar methods and devices can be used to transport gases through combustion chamber fluid pump 1701, which can act as a compressor for gases such as air or other appropriate gases. It is also contemplated that the hydrogen and oxygen supply can be replaced with an alternative one or more combustible fluids.

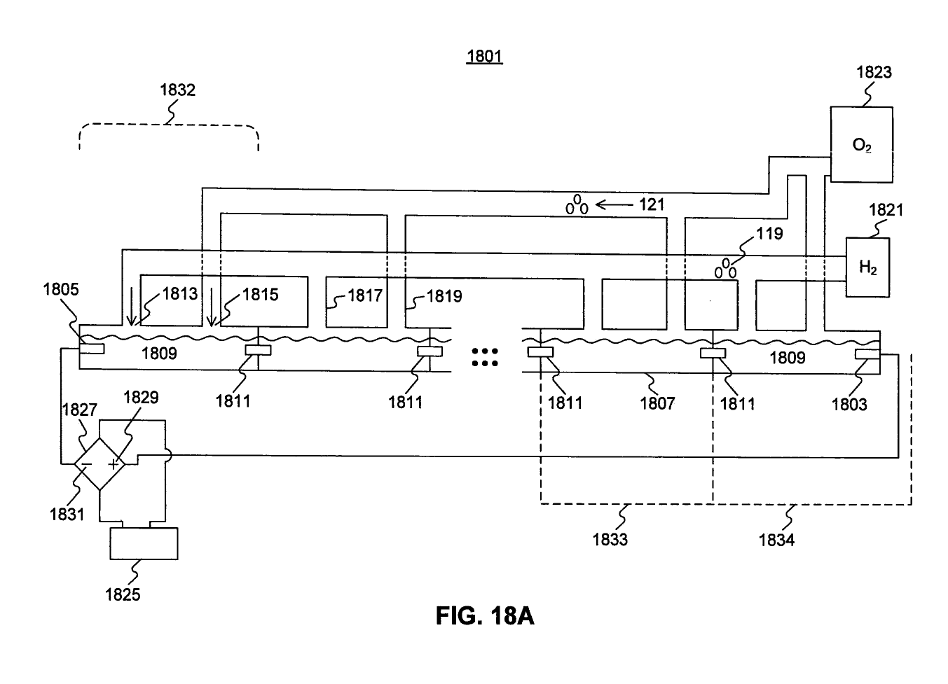

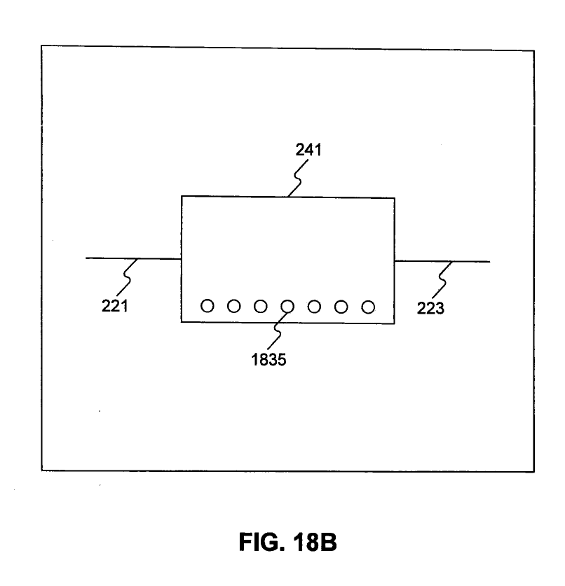

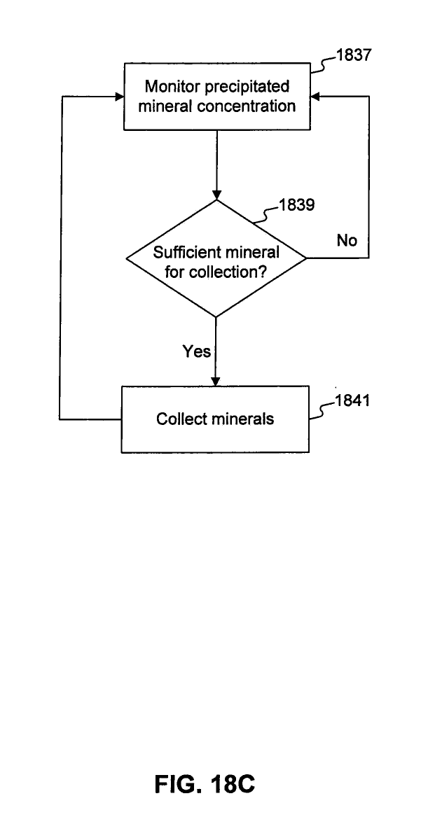

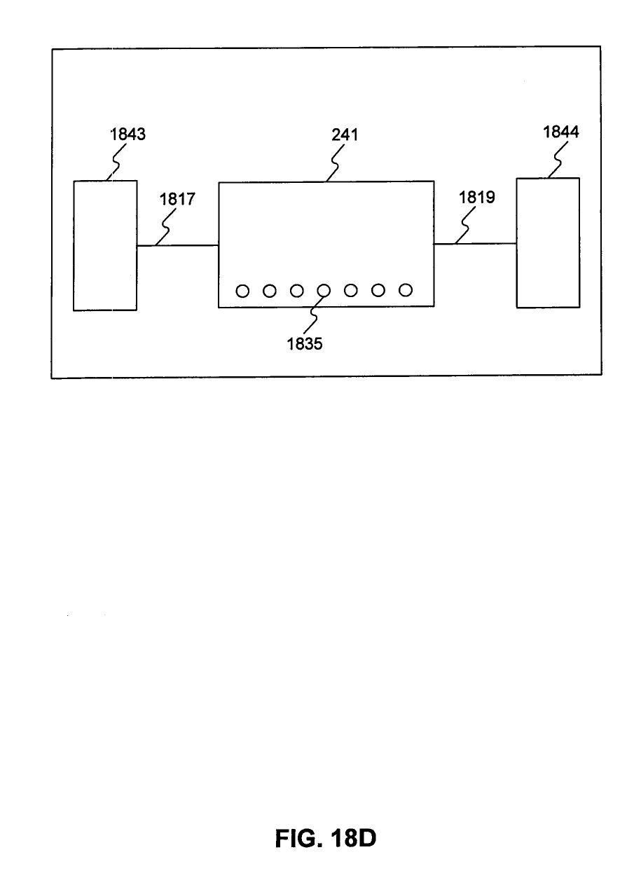

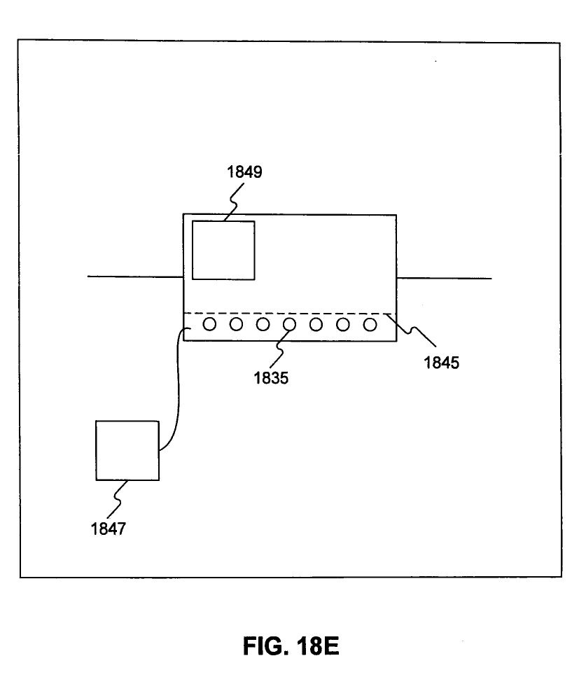

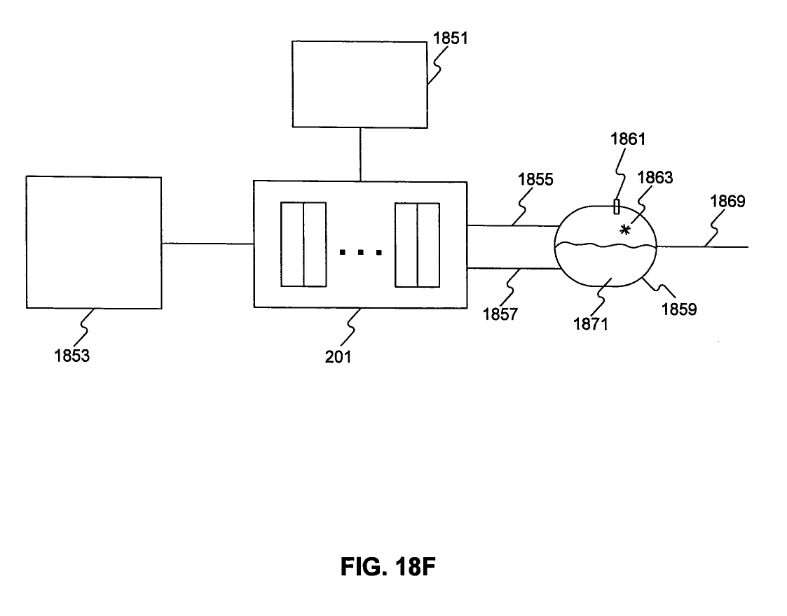

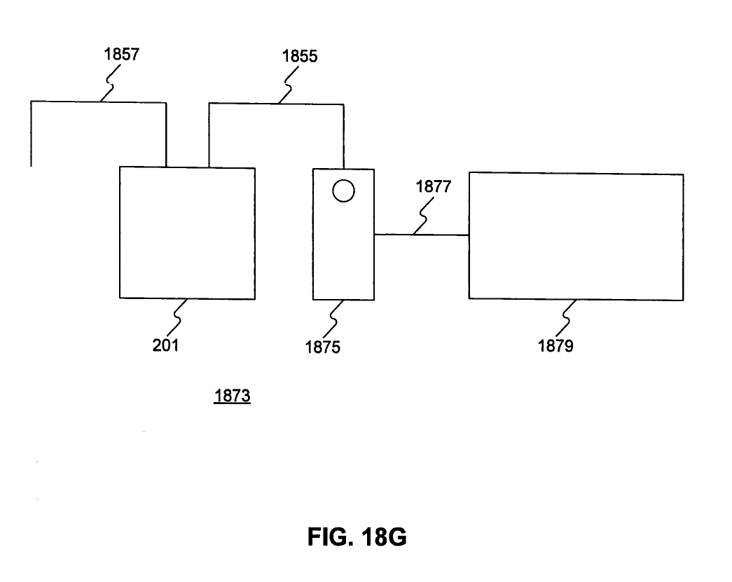

Other embodiments consistent with the above discussed unit 201 and cells 203 are illustrated in FIGS. 18A-G.

FIG. 18A illustrates a dedicated hydrogen and oxygen generator (DHOG) 1801. An anode electrode 1803 and a cathode electrode 1805 are provided in a chamber 1807. Chamber 1807 contains a conductive, electrolytic solution 1809 capable of being electrolyzed, for example, sea water. Shared electrodes 1811 are provided between alternating hydrogen capture orifices 1813 and oxygen capture orifices 1815. Shared electrodes 1811 are electrically connected to cathode electrodes 1803 and 1805, and with other electrodes 1811 by electrolytic solution 1809 provided therebetween. Shared electrodes 1811 also separate and confine electrolytic solution 1811 provided therebetween, for example, confining a portion of solution 1809 between adjacent electrodes 1811, consistent with the structure of cells discussed above. Consistent with other embodiments discussed herein, electrolytic solution 1809 may be provided continuously or periodically. Hydrogen capture orifices 1813 and oxygen capture orifices 1815 are connected to hydrogen collection tubes 1817 and oxygen collection tubes 1819, respectively. Hydrogen 119 and oxygen 121 are conveyed through hydrogen capture orifices 1813 and oxygen capture orifices 1815, respectively, to hydrogen collection tubes 1817 and oxygen collection tubes 1819, respectively. Hydrogen 119 and oxygen 121 are collected via hydrogen collection tubes 1817 and oxygen collection tubes 1819, respectively, and conveyed to a hydrogen reservoir 1821 and an oxygen reservoir 1823, respectively. A maximum level of electrolytic solution 1809 may be provided such that solution 1809 does not enter reservoirs 1821 and 1823. An AC electrical source 1825 provides current to a bridge rectifier 1827, which in turn applies a DC voltage across cathode electrode 1805 and anode electrode 1803 via terminals 1829 and 1831 of bridge rectifier 1827, respectively. DC current is conducted through solution 1809, provided between cathode electrode 1805 and an adjacent shared electrode 1811. Current is also conducted to the other shared electrodes 1811 provided adjacent to each other in chamber 1807 via solution 1809. The circuit between terminals 1829 and 1831 is completed at anode electrode 1803 and an adjacent shared electrode 1811, which again uses solution 1809 to electrically conductively connect these electrodes.

Operation of DHOG 1801 results in the production of hydrogen 119 and oxygen 121. Hydrogen 119 and oxygen 121 result from the electrolytic solution 1809. Electrolysis of solution 1809 occurs between complementary pairs of electrodes 1811, as well as between anode electrode 1803 and cathode electrode 1805 and their nearest adjacent electrode 1811, respectively. Hydrogen 119 and oxygen 121 flow through hydrogen capture orifices 1813 and oxygen capture orifices 1815, respectively. Hydrogen 119 and oxygen 121 are then conveyed to hydrogen reservoir 1821 and oxygen reservoir 1823, respectively, via hydrogen collection tubes 1817 and oxygen collection tubes 1819, respectively.

Three exemplary DHOG chambers 1832, 1833, and 1834, which make up chamber 1807, are illustrated in FIG. 18A. DHOG chamber 1832 includes cathode electrode 1805 and its nearest adjacent shared electrode 1811, which share a portion of solution 1809 provided between cathode electrode 1805 and its nearest adjacent shared electrode 1811. DHOG chamber 1833 is another exemplary example of an appropriate chamber and includes two adjacent shared electrodes 1811 with shared solution 1809. DHOG chamber 1834 is yet another exemplary chamber and includes anode electrode 1803, its nearest adjacent shared electrode 1811, and a portion of solution 1809.

In one embodiment of DHOG 1801, nine adjacent shared electrodes 1811 are provided between cathode electrode 1805 and anode electrode 1803. A voltage of 110 DC volts may be applied to such a configuration to produce ten functioning chambers including one chamber 1832, one chamber 1834, and eight chambers 1833. In an alternative embodiment, a voltage of 220 DC volts may be applied to DHOG 1801 that includes nineteen adjacent shared electrodes, producing twenty functioning chambers including one chamber 1832, one chamber 1834, and eighteen chambers 1833. Configurations such as the exemplary embodiments discussed above allow current to be recycled.

Recycled is used here to indicate that although current passes through a unit during operation, it passes through the unit with very little potential lost due to the low resistance of the production unit. Losses are analogous to losses between coupled diodes. For example, current may be recycled over a number of units provided in series with each other. That is, current will pass through a first unit to a second unit, with little loss of current amperage because of the low resistance encountered by the current when an appropriate voltage is applied.

It will now be apparent to one of skilled in the art that DHOG 1801 described above allows for high volume gas production with very high electrical efficiency. It will also now be apparent to one skilled in the art that hydrogen reservoir 1821 and oxygen reservoir 1823 need not be limited to storage only, but may supply gas to other devices, such as compression pumps, to facilitate high volume storage.

FIGS. 18B-E illustrate another exemplary application of cell 241. FIG. 18B illustrates cell 241 symbolically including a precipitate 1835. Cell 241 may include a hydrogen collection tube 1817 and an oxygen collection tube 1819 consisting of a combination of tubing 255, orifices 227, 229, 409, and 411, and end collection tubes 221 and 223, discussed above. Minerals, such as electrolytes, and other foreign matter present in conductive solution 257 will precipitate out of conductive solution 257 over time during operation of cell 241 as precipitate 1835. With reference to FIGS. 5C-5F, such precipitate 1835 may gather in bottom collector 505 provided in cell 241. After a period of operation of cell 241, the amount of precipitate 1835 in collector 505 may be substantial. In an exemplary method of operation of cell 241, these minerals and other foreign matter can then be collected from cell 241.

In one exemplary mode of operation, a slurry including water and minerals and/or other foreign matter may be provided in cell 241 as conductive solution 257. The precipitated minerals and foreign matter will accumulate in the bottom collection reservoirs 505 as precipitate 1835 to be gathered and removed. Exemplary uses of this particular implementation include mineral extraction from mining waste or other slurries containing precious metals such as gold, silver, or platinum, which will precipitate during electrolysis and can be extracted after coming to rest in the bottom collection reservoir 505. Agitation of the minerals or foreign matter in cell 241 may be conducted to assist in collection of extraction.

It will now be appreciated by one of ordinary skill in the art that the material collection mode describe above may be practiced for other uses beyond those in the exemplary embodiments discussed above. Other modes of operation are also possible and cell 241 may be operated in a number of ways that will allow a user to, for example, use cell 241 as a desalination unit, by appropriately configuring cell 241 and using, for example, sea water as conductive solution 257. In general, any conductive solution with foreign matter present therein, where the foreign matter will precipitate during electrolysis, may be used as conductive solution 257.

FIG. 18C illustrates another exemplary embodiment consistent with this disclosure. With reference to FIG. 18B and the discussion thereof above, precipitates within conductive solution 257 may be monitored using appropriate methods, as illustrated in a step 1837. A step 1839 illustrates a decision made as to whether or not sufficient material, e.g., precipitate 1835, is present to warrant collection. If sufficient material is present, it is collected as illustrated in a step 1841. If sufficient material is not present, monitoring will continue at step 1837.

FIG. 18D illustrates another exemplary embodiment consistent with the disclosure. FIG. 18D includes cell 241 provided with collection tubes 1817 and 1819, discussed above. Collection tubes 1817 and 1819 connect cell 241 to a flush means 1843 and an extraction means 1844, respectively.

Once the level of precipitate 1835 is sufficient for collection, flush means 1833 may flood cell 241 with a fluid, e.g., conductive solution 257, forcing precipitate 1835 through cell 241 to extraction means 1844. Precipitate 1835 is then separated from conductive solution 257 by extraction means 1844 for recovery.

FIG. 18E illustrates another exemplary embodiment consistent with this disclosure. FIG. 18E illustrates cell 241 with a removable bottom portion 1845. Once sufficient precipitate 1835 is present, bottom portion 1845 can be removed to extract precipitate 1835.

It will now be apparent to one of ordinary skill in the art that recovery of precipitate 1835 can be conducted in a number of ways illustrated above or by using other methods consistent with the discussion above. With further reference to FIG. 18E, a monitoring means 1847, which detects the amount of precipitate 1835, may be provided to cell 241 and used to determine when recovery of precipitate 1835 is desirable. Alternatively, a counter 1849 may be provided to cell 241 that tracks the amount of time of operation of cell 241. With further reference to FIG. 18D, an automatic system may provide an automated flush and extraction cycle based on a time provided by counter 1849 or a signal received from monitoring means 1847. Similarly, an operator or automated system may remove bottom portion 1835 to recover precipitate 1835 based on a signal received from monitoring means 1847 or counter 1849. It will now be apparent to one of ordinary skill that the placement of various elements discussed above with respect to FIGS. 18D and 18E are illustrated in an exemplary manner, but may be provided at other locations and via other connection schemes to facilitate recovery of precipitate 1835.

FIG. 18F illustrates another exemplary embodiment consistent with the disclosure. FIG. 18F illustrates a system for creating purified water from a non-potable water source 1851, for example, sea water or water having biological contaminants present therein. A power supply 1853 is provided to unit 201 and hydrogen lines 1855 and oxygen lines 1857 deliver hydrogen 119 and oxygen 121 created by unit 201 to a chamber 1859. An ignition system 1861 is provided to chamber 1859 for providing ignition 1861, for example a spark 1865, therein. A purified water line 1869 is provided to transport pure water 1871 from chamber 1859.

With further reference to FIG. 18F and the embodiments discussed above, a method of producing pure water is illustrated. Hydrogen 119 and oxygen 121 are created by unit 201. Hydrogen 119 and oxygen 121 are provided to chamber 1859 by appropriately configuring unit 201. Hydrogen 119 and oxygen 121 are combusted in chamber 1859 by providing spark 1863. After combustion is complete, pure water 1871 is formed by the combusted hydrogen 119 and oxygen 121. It is noted that any microbes and other foreign biological matter will not survive in unit 201, particularly when operated at higher temperature capable of killing any such biological substances. Pure water 1871 can then be channeled out of chamber 1859 using purified water line 1869. It is understood that chamber 1859 would be configured with appropriate pressure relief features, such as a pressure relief valve.

FIG. 18G illustrates another exemplary embodiment consistent with the disclosure. FIG. 18G illustrates a system for providing a filling station 1873 for providing hydrogen to a vehicle that operates using hydrogen as a fuel. Unit 201 is provided and connected to a filling means 1875 via hydrogen line 1855. Oxygen line 1857 is also provided connected to unit 201. A dispensing means 1877, for example a combined line and dispenser, may be used to provide hydrogen to a vehicle 1879 from filling means 1875.

With further reference to FIG. 18G, a method of operating a filling station 1873 is illustrated. Unit 201 is operated in a manner consistent with the exemplary embodiments above, for example, to create hydrogen 119 and oxygen 121. Hydrogen 119 is conveyed to filling means 1875 and then through dispensing means 1877 to provide hydrogen 119 to vehicle 1879. Oxygen 119 produced by unit 201 may be, for example, stored or conveyed to a suitable location, for use. Alternatively, oxygen 119 may be released into the atmosphere.

It will now be apparent to one of ordinary skill in the art that using apparatus and methods as illustrated above provide hydrogen on demand, eliminating storage requirements and reducing safety issues associated with conventional hydrogen filling stations. In particular, because hydrogen is produced on demand, the amount of hydrogen present is lower than when stored hydrogen is used as the source of hydrogen for filling vehicles. As long as a sufficient number of cells are used for unit 201, sufficient hydrogen may be produced. When the number of cells 241 required is impractical or commercially infeasible, however, additional hydrogen 119 may be produced and stored. In such cases, hydrogen 119 may be produced during times of low electrical demand, to maximize the efficiency of electricity produced that would otherwise be inefficiently used or lost during the low demand period.

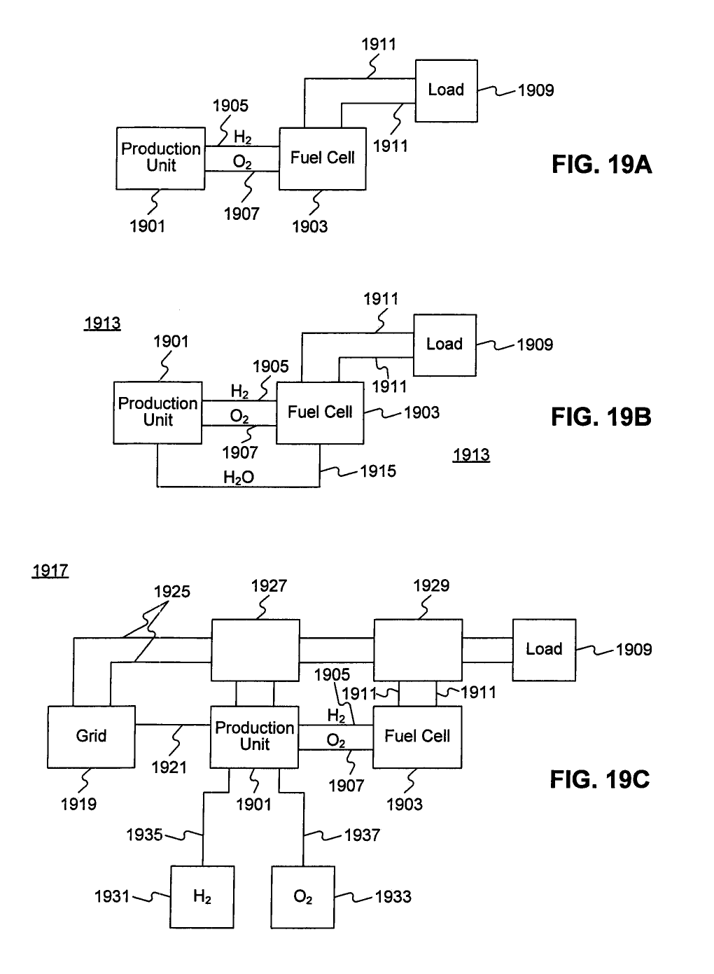

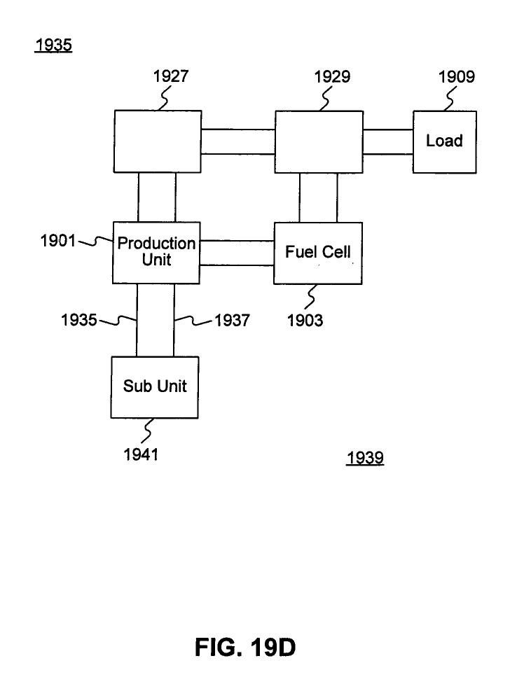

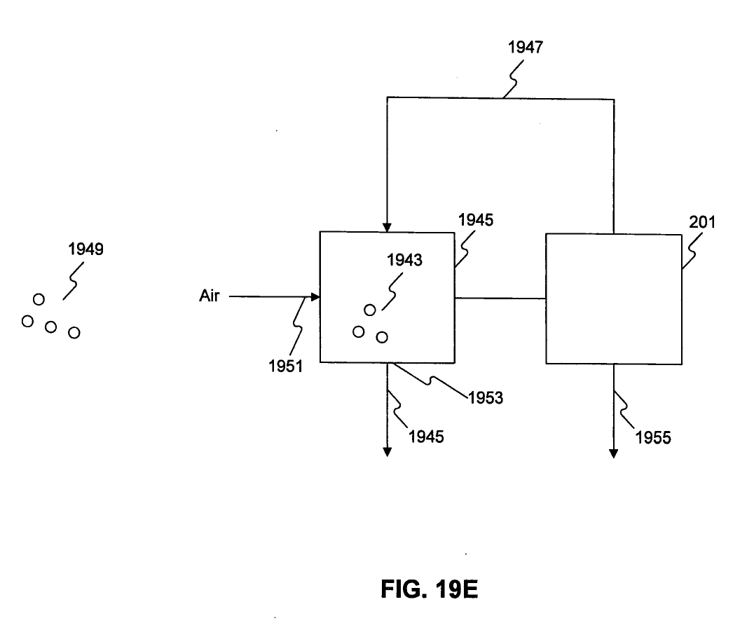

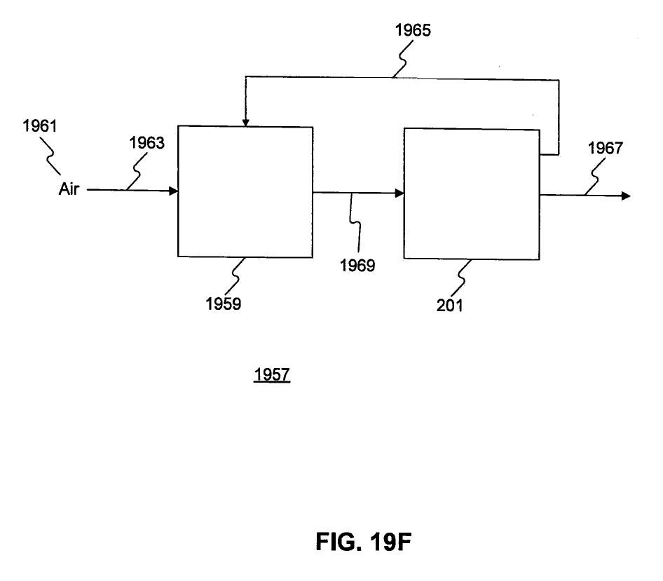

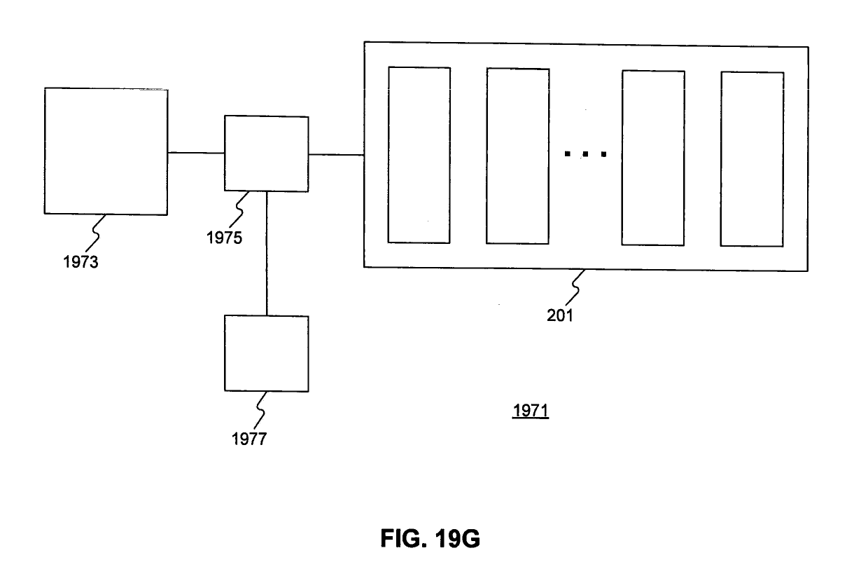

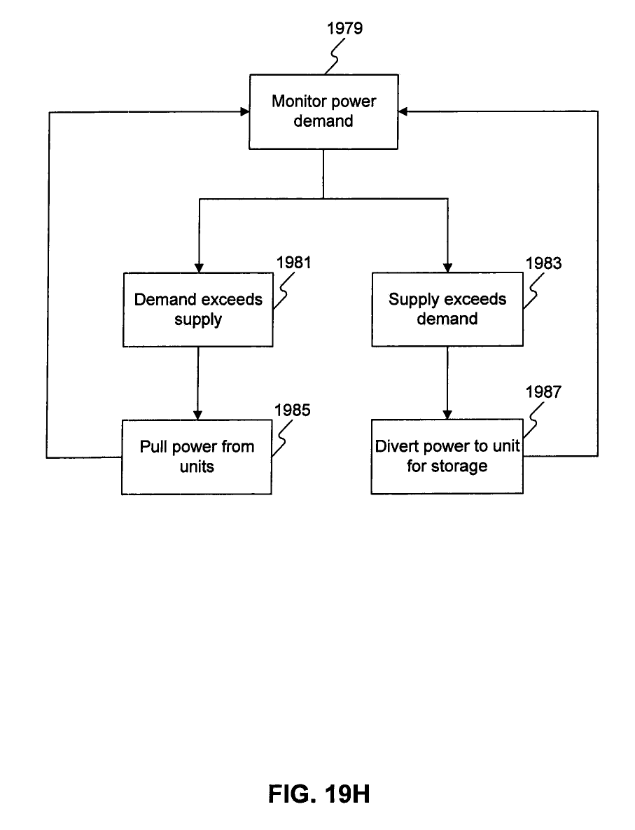

FIGS. 19A-19I illustrate numerous exemplary embodiments using cells 203 with various other exemplary embodiments illustrated in this disclosure.

FIG. 19A illustrates an exemplary combination of a production unit 1901 with a fuel cell 1903. Fuel cell 1903 may be, for example, a low or high temperature proton exchange membrane fuel cell, a solid oxide fuel cell, or another fuel cell having a different catalyst material. As used in this exemplary embodiment, production unit 1901 provides hydrogen 119 and oxygen 121 via a hydrogen transfer line 1905 and an oxygen transfer line 1907, respectively, to fuel cell 1903. Fuel cell 1903 converts hydrogen 119 and oxygen 121 to electrical power which is provided to an electrical load 1909 via power lines 1911. Production unit 1901 may be, for example, unit 201 appropriately configured to produce hydrogen and oxygen, consistent with the discussion herein.

FIG. 19B illustrates an alternative exemplary configuration of a closed loop system 1913. Production unit 1901, hydrogen and oxygen transfer lines 1905 and 1907, and fuel cell 1903 are configured to provide power to electrical load 1909 via power lines 1911, in a manner similar to the exemplary configuration illustrated in FIG. 19A. A water return line 1915 is provided from fuel cell 1903 to production unit 1901 to provide water produced during operation of fuel cell 1903 to production unit 1901. Thus, water return line 1915 closes the loop between production unit 1901 and fuel cell 1903 by providing waste water to production unit 1901.

FIG. 19C illustrates yet another exemplary configuration of a system 1917 for combining production unit 1901 with fuel cell 1903. Production unit 1901, hydrogen and oxygen transfer lines 1905 and 1907, and fuel cell 1903 are configured to provide power to electrical load 1909 via power lines 1911, in a manner similar to the exemplary configuration illustrated in FIG. 19A. In addition, power is provided to production unit 1901 from an electrical grid 1919 via a grid power line 1921. Power provided by grid power line 1921 allows production unit 1901 to produce hydrogen 119 and oxygen 121, which is provided to fuel cell 1903. Fuel cell 1903 then converts hydrogen 119 and oxygen 121 into electrical power that may be provided to electrical load 1909. Tie lines 1925 are provided to connect grid 1919 to controllers 1927 and 1929. Controllers 1927 and 1929 control current flow from and to production unit 1901 and fuel cell 1903, respectively. In addition, hydrogen storage 1931 and oxygen storage 1933 may be coupled to production unit 1901 via a hydrogen transport line 1935 and an oxygen transport line 1937.

An exemplary operation of configuration 1917 is now discussed with reference to FIG. 19C. Generally, it is desirable to operate fuel cells in a constantly on state. A constantly on state of operation is preferable over operation that requires intermittently turning a fuel cell on and off, because turning off or restarting a fuel cell reduces its operating efficiency. However, load 1909 may not require a continuous supply of power from fuel cell 1903. In order to facilitate operation of fuel cell 1903 in a constantly on state of operation, controllers 1927 and 1929 can be used to detect low demand of load 1909 and direct power from fuel cell 1903 to grid 1919. Alternatively, controllers 1927 and 1929 may direct power to production unit 1901 to produce hydrogen 119 and oxygen 121, conveyed to hydrogen storage 1931 and oxygen storage 1933, respectively. In particular, hydrogen transport line 1935 and oxygen transport line 1937 convey hydrogen 119 and oxygen 121, respectively, produced using excess power generated by fuel cell 1903. Stored hydrogen 119 and oxygen 121 may then be utilized, for example, in other applications, e.g., industrial or medical applications.

Yet another exemplary configuration of a system 1939 is illustrated in FIG. 19D. Controllers 1927 and 1929 are again provided to production unit 1901 and fuel cell 1903. A subunit 1941, provided as unit 201 operating in power source mode, is connected to production unit 1901. Excess power generated by fuel cell 1903 during low demand periods may be directed to production unit 1901. Hydrogen 119 and oxygen 121, produced by production unit 1901 during low demand periods, may be provided to subunit 1941. Hydrogen transport line 1935 and oxygen transport line 1937 may be used to convey hydrogen 119 and oxygen 121, respectively, to subunit 1941. Alternatively, subunit 1941 may be charged by storing hydrogen 119 and oxygen 121, when operated in a manner consistent with exemplary embodiments discussed above. Subunit 1941 therefore is effectively converted to a battery that may be drawn upon to continue fuel cell operation or hydrogen and oxygen production at a later time when electrical demand by load 1909 increases.

It will now be apparent to one skilled in the art that exemplary systems 1913, 1917, and 1939 are not mutually exclusive and may be used in combination. For example, rather than direct excess power to a grid, controllers 1927 and 1929 may determine that the most efficient use of excess power is the additional production of hydrogen 119 and oxygen 121 in subunit 1941 Alternatively, excess power may be produced during low demand periods and converted to hydrogen 119 and oxygen 121, stored in hydrogen storage 1931 and oxygen storage 1933, respectively. It will now also be apparent that water return line 1915 may be provided for a closed loop system. Other embodiments may also be realized without substantially deviating from the scope of exemplary embodiments discussed above.

FIG. 19E illustrates another exemplary embodiment consistent with the disclosure. FIG. 19E illustrates a combination of apparatuses for creating a nitrogen rich compound 1943. Unit 201 is provided and supplies hydrogen to an engine 1945, for example, internal combustion engine 1201 discussed above. Hydrogen 119 is supplied to engine 1945 via line 1947 and air 1949 is provided to engine 1945 via intake 1951. An exhaust 1953 is provided out of engine 1945. Oxygen 121 may be channeled from unit 201 via line 1955.

With further reference to FIG. 19E, a method of producing nitrogen rich compound 1943 is provided. Hydrogen 119 is produced by unit 201 and provided to engine 1945. Engine 1945 draws air 1949 from the atmosphere. Hydrogen 119 is provided to engine 1945. Hydrogen 119 and air 1949 are combusted by engine 1945. The nitrogen rich compound 1943 and water are then captured as engine exhaust and the nitrogen rich compound 1943 may then be extracted from the engine exhaust.

Nitrogen is used in many applications and nitrogen rich compound 1943 may be further processed for such applications. For example, nitrogen rich compound 1943 may be further processed to produce a nitrogen rich fertilizer. Other applications requiring a nitrogen supply may also employ nitrogen rich compound 1943.

FIG. 19F illustrates another exemplary embodiment consistent with the disclosure. FIG. 19F illustrates a combination of apparatuses for creating a portable, on demand oxygen generator 1957 using a fuel cell 1959. Fuel cell 1959 is provided with air 1961 via an atmosphere intake 1963 and hydrogen 119 via a supply line 1965 from unit 201. Oxygen 121 is provide out line 1967. Fuel cell 1959 provides power to unit 201 via a power line 1969.

With further reference to FIG. 19F, a method of operating oxygen generator 1957 is illustrated. Fuel cell 1959 collects air 1961 and hydrogen 119 to produce electricity. Electricity from fuel cell 1959 is provided to unit 201, configure to provide hydrogen 119 and oxygen 121. Unit 201 may be configured, for example, consistent with an exemplary embodiment discussed above to produce hydrogen 119 and oxygen 121. Oxygen 119 is produced and provided to, for example, a user via line 1967. Hydrogen 119 produced by unit 201 is provided to fuel cell 1959 via line 1965, to facilitate power production by fuel cell 1959. Portable oxygen generator 1957 can produce oxygen 121 sufficient for demands by a user, so long as unit 201 is provided with sufficient cells 203 to produce oxygen 121 at the desired rate.

Portable oxygen generator 1957 provides on demand oxygen, thus eliminating the need to transport stored oxygen, which is highly flammable. Other exemplary embodiments requiring a portable oxygen source will now be apparent to one of ordinary skill in the art based on the above disclosure.

FIG. 19G illustrates another exemplary embodiment consistent with the disclosure. FIG. 19G illustrates a system 1971 including a combination of apparatuses for facilitating load leveling of a power grid 1973. Grid 1973 is connected via controller 1975 to a unit 201. A load 1977, for example a residential power demand, is connected to grid 1973 and unit 201 through controller 1975.

With further reference to FIG. 19G, a method of operating system 1971 is illustrated. Controller 1975 may both monitor grid 1973, load 1977, and unit 201, as well as direct power flow between them. Unit 201 is configured to store hydrogen 119 and oxygen 121, such that power can be produced on demand by unit 201 via a reverse electrolysis reaction of stored hydrogen 119 and oxygen 121 in cells 203 of unit 201. During periods of low demand by load 1977, controller 1975 switches to receive power from grid 1973 to unit 201 to produce and store hydrogen 119 and oxygen 121. When a sufficiently higher demand is sensed by controller, controller 1975 stops power flow from grid 1973 to unit 201 and directs power from grid 1973 to load 1977. Controller 1975 may also direct power from unit 201 to load 1977 to meet power needs.

FIG. 19H illustrates another exemplary embodiment consistent with the disclosure. In particular, FIG. 19H illustrates a flowchart of a method consistent with the exemplary load leveling embodiment shown in FIG. 19G. A step 1979 illustrates monitoring power demand of, for example, load 1977 discussed above. In steps 1981 and 1983, it is determined if the power demand of load 1977 is low or high. As illustrated in step 1985, when demand is high, power is drawn from another source, such as unit 201 configured in a manner consistent with the discussion of FIG. 19G above. Specifically, unit 201 has been charged with hydrogen 119 and oxygen 121 and may provide power, for example, through a reverse electrolysis reaction, to grid 1973. Alternatively, a step 1987 illustrates power being diverted to unit 201 from grid 1973 to create hydrogen 119 and oxygen 121 that is stored in unit 201 during periods of low power demand.

FIG. 19I illustrates another exemplary embodiment consistent with the disclosure. In particular, a system 1989 including a combination of exemplary embodiments discussed in this disclosure is provided for situations in which limited or no power is available from conventional grid ties, e.g., emergency, disaster, or survival settings, in remote locations such as an island, or during power failure in residential and commercial buildings.

FIG. 19I illustrates a power source 1991 connected to a first controller 1993 to provide power to a first unit 1995, for example, an exemplary unit 201. Power source 1991 may be any exemplary power providing system, for example, a generator, a solar power collection system, a wind turbine, or a geothermal power source. Alternatively, power source 1991 may also be a generator capable of providing primary or, if provided in combination with one of the exemplary alternative energy sources above, supplemental power. First controller 1993 is also connected to a second controller 1997. First unit 1995 and a second unit 1999 are connected to first and second controllers 1993 and 1997, respectively. For example, second unit 1999 may be a unit 201 configured to produce hydrogen and oxygen, provided with lines 1955 and 1957 for conveying hydrogen 119 and oxygen 121 to a load 19101. Load 19101 may be any of a number of loads, including the exemplary embodiments of apparatuses configured to receive hydrogen and oxygen discussed above. Alternatively or in combination, load 19101 may also include oxygen and/or hydrogen delivery systems for providing oxygen and/or hydrogen or a fuel cell system for delivering power.

With further reference to FIG. 191, a method for operating system 1989 is discussed. Power from power source 1991 is directed to unit 1995 or unit 1999 depending on whether power is demanded or hydrogen and oxygen are demanded. Depending on a voltage provided by source 1991, the demand of load 19101, and the desired amount of hydrogen and oxygen to be output by unit 1999, controllers 1993 and 1997 may send power to either or both of units 1995 and 1999. Consistent with the embodiments above, power from power source 1991 may be stored in unit 1995 as hydrogen and oxygen, and then provided to load 19101 or unit 1999, depending on whether satisfying load 19101 demand or producing hydrogen and oxygen using unit 1999 is desired. Moreover, various combinations of the exemplary elements of system 1989 may be omitted. For example, first unit 1995 may be provided with appropriate control apparatuses to capture power from source 1991 to provide on demand power, i.e., unit 1995 may convert unstable wind or solar power captured by source 1991 to be used as a constant power supply.

The nature of load 19101 itself may dictate a method of control executed by controllers 1993 and 1997. For example, in an emergency situation, such as following a natural disaster, power may be required as well as oxygen, by a field hospital. In such a case, system 1989 may provide both by configuring load 19101 to be a power load and also an oxygen output source, proving medical oxygen via line 19103. It will now be apparent that any combination of the exemplary devices and loads discussed above may be provided as load 19101, either alone or in combination. Appropriately configured, system 1989 may capture energy using, for example, solar panels provided as power supply 1991. System 1989 may then output power, either in the form of electricity or motive drive, as well as gases, including hydrogen and oxygen. Alternatively, system 1989 may be configured to provide the equivalent of a backup generator for residential settings. Alternatively, it may be configured to provide a combined mini electrical grid and desalination system, for example, for use on remote islands.

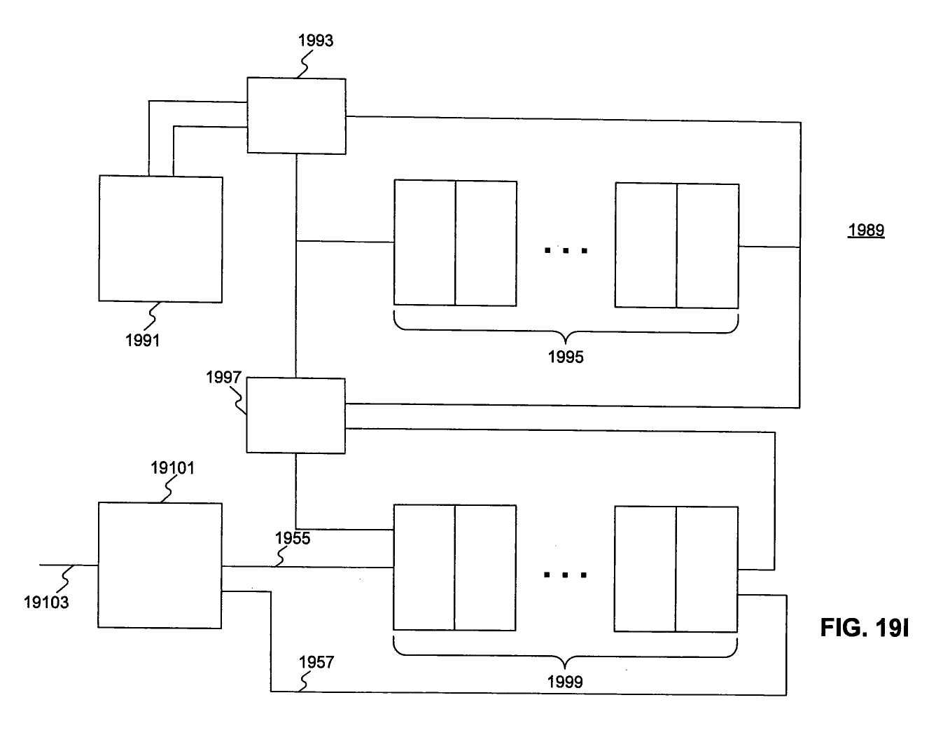

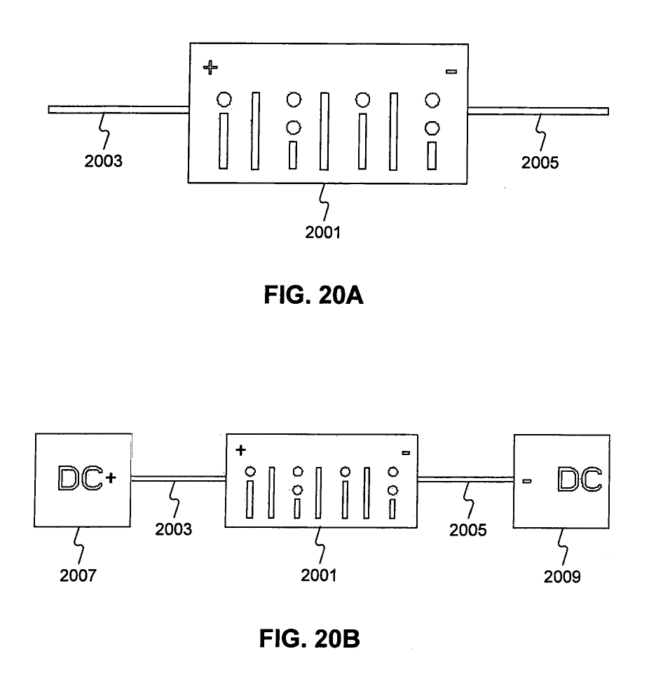

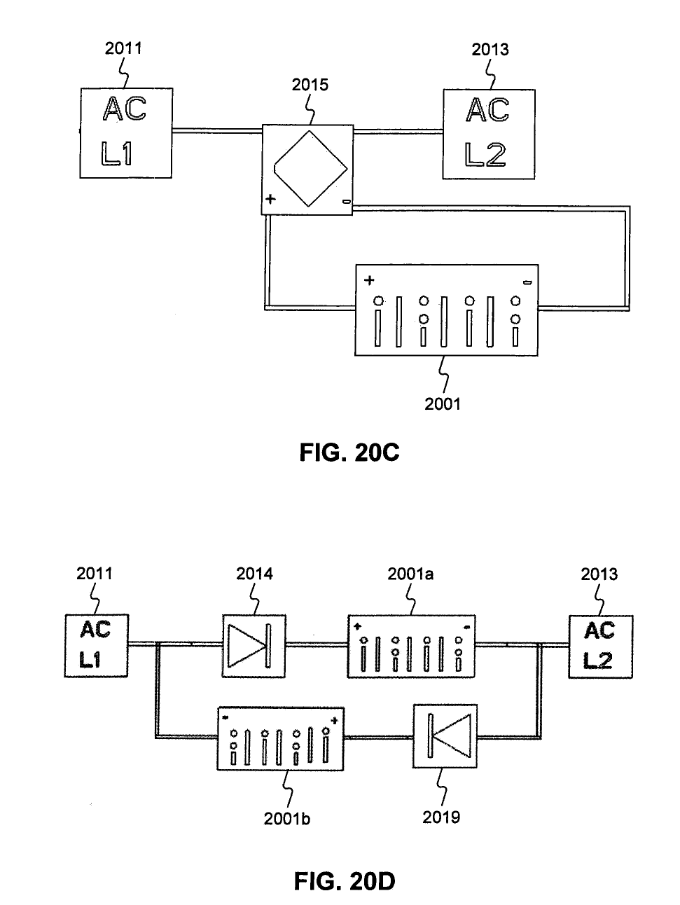

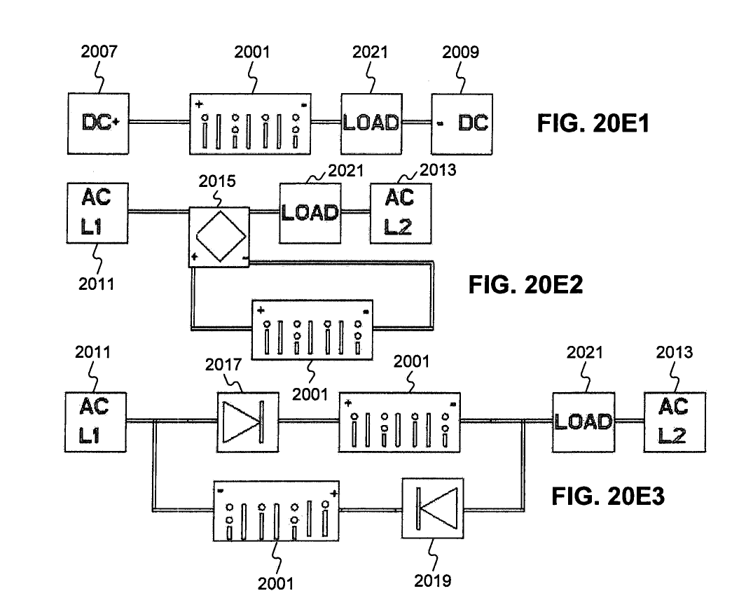

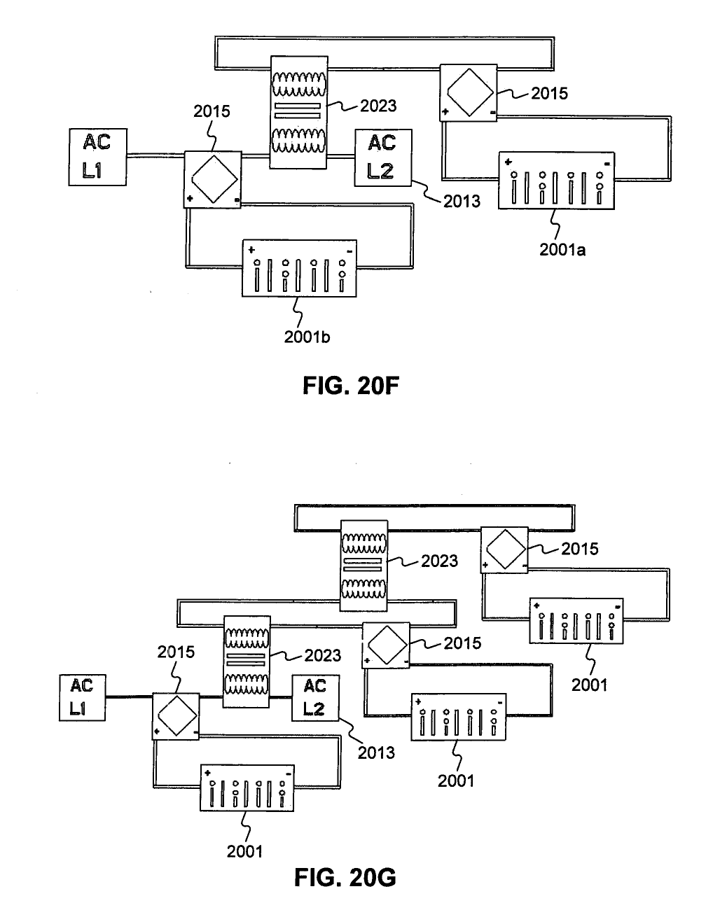

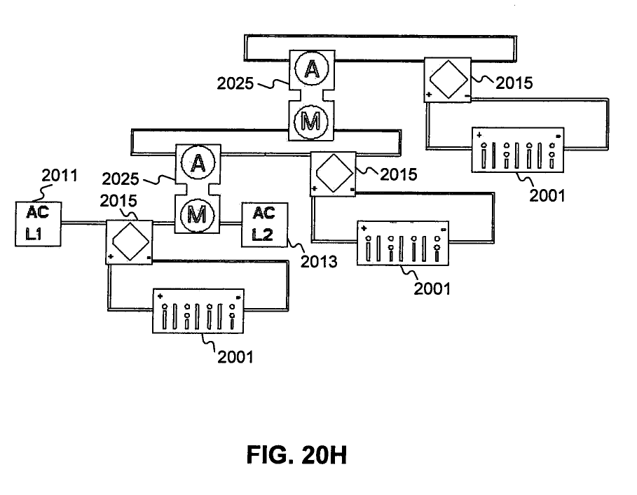

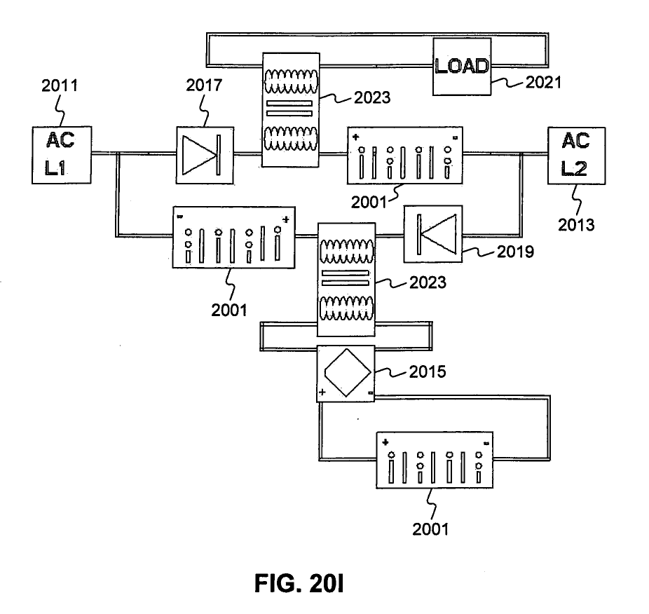

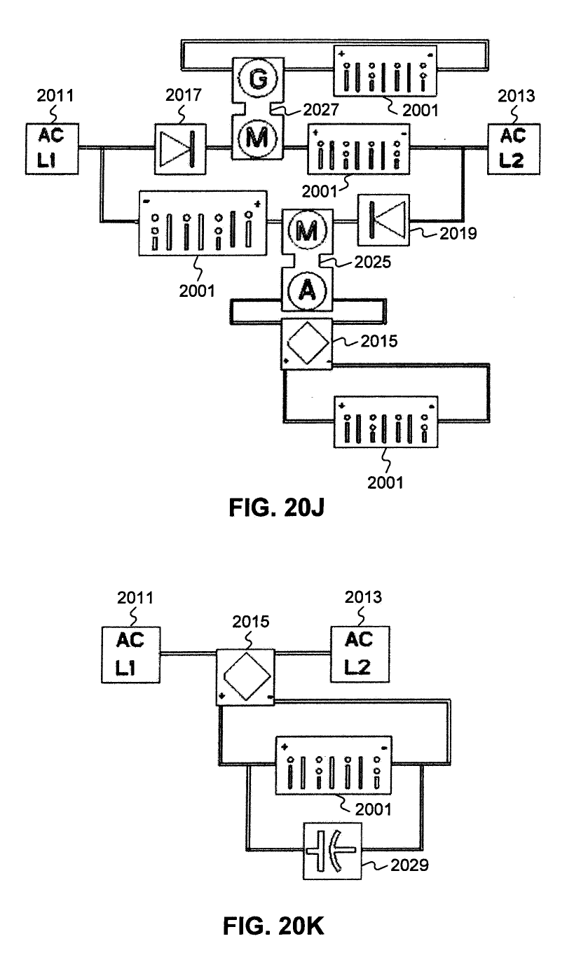

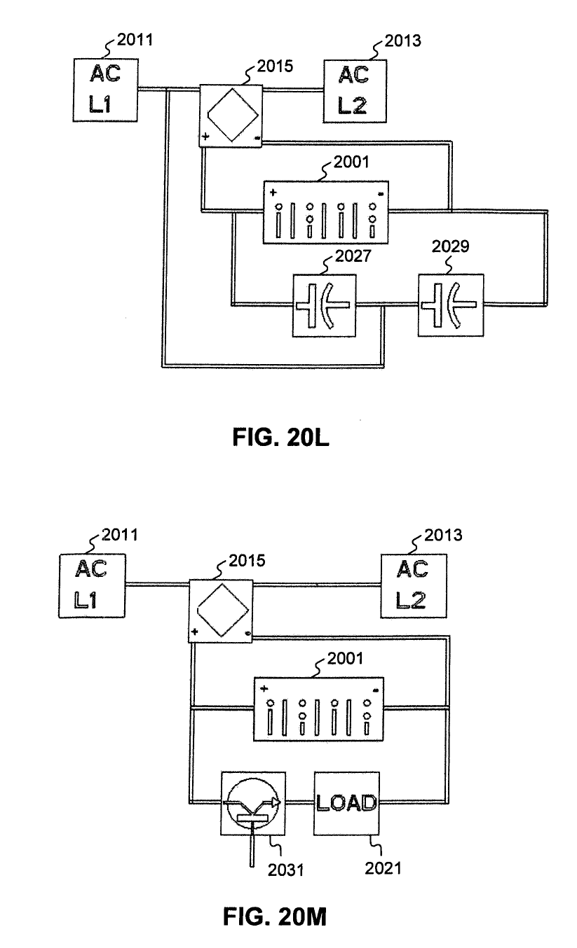

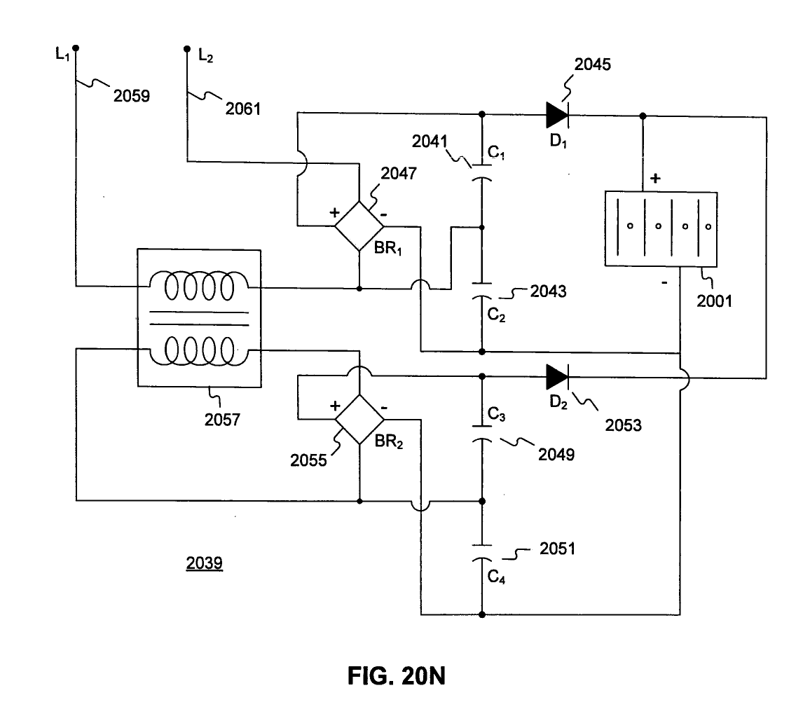

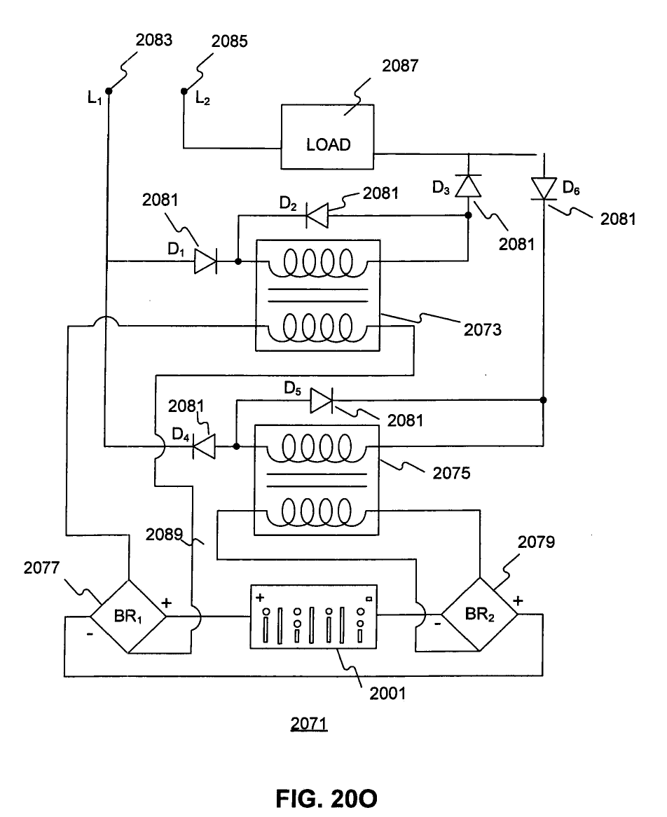

Various exemplary electrical device configurations for operation of the exemplary units are illustrated in FIGS. 20A-20O. Before discussing the various exemplary electrical device configurations including unit 201 or cell 241, a brief discussion of the electrical characteristics of cell 241 is provided.

Cell 241 exhibits electrical behavior analogous to diodes and capacitors in certain manners. As discussed above, a voltage is applied across cell 241 during operation in production mode. Current flows through cell 241 in a manner analogous to a semiconductor diode. At an applied voltage below a threshold voltage V_{TH}, cell 241 may be seen as an infinite resistance. When the applied voltage reaches V_{TH}, current begins to flow. At this time, gases such as hydrogen and oxygen are electrolyzed. Gas will be produced when a voltage is applied over cell 241, but current will not flow until an applied voltage equal to or greater than V_{TH} is applied. The current flow in cell 241 at a voltage greater than or equal to V_{TH} may be approximated as:

I=(V_{TH}−(BE×2))/Rₛᵤₘ

where BE is proportional to the number of cells present in cell 241 and Rₛᵤₘ is the combined resistance of the path of the current through cell 241. BE also varies based on other factors. It is believed that these other factors include the operating pressure of cell 241, electrode size, surface contact area of the electrodes, and size of the slots provided within the cells. The inventor has observed that the performance improves when the cross sectional area of the exposed side of the electrode is approximately equal to the total cross sectional area of the adjacent slots 407.

As discussed above, cell 241 may exhibit battery-like behavior in one mode of operation. Cell 241 may also exhibit capacitor-like behavior depending on how it is provided within a system. Accordingly, cell 241 may be substituted for a capacitor in electrical configurations requiring a capacitor.

Cell 241 also exhibits a pulsating or oscillating behavior. For example, when operated in a storage mode and connected to a voltage source, cell 241 will generate hydrogen and oxygen and store these gases within cell 241. When cell 241 cannot hold additional hydrogen and oxygen, the gases will begin a reverse electrolysis reaction, combining to form water and producing current in power source mode. This recombination will produce an excess voltage spike within the system including cell 241 greater than the voltage applied to cell 241. The gases within cell 241 will continue to recombine and produce excess voltage until the levels of gas subside and electrolysis resumes. The system voltage will then temporarily drop below the applied voltage level. The gas level within cell 241 then returns to equilibrium and cell 241 does not produce a voltage. As hydrogen and oxygen are again produced in cell 241 in production mode, cell 241 again deviates from the equilibrium state and excess hydrogen and oxygen levels build, beginning the cycle again. This pulsating or oscillating behavior of cell 241 continues while the voltage is applied.

FIG. 20A illustrates an exemplary unit 2001 that may include one or more cells 241. Unit 2001 includes a lead 2003 for connecting an anode (positive) terminal, associated with hydrogen production, to a positive potential. A cathode (negative) terminal of unit 2001 may be connected to a negative potential via a lead 2005. Hydrogen and oxygen gas may be produced or stored in unit 2001. If operated in a storage or power source mode, power will be produced by unit 2001 and provided to leads 2003 and 2005.

FIG. 20B illustrates an exemplary embodiment of unit 2001 coupled to a positive terminal 2007 of a DC voltage supply and a negative terminal 2009 of a DC voltage supply via leads 2003 and 2005, respectively. The oscillating behavior observed in unit 2001 is described further with respect to this embodiment. If unit 2001 includes six cells and is provided with a voltage supply of 12 volts, unit 2001 will create hydrogen and oxygen until unit 2001 has a higher voltage than that supplied by voltage supplied over positive terminal 2007 and negative terminal 2009. For example, the voltage of unit 2001 may reach 13 volts. Unit 2001 attempts to drive voltage back onto the DC voltage supply over positive terminal 2007 and negative terminal 2009. Hydrogen and oxygen within unit 2001 are depleted and the voltage of unit 2001 drops to a voltage lower than the supplied DC voltage, e.g., 11 volts. The DC voltage supply, e.g., a battery, then again begins providing current to the lower potential unit 2001, which again begins producing hydrogen and oxygen.

FIG. 20C illustrates another exemplary embodiment of unit 2001 illustrating a configuration of a DC voltage supply applied to unit 2001. Lines 2011 and 2013 of a single phase AC power source are provided to a bridge rectifier 2015, which produces positive and negative DC potentials applied to unit 2001. Lines 2011 and 2013 may be a line and neutral terminal of an AC power supply, respectively, or may carry phase to phase voltage. It will now be apparent to one skilled in the art that although a single unit 2001 is illustrated in FIG. 20C, multiple units 2001 may be provided in series, parallel, or both. Moreover, it will now be apparent that other electrical sources having various frequencies, voltages, and multiple phases may be provided to unit 2001 via suitable electrical conversion devices such as rectifiers, inverters, and others.

FIG. 20D illustrates another exemplary embodiment including two units 2001a and 2001b with diodes 2017 and 2019. Diode 2017 is provided between AC line 2011 and a positive terminal of unit 2001a. AC line 2011 is also provided to a negative terminal of unit 2001b. AC line 2013 is connected to the negative terminal of unit 2001a and to a positive terminal of unit 2001b via diode 2019. Diodes 2017 and 2019 rectify the AC currents provided by AC lines 2011 and 2013 to apply a DC voltage across both units 2001a and 2001b.

The systems illustrated in FIGS. 20C and 20D will produce units having a pulsating voltage. The rate of voltage pulsation is in reference to and based on a 60 hertz cycle provided by the AC power sources. Using the exemplary embodiments in FIGS. 20C and 20D as an example, in one embodiment unit 2001 would be charged at a rate of 120 times per second and units 2001a and 2001b would each be charged at 60 times per second. Such configurations would make it easier to retrieve current from unit 2001a when unit 2001b is being charged and flip flop on a 60 hertz cycle between units 2001a and 2001b.

FIGS. 20E1-20E3 provide examples of various embodiments using recycling of electricity. Each of the exemplary embodiments shown in FIGS. 20E1-20E3 are similar to embodiments discussed above with respect to FIGS. 20B-20D, respectively, but with the addition of an electrical load 2021. Because units 2001 operating in hydrogen and oxygen production mode present very low electrical resistance, current flows through unit 2001 and load 2021, resulting in the voltage applied to load 2021 being slightly reduced due to the small voltage drop across unit 2001. The reduced voltage drop seen by load 2021 should be no more than approximately 10%-20% of the maximum voltage available from a DC or a rectified AC supply to load 2021 to ensure that load 2021 can continue to function in its usual manner. In other words, the number of electrode pairs present in unit 2001 may be selected so that a voltage of 2V per pair of electrodes required for operation is present, but the number of pairs of electrodes should not consume so great a voltage as to impact the operation of load 2021. In the case of load 2021 being a resistive load, such as lighting, its light output will be imperceptibly reduced while its power consumption is also reduced. At the same time, unit 2001, as illustrated in FIGS. 20E1 through 20E3 will produce hydrogen 119 and oxygen 121 as by-products.

FIG. 20F illustrates another exemplary configuration providing for effective current doubling through the use of transformers. In particular, one side of a transformer 2023 is connected between AC line 2013 and bridge rectifier 2015. The other side of transformer 2023, having a transformed voltage, is connected to another bridge rectifier 2015, which provides current to another unit 2001a. This configuration allows hydrogen and oxygen production to be effectively doubled using the same amount of current. Effectively, two streams of current flow are provided from one source current. It will now be apparent to one skilled in the art that additional loads may be placed within the configuration and that the load may be powered with an attached unit recycling the residual current not consumed by the load.

FIG. 20G illustrates another exemplary configuration providing for increasing effective current through the use of transformers. Transformers 2023 are provided between AC line 2013 and bridge rectifiers 2015 in a cascade formation. Each transformer 2023 and unit 2001 requires only a portion of the current provided by AC line 2013 to operate. Accordingly, the current is distributed to the plurality of units 2001 connected to bridge rectifiers 2015 via the cascade configuration illustrated in FIG. 20G. The distributed portions of current are sufficient to operate the plurality of units 2001. Thus, gas production may be increased by adding the transformers 2023, bridge rectifiers 2015, and units 2001 in the exemplary cascade configuration illustrated in FIG. 20G.

FIG. 20H illustrates an exemplary configuration of an alternative cascade configuration. A motor including a mechanically linked alternator, collectively motor 2025, is provided in place of transformers 2023 illustrated in FIG. 20G. The configuration of cascaded motors 2025 allows for distributed current to be supplied to motors 2025 and current to be recycled by attached units 2001, thus allowing for simultaneous motor operation and gas production by maximizing the current provided to the system in the configuration illustrated in FIG. 20H. More particularly, motors 2025 could be employed to perform a primary function, e.g., driving a load such as a fan, while secondarily also driving their respective alternator.

FIGS. 20I and 20J illustrate additional exemplary configurations contemplated for units 2001 using exemplary current recycling schemes. Rectifying diodes 2017 and 2019 are provided between transformers 2023 and AC lines 2011 and 2013. In FIG. 201, load 2021 is coupled across one side of one of transformers 2023. In the alternative embodiment illustrated in FIG. 20J, a motor attached to a DC generator, collectively motor 2027, provides power to one of the plurality of units 2001. Motor 2027 is a DC motor driven by the rectified output from diode 2017. Motor 2027 drives a DC generator whose output is applied to another unit 2001. In each of the exemplary embodiments illustrated in FIGS. 20I and 20J, current from AC lines 2011 and 2013 is provided to the various components provided therein such that sufficient current is present to provide for the operation of the plurality of units 2001 electrically connected to the other components in each exemplary embodiment.

FIG. 20K illustrates yet another exemplary embodiment of current distribution applied to the use of units 2001. In particular, AC lines 2011 and 2013 provide current to bridge rectifier 2015, which is then provided to unit 2001 connected in parallel with a capacitor 2029. The configuration illustrated in FIG. 20K will result in additional current flow. In particular, capacitor 2029 may be charged by the current received via AC lines 2011 and 2013 and by the oscillation effect of unit 2001. Capacitor 2029 provides for a constant voltage therefore increasing current flow. Empirically, the presence of capacitor 2029 was been shown to increase low current amperage significantly and increase effective voltage across unit 2001 accordingly.

FIG. 20L illustrates yet another configuration of unit 2001 with other components that will provide a supply voltage that is doubled. For example, if a voltage of approximately 110 volts is supplied to this configuration, a voltage of approximately 220 volts will be applied across unit 2001 in this configuration. This circuit utilizes two capacitors 2027 and 2029 with a common junction and the stored voltage of the capacitors supplied to 2001 unit is doubled. This doubled voltage allows unit 2001 to be configured with a higher number of cells in series with corresponding increased hydrogen production. In an alternative embodiment, capacitors 2027 and 2029 may be replaced by units 2001. In such an embodiment, the additional units 2001 in place of capacitors 2027 and 2029 will together generate voltage across the remaining unit 2001. However, additional units 2001 can also produce hydrogen and oxygen in production mode, which capacitors 2027 and 2029 are not capable of doing.

FIG. 20M illustrates an additional exemplary configuration of unit 2001 with other components including a bipolar junction transistor 2031. In such a configuration, unit 2001 may operate in either production mode or storage mode. Use of transistor 2031 allows for switching of the current between unit 2001 and load 2021. In particular, providing transistor 2031 allows for current to be provided to load 2021 when demanded. Thus, voltage may be provided to load 2021 even while unit 2001 continues to operate.

FIG. 20N illustrates a voltage doubler circuit 2039 for coupling to an AC line source comprised of lines 2059 and 2061. Capacitors 2041 and 2043 are provided in series between positive and negative terminals of unit 2001. A positive DC output of a bridge rectifier 2047 is applied to one side of capacitor 2041 and through a diode 2045 to unit 2001. Diode 2045 is forward conductive from an anode terminal coupled to the one side of capacitor 2041 to a cathode terminal coupled to the positive terminal of unit 2001. A negative output from bridge rectifier 2047 is provided on one side of capacitor 2043 and to the negative terminal of unit 2001. Capacitors 2049 and 2051 are coupled to each other in a similar manner and to unit 2001. In particular, a positive DC output from a bridge rectifier 2055 is applied to one side of capacitor 2049 and through a diode 2053 to the positive terminal of unit 2001. Diode 2053 is forward conductive from an anode terminal coupled to the one side of capacitor 2049 to a cathode terminal coupled to the positive terminal of unit 2001. A negative output from bridge rectifier 2055 is provided to one side of capacitor 2051 and to the negative terminal of unit 2001. A primary winding of a transformer 2057 is for coupling at one end to AC line 2059 and coupled at the other end to one input of bridge rectifier 2047. The other end of the primary winding is also coupled between capacitors 2041 and 2043. The other input of bridge rectifier 2047 is for coupling to AC line 2061. A secondary winding of transformer 2057 is coupled across input terminals of bridge rectifier 2055. One end of the secondary winding is also coupled between capacitors 2049 and 2051.

During operating of circuit 2039, transformer 2057 will provide an AC input to both bridge rectifiers 2047 and 2055, such input being converted to a DC power output by bridge rectifiers 2047 and 2055. The DC output of bridge rectifier 2047 is coupled across the series coupled pair of capacitors 2041 and 2043, and the DC output of bridge rectifier 2055 is coupled across the series coupled pair of capacitors 2049 and 2051. Each series coupled pair of capacitors is coupled in circuit 2039 to substantially double the rectified voltage of the AC source, and the respective doubled voltage outputs of the series coupled pairs are applied in parallel across unit 2001. Applying the doubled voltage across unit 2001 results in approximately doubling the current flow therethrough and a generally corresponding increase in gas, i.e., hydrogen and oxygen, production. In this manner, circuit 2039 enables use of a conventional AC line source at, e.g., 110 volts, to generate increased gas production from unit 2001. Further increases in the voltage applied to unit 2001 may result in further increases in current flow and gas production, but such further increases may at some point result in less optimal operation of unit 2001

FIG. 20O illustrates a driver circuit 2071 for coupling to an AC line source comprised of lines 2083 and 2085. A primary winding of each of transformers 2073 and 2075 is coupled across AC lines 2083 and 2085. However, current flow is restricted by diodes 2081 depending on the phase of AC source lines 2083 and 2085. Diodes 2081 are further designated as D1, D2, . . . , D6. Each diode 2081 is forward conductive from an anode terminal to a cathode terminal. For example, the respective cathode terminals of diodes D1 and D2 are coupled together, while the respective anode terminals of diodes D2 and D3 are coupled together. The secondary side of each of transformers 2073 and 2075 is applied across a bridge rectifier 2077 and a bridge rectifier 2079, respectively An electrical load 2087, e.g., lighting, is coupled between source line 2085 and one winding of transformer 2073. Unit 2001 is coupled between the negative terminal of bridge rectifier 2079 and the positive terminal of bridge rectifier 2077. The negative terminal of bridge rectifier 2077 is coupled to the positive terminal of bridge rectifier 2079.

During operation of circuit 2071, current flows through load 2087 and through transformer 2073 or transformer 2075, depending on the phase of the voltage on line 2085. As current passes through transformers 2073 and 2075, transformers 2073 and 2075 produce pulses as the transformers are charged and discharged.

Circuit 2071 divides the single alternating current source provided on AC source lines 2083 and 2085 and drives the two different transformers producing two separate alternating currents. Transformers 2073 and 2075 output two current flows on their respective secondary windings, which are rectified and pass through unit 2001. In circuit 2071, load 2087 is driven by current through transformer 2073 independently of the portion of circuit 2071 driving unit 2001. Accordingly, operation of unit 2001 can be interrupted without impeding current flow to load 2087. In this manner, circuit 2071 permits greater operating efficiency by operating both load 2087 and unit 2001 from the same AC source. Further, circuit 2071 is configured to permit either load 2087 or unit 2001 to be turned off, e.g., by a switch not shown, without interrupting operation of unit 2001 or load 2087, respectively.

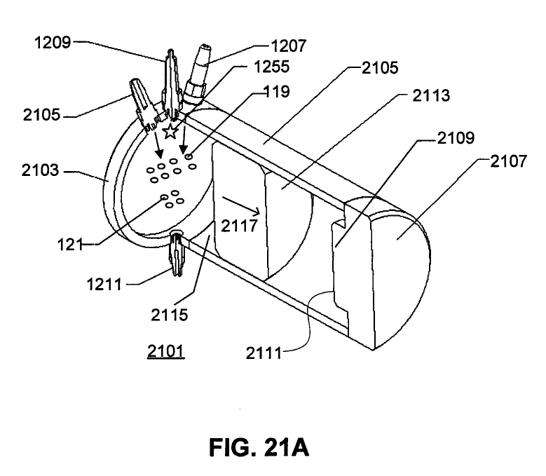

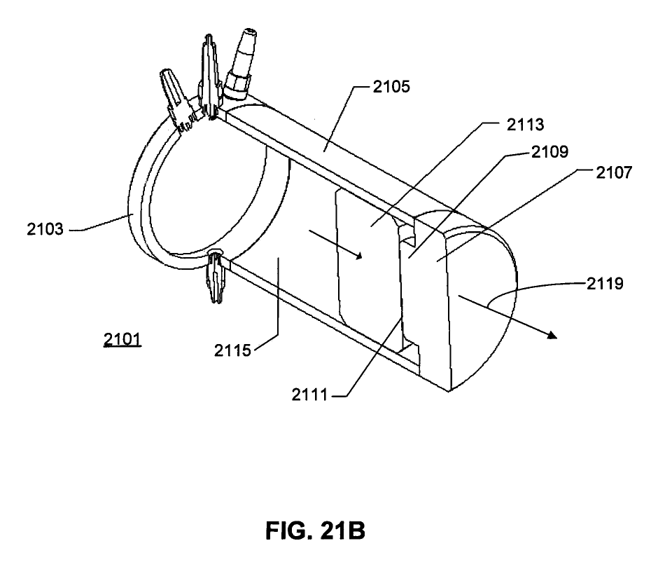

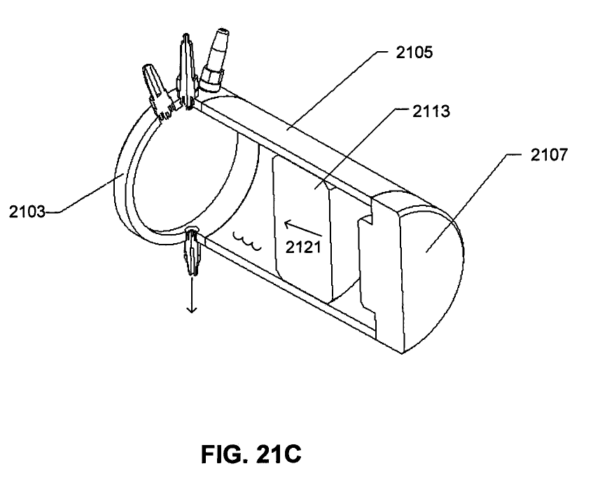

FIGS. 21A-C illustrate an impact accelerator 2101, its various components, and operation.

FIG. 21A illustrates impact accelerator 2101 including a first end cap 2103, a cylinder housing 2105, and a second end cap 2107. First end cap 2103 is provided with openings in its sidewall for receiving hydrogen injector 1205, oxygen injector 1207, spark plug 1209, and water ejector 1211. The structure, control, alternatives, and operation of hydrogen injector 1205, oxygen injector 1207, spark plug 1209, and water ejector 1211 are the same in this impact accelerator as the corresponding components described above in connection with the internal combustion engine of FIG. 12A. Thus, reference is made to the discussion of these components in FIG. 12A for this impact accelerator embodiment. Second end cap 2107 is further provided with an anvil 2109 having an impact surface 2111. While not shown, it is understood that hydrogen injector 1205, oxygen injector 1207, spark plug 1209, and/or water ejector 1211 may controlled by any suitable controller to achieve the timings necessary to sustain operation of the impact accelerator 2101. Cylinder 2105 is capped at one end by first end cap 2103 and the opposing end by second end cap 2107, with anvil 2109 being disposed within cylinder 2105. Impact surface 2111 faces first end cap 2103. A hammer 2113 is provided within cylinder 2105 between end caps 2103 and 2107. Hammer 2113 may be formed of, for example, aluminum or work hardened steel. Hammer 2113 may freely traverse the area within cylinder 2105 between first and second end caps 2103 and 2107.

FIGS. 21A-C illustrate the cycle of operation of impact accelerator 2101. As illustrated in FIG. 21A, hydrogen 119 and oxygen 121 are injected into a combustion chamber 2115, defined between the face of hammer 2113 opposite to first end cap 2103. Hydrogen injector 1205 and oxygen injector 1207 provide hydrogen 119 and oxygen 121, respectively, to chamber 2115. Spark 1255 is then provided by spark plug 1209 to create the combustion of hydrogen 119 and oxygen 121 in chamber 2115. The resulting combustion produces a force symbolically shown as force 2117, driving hammer 2113 towards impact surface 2111 of anvil 2109. It is understood that the initial driving of hammer 2113 towards impact surface 2111 of anvil 2109 may be less than the full distance of the cylinder depending on the stationary position of the piston 2113 prior to the initial combustion. The pressure drop seen after a combustion will create a vacuum and pulling hammer 2113 toward endcap 2103.

FIG. 21B illustrates the impact of hammer 2113 after the combustion of hydrogen 119 and oxygen 121 in chamber 2115. Hammer 2113 travels in the direction of force 2117 until it strikes impact surface 2111 of anvil 2109, transferring the energy of force 2117 through second end cap 2107, the transferred force being symbolically illustrated as force 2119.

FIG. 21C illustrates the return cycle of hammer 2113. Hammer 2113 bounces off impact surface 2111 and reverses direction (symbolically illustrated as direction 2121). As hammer 2113 nears first end cap 2103, hydrogen injector 1205 and oxygen injector 1207 again begin providing hydrogen 119 and oxygen 121, slowing the travel of hammer 2113 in direction 2121. When the required amount of hydrogen 119 and oxygen 121 are present in chamber 2115, spark 1255 is again introduced by spark plug 1209, beginning the cycle illustrated in FIG. 21A, and the cycle is maintained and repeated as required. As noted above in connection with the internal combustion engine of FIG. 12A, the combustion of the hydrogen and oxygen will result in a pressure drop within the combustion chamber 2115 which will assist in drawing the hammer 2113 back toward first end cap 2103. In addition, the water ejector 1211 is configured and/or controlled to open during the return of the hammer 2113 toward the first end cap 2103. The opening of the water ejector 1211 takes place before the reintroduction of hydrogen and oxygen to the combustion chamber. In addition, the impact accelerator can receive the hydrogen and oxygen via the unit 201 or from any other supply system discussed above.

Numerous applications of impact accelerator 2101 will now be apparent. For example, impact accelerator may be used to provide force for impact tools, such as in construction applications. Impact accelerator 2101 may also be used for propulsion and/or maneuvering. For example, impact accelerator 2101 may be provided to vehicles, such as space vehicles, watercraft, and rovers.

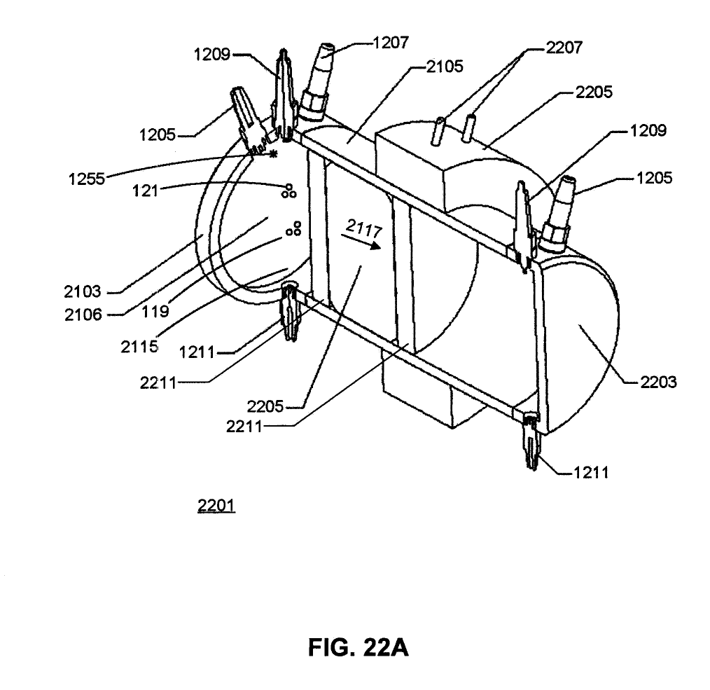

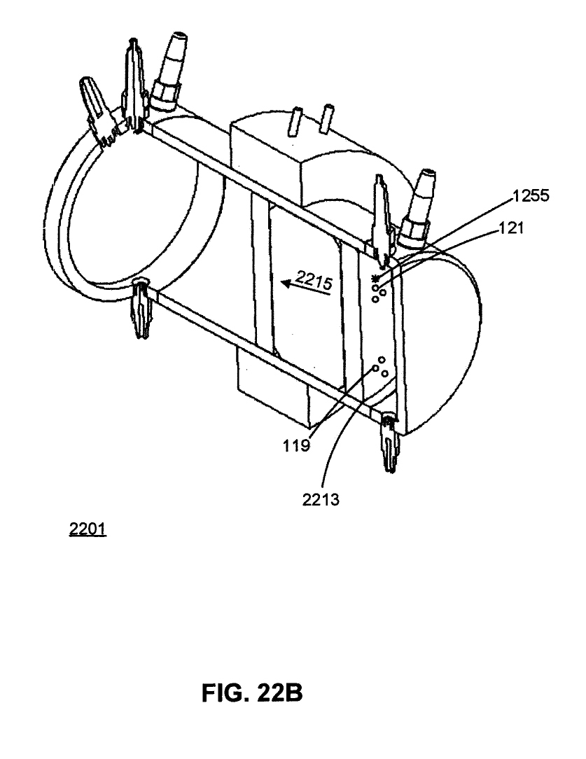

FIGS. 22A and 22B illustrate an impact accelerator generator 2201, its various components, and operation.

FIG. 22A illustrates accelerator generator 2201 including first end cap 2103, cylinder housing 2105, and a second end cap 2203. First end cap 2103 is provided with openings in its sidewall for receiving hydrogen injector 1205, oxygen injector 1207, spark plug 1209, and water ejector 1211. Second end cap 2203 is provided with openings in its sidewall for receiving hydrogen injector 1205, oxygen injector 1207 (not shown), spark plug 1209, and water ejector 1211. Although oxygen injector 1207 is not illustrated in end cap 2203 in FIG. 22A, from the foregoing description it is clear that end cap 2203 is a mirror image of end cap 2103. Alternatively, end cap 2203 may be provided to inject hydrogen 119 and oxygen 121 via a single hydrogen injector 1205 to achieve the operation discussed below. The structure, control, alternatives, and operation of hydrogen injector 1205, oxygen injector 1207, spark plug 1209, and water ejector 1211 are the same in impact accelerator 2201 generator as the corresponding components described above in connection with internal combustion engine 1201 of FIG. 12A. Thus, reference is made to the discussion of like components in FIG. 12A for description of impact accelerator generator 2201. Cylinder 2105 is capped at one end by first end cap 2103 and at the opposing end by second end cap 2203. Cylinder 2105 is further provided with a toroidal coil 2205 centrally located on cylinder 2105. Electrical terminals 2207 are connected to toroidal coil 2205. An accelerator generator hammer 2209 is provided within cylinder 2105 between end caps 2103 and 2207. Hammer 2209 may be formed of a magnetic or magnetizable material, for example, a load stone, other magnetic retaining materials, or armature steel magnetized by coil 2205. Hammer 2209 may freely traverse the area within cylinder 2105 between first and second end caps 2103 and 2207. Hammer 2209 is further provided with ceramic heat shields 2211 provided on opposing sides of hammer 2209. Ceramic heat shields 2211 may be comprised of, for example, aluminum oxide or other thermal protective material. Combustion chamber 2115 is provided between one face of hammer 2209 and first end cap 2103 and a second combustion chamber 2213 is formed between another face of hammer 2209 and second end cap 2203.

FIGS. 22A and 22B illustrate the cycle of operation of accelerator generator 2201. As illustrated in FIG. 22A, hydrogen 119 and oxygen 121 are injected into combustion chamber 2115, defined between the face of hammer 2209 opposite to first end cap 2103 and first end cap 2103. Hydrogen injector 1205 and oxygen injector 1207 provide hydrogen 119 and oxygen 121, respectively, to chamber 2115. Spark 1255 is then provided by spark plug 1209 to initiate combustion of hydrogen 119 and oxygen 121 in chamber 2115. The resulting combustion produces a force symbolically shown as force 2117, driving hammer 2209 towards second end cap 2203. Hammer 2209 passes through toroidal coil 2205, generating electricity from the interaction, i.e., the magnetic coupling, between hammer 2209 and coil 2205. Electricity generated in coil 2205 is conveyed to electrical terminals 2207. It is understood that the initial driving of hammer 2209 towards second end cap 2203 may be less than the full distance of the cylinder depending on the stationary position of the hammer 2209 prior to the initial combustion.

FIG. 22B illustrates another part of the exemplary operation cycle. A face of hammer 2209 opposite to second end cap 2203 passes coil 2205 and hammer 2209 approaches second end cap 2203. Hydrogen injector 1205 and oxygen injector 1207 (not shown) provide hydrogen 119 and oxygen 121, respectively, to second combustion chamber 2213. Spark 1255 is then provided by spark plug 1209 to initiate the combustion of hydrogen 119 and oxygen 121 in chamber 2213. After combustion of hydrogen 119 and oxygen 121 in chamber 2213, hammer 2209 travels in the direction of force 2215. Hammer 2209 again passes through coil 2205 and again generates electricity from the interaction of hammer 2209 with coil 2205. Electricity generated in coil 2205 is again conveyed to electrical terminals 2207. It is understood that if the initial driving of hammer 2209 towards second end cap 2203 is less than the full distance of the cylinder, hammer 2209 may not pass coil 2205 during the first several combustions, but that hammer 2209 will eventually traverse cylinder 2115 at a frequency proportional to a timing of sparks 1255 provided to both chambers 2115 and 2213.

Numerous applications of accelerator generator 2201 will now be apparent. For example, impact accelerator generator 2201 may be used to generate electricity when traditional generators may not be used due to safety concerns.

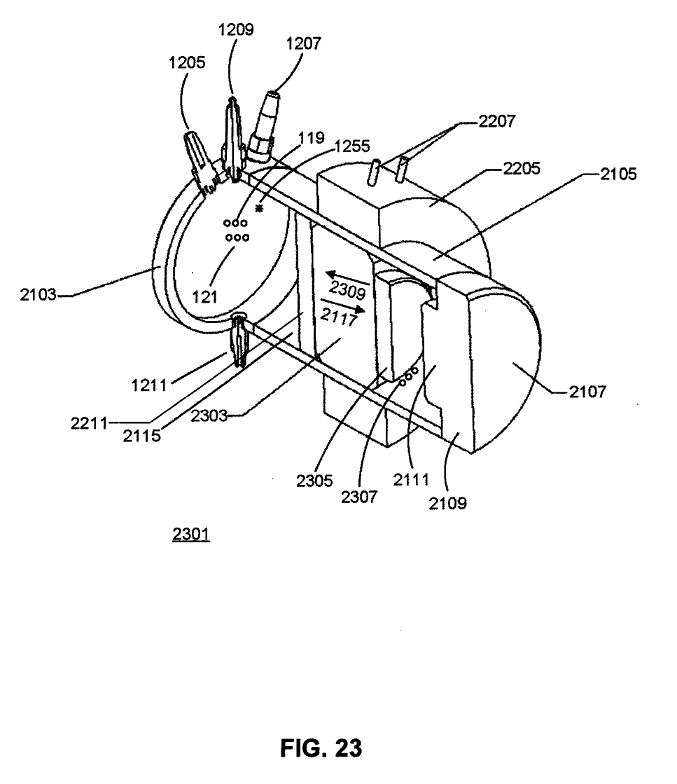

FIG. 23 illustrates an impact accelerator generator 2301. Impact accelerator generator 2301 includes a cylinder 2105 having a first end cap 2103 provided with openings in its sidewall for receiving hydrogen injector 1205, oxygen injector 1207, spark plug 1209, and water ejector 1211. The structure, control, alternatives, and operation of hydrogen injector 1205, oxygen injector 1207, spark plug 1209, and water ejector 1211 are the same in this impact accelerator generator as the corresponding components described above in connection with internal combustion engine 1201 of FIG. 12A. Thus, reference is made to the discussion of these components in FIG. 12A for impact accelerator generator 2301. At an opposite end of cylinder 2105, second end cap 2107 is provided with anvil 2109 being disposed within cylinder 2105. Impact surface 2111 faces first end cap 2103. Second end cap having anvil 2109 and impact surface 2111 are the same in impact accelerator generator 2301 as the corresponding components described above in connection with impact accelerator 2101 of FIG. 21A. Thus, reference is made to the discussion of these components in FIG. 21A for the description of impact accelerator generator 2301. Cylinder 2105 is further provided with a toroidal coil 2205 centrally located on cylinder 2105. Electrical terminals 2207 are connected to toroidal coil 2205. Toroidal coil 2205 and terminals 2207 are the same in impact accelerator generator 2301 as the corresponding components described above in connection with accelerator generator 2201 of FIG. 22A. Thus, reference is made to the discussion of these components in FIG. 22A for the description of impact accelerator generator 2301.

An impact accelerator generator hammer 2303 is provided within cylinder 2105 between end caps 2103 and 2107. Hammer 2303 combines part of exemplary hammers 2113 and 2209 discussed above. For example, hammer 2303 may be formed of a magnetic or magnetizable material, for example, a load stone, other magnetic retaining materials, or armature steel magnetized by coil 2205. Hammer 2303 may freely traverse the area within cylinder 2105 between first and second end caps 2103 and 2107. Hammer 2303 is further provided with one of ceramic heat shields 2211 on a face of hammer 2303 facing first end cap 2103. Various materials and features of hammer 2209 and ceramic heat shields 2211 are as previously described. Thus, reference is made to the discussion of these components above for impact accelerator generator 2301. Hammer 2303 is further provided with a compression surface 2305, which faces impact surface 2111. A snubber gas 2307 is provided between compression surface 2305 and second end cap 2203.

The method of operation of impact accelerator 2101 and accelerator generator 2201 is also relied upon. With further reference to FIG. 23, hydrogen 119 and oxygen 121 are provided to combustion chamber 2115. Spark 1225 is introduced to initiate combustion of hydrogen 119 and oxygen 121, providing force 2117 against hammer 2303. Hammer 2303 passes through coil 2205, producing electricity in coil 2205 due to the magnetic coupling between coil 2205 and magnetic hammer 2303. Hammer 2303 proceeds through cylinder 2105 and begins to compress gas 2307 between compression surface 2305 and second end cap 2203. Gas 2307 is compressed until all energy provided to hammer 2303 from force 2117 is exhausted. Gas 2307 then begins to expand, pushing against compression surface 2305 with a force 2309 resulting from gas 2307 expanding back to its equilibrium pressure state. Hammer 2303 moves through cylinder 2105 in the direction of force 2309, again passing through coil 2205 to create electricity therein. As hammer 2303 nears first end cap 2103, ejector 1211 is opened and water is expelled. Hydrogen injector 1205 and oxygen injector 1207 again begin providing hydrogen 119 and oxygen 121. Similar to the compression of snubber gas 2307, compression of hydrogen 119 and oxygen 121 may act against the motion of hammer 2303, i.e., the compression of hydrogen 119 and oxygen 121 may slow hammer 2303. Spark 1225 is again provided to hydrogen 119 and oxygen 121, and the operation cycle repeats.

It will now be apparent to one of ordinary skill in the art that the embodiments illustrated in FIGS. 21A-C, 22A and 22B, and 23 are not necessarily mutually exclusive embodiments and may be used together in certain combinations. In particular, the combination of elements may be dictated by the desired direction of forces within and out of the particular embodiment. For example, snubber gas or gases may be used to slow the motion of a hammer moving against the gas or gases to create a force in the opposite direction of the hammers motion. In such exemplary configurations, an anvil and impact surface may be omitted. Alternatively, force may be directed out of the exemplary embodiment by providing an anvil and impact surface at one end of a cylinder containing a hammer.

It will now be understood that the above embodiments are illustrative only. Various combinations, modifications, and substitution of the exemplary embodiments discussed herein, either as a whole or in part, will now be apparent to one of ordinary skill in the art.

What is claimed is:

1. A cell for use in an electrolysis unit, comprising:
a back wall,
a side wall extending upwardly from and around a periphery of the back wall to define an inner region of the cell,
an electrode disposed on the back wall within the inner region to divide at least a portion of the inner region into first and second regions.

2. The cell of claim 1 further including a ridge disposed on the back wall and extending from an end portion of the electrode to further divide the inner region into the first and second regions.

3. The cell of claim 2, wherein the back wall is generally rectangular having a length dimension longer than a width dimension,
wherein the electrode is elongate and extends along the length dimension, the electrode and the ridge extending substantially between opposite end portions of the side wall that extend along the width dimension.

4. The cell of claim 3, wherein the electrode and ridge fully extend between the opposite end portions of the side wall.

5. The cell of claim 1, wherein the back wall includes a gas collection orifice near one of the side wall end portions.

6. The cell of claim 3, wherein the back wall includes at least one open slot in one of the first and second regions and adjacent the electrode for enabling communication of a conductive solution therethrough.

7. An electrolysis unit, comprising:
a first electrode having a first side and a second side,
a second electrode having a first side and a second side, and
a cell wall structure that defines
first confined regions respectively adjacent the first sides of the first and second electrodes, the first confined regions having an opening therebetween, and
second confined regions respectively adjacent the second sides of the first and second electrodes, the second confined regions being isolated from each other.

8. The unit of claim 7, wherein the cell wall structure includes:
a first chamber structure and a second chamber structure positioned in contact with the first chamber structure, the first and second electrodes respectively disposed in the first and second chamber structures.

9. The unit of claim 8, wherein each of the first and second chamber structures includes:
a back wall,
a side wall extending upwardly from and around a periphery of the back wall to define an inner region,
the first electrode disposed on the back wall of the first chamber within the inner region to divide at least a portion of the inner region of the first chamber into first and second regions,
the second electrode disposed on the back wall of the second chamber within the inner region to divide at least a portion of the inner region of the second chamber into first and second regions.

10. The unit of claim 9 further including a ridge disposed on the back wall of each of the first and second chambers and extending from an end portion of each of the first and second electrodes to further divide the inner region into the first and second regions.

11. The unit of claim 10, wherein the back wall of each of the first and second chambers is generally rectangular having a length dimension longer than a width dimension,
wherein each of the first and second electrodes is elongate and extends along the length dimension, the first and second electrode and the ridge extending substantially between opposite end portions of the side wall that extend along the width dimension of the first and second chambers, respectively.

12. The unit of claim 11, wherein the back wall of each of the first and second chambers includes a gas collection orifice near one of the side wall end portions.

13. The unit of claim 11, wherein the back wall of each of the first and second chambers includes at least one open slot in the second and first regions, respectively, and adjacent the first and second electrodes, respectively, for enabling communication of electrolyte therethrough.

14. The unit according to claim 11, further comprising:
a coating seal, wherein the coating seal is provided over portions of the first and second chambers.

15. The unit according to claim 14, wherein the coating seal is comprised of a solution of 10% Acrylonitrile Butadiene Styrene by weight concentration dissolved in Methyl Ethyl Ketone solvent.

16. The unit according to claim 9, further comprising:
a cement provided for securing the first and second electrodes to the back walls of the first and second chambers.

17. The unit according to claim 16, wherein the cement is comprised of 2% Acrylonitrile Butadiene Styrene by weight concentration dissolved in Methyl Ethyl Ketone solvent.

18. The unit according to claim 10, wherein each of the first and second chambers includes first and second faces, the second face of the first chamber in contact with the first face of the second chamber, the unit further comprising:
an endplate disposed on the first face of the first chamber and having a gas connection orifice,
a gas collection orifice provided to the first chamber,
tubing connected to the gas connection orifice, and
a collection tube, wherein
the tubing, gas connection orifice, and gas collection orifice are connected to provide a channel for the gas from the unit to the collection tube.

19. A method for producing a first gas and a second gas using a unit, the method comprising:
providing the unit including:
a first electrode in a first chamber, the first chamber having slots,
a second electrode provided to a second chamber, and
a conductive solution capable of being electrolyzed, wherein the first chamber and second chamber are provided adjacent to each other such that the solution can pass through the slots to contact both the first and second electrodes, and
applying a voltage across the first and second electrodes to electrolyze the solution to produce the first and second gases, wherein the solution acts as an electrically conductive path.

20. The method according to claim 19, further comprising:
providing the unit with:
a first gas channel,
a second gas channel, and
channeling the first and second gases through the first and second gas channels, respectively.

21. The method according to claim 19, wherein the providing of the unit further includes:
applying a coating seal over the first and second chambers to seal the first and second chambers.

22. The method according to claim 21, wherein the coating seal is comprised of a solution of 10% Acrylonitrile Butadiene Styrene by weight concentration dissolved in Methyl Ethyl Ketone solvent.

23. The method according to claim 19, wherein the providing of the unit further includes
securing first and second electrodes to the first and second chambers using a cement.

24. The method according to claim 23, wherein the cement is comprised of 2% Acrylonitrile Butadiene Styrene by weight concentration dissolved in Methyl Ethyl Ketone solvent.

25. The method according to claim 19, wherein the providing of the unit further includes:
providing an endplate having a gas connection orifice,
providing a collection orifice to the first chamber,
connecting one end of a tubing to the gas connection orifice, and
connecting an opposite end of the tubing to a collection tube,
wherein the tubing, gas connection orifice, and collection orifice are connected to provide a channel for the first gas from the unit to the collection tube.

26. The method according to claim 19, wherein providing the conductive solution includes providing an electrolyte and water.

27. The method according to claim 26, wherein the conductive solution comprises 30% by weight NaCl.

28. A unit cell, the cell comprising:
a plurality of chambers including:
a first chamber including a cathode electrode coupled to a first terminal for providing a first electrical connection to the cell,
a second chamber including an anode electrode connected to a second terminal for providing a second electrical connection to the cell, and
a third chamber, provided between the first chamber and second chamber, the third chamber configured to confine a conductive solution to provide an electrically conductive path through the conductive solution and connection between the anode electrode and the cathode electrode,
so that when a voltage is applied across the first terminal and second terminal and the conductive solution is provided in the third chamber, the conductive solution is electrolyzed to produce hydrogen and oxygen.

29. A method of operating a unit for producing hydrogen and oxygen, the method comprising:
confining a conductive solution, capable of being electrolyzed, between a first electrode and a second electrode,
applying a voltage across the first electrode and second electrode to electrolyze the solution to produce hydrogen and oxygen, and
channeling the hydrogen and oxygen produced by the electrolyzed solution out of the unit,
wherein the solution provides an electrically conductive path between the first and second electrodes.

30. A method of obtaining power from a unit capable of generating and storing hydrogen and oxygen, the method comprising:
confining a conductive solution, capable of being electrolyzed, between a first electrode and a second electrode, the solution providing a conductive path between the first and second electrodes, each of the first and second electrodes having a cavity,
applying a voltage across the first and second electrodes to electrolyze the solution and produce hydrogen and oxygen,
storing the produced hydrogen and oxygen within the cavity in the first and second electrodes, respectively,
removing the applied voltage, and
applying an electrical load to the unit to power the load by a reverse electrolysis process driven by the stored hydrogen and oxygen.

31. The method of obtaining power according to claim 30, wherein the cavity in each of the first and second electrodes comprises a plurality of notches, the hydrogen and oxygen being stored in the notches of the first and second electrodes, respectively.

32. An electrode for use in a unit for storing a first gas and a second gas, the electrode comprising:
a first plurality of notches provided in a first side of the electrode for receiving the first gas, and
a second plurality of notches provided in second side of the electrode for receiving the second gas.

33. A deposition system for forming a structure on a substrate capable of receiving the structure, comprising:
a window having a two-dimensional shape consistent with a desired shape of the structure, and
a deposition system for providing material used to form the structure, the deposition system being masked by the window on one side.

34. A method for forming a structure using a deposition method, comprising:
forming a window having a shape consistent with a desired shape of the structure,
masking a deposition system providing a material for forming the structure with the window,
providing a substrate capable of receiving the structure, and
depositing the material through the window for a time sufficient to form a desired thickness of the structure.

35. An electrolyte amperage meter comprising:
a test chamber for receiving a conductive solution and having a known volume,
electrically conductive terminals for receiving a voltage source to apply a known voltage across the test chamber, and
an amperage meter having probes provided within the test chamber to contact the conductive solution when disposed therein, and to measure a magnitude of current flow through the conductive solution when disposed in the test chamber when the known voltage is applied,
wherein a concentration of a foreign matter present in the conductive solution is determinable from the known volume, the known voltage, and the current magnitude measured by the amperage meter.

36. A method of determining a concentration of a foreign matter present within a conductive solution, comprising:
providing a conductive solution to a test chamber, the test chamber having a known volume,
providing a voltage source to apply a known voltage across the test chamber,
providing probes within the test chamber to contact the conductive solution,
providing an amperage meter, connected to the probes provided in contact with the conductive solution, for measuring a magnitude of current flowing through the conductive solution,
calculating a resistance of the conductive solution from the known volume, known voltage, and the measured current magnitude, and
converting the resistance to a concentration of the foreign matter present within the conductive solution.

37. The method according to claim 36, further comprising:
controlling the concentration of the foreign matter present by adding an electrolyte or water to the conductive solution to reach a desired concentration.

38. An internal combustion engine, comprising:
a combustion chamber including,
a hydrogen injector,
an oxygen injector,
a water ejector, and
a spark plug configured to initiate combustion of a mixture of hydrogen and oxygen in the combustion chamber.

39. The internal combustion engine of claim 38, wherein the hydrogen injector and the oxygen injector are fluidly connected to a hydrogen and oxygen production unit.

40. The internal combustion engine of claim 38, wherein at least one of the hydrogen injector and the oxygen injector are fluidly coupled to a supply plenum.

41. The internal combustion engine of claim 38, wherein the hydrogen injector and the oxygen injector include check valves.

42. The internal combustion engine of claim 38, wherein the hydrogen injector and the oxygen injector include discharge orifices that are sized to provide a desired ratio of hydrogen to oxygen in the combustion chamber.

43. The internal combustion engine of claim 42, wherein the desired ratio is approximately 2 to 1 hydrogen to oxygen.

44. The internal combustion engine of claim 38, further including a piston assembly that forms a plurality of said combustion chambers.

45. The internal combustion engine of claim 38, where the plurality of combustion chambers includes three combustion chambers.

46. The internal combustion engine of claim 45, wherein two of the three combustion chambers are formed on opposite sides of a piston head of the piston assembly.

47. The internal combustion engine of claim 46, wherein the piston head is a first piston head, and a remaining one of the combustion chambers includes a second piston head of the piston assembly, the first and second piston heads being mechanically connected to one another.

48. The internal combustion engine of claim 38, further including a plurality of combustion chambers, each of the combustion chambers including a separate piston assembly connected to a common crankshaft.

49. The internal combustion engine of claim 38, wherein the engine is a prime mover for a mobile machine.

50. The internal combustion engine of claim 38, wherein the engine is coupled to a generator for creating electricity.

51. An internal combustion engine method, comprising:
supplying hydrogen to a combustion chamber,
supplying oxygen to a combustion chamber, and
initiating combustion of a mixture of only hydrogen and oxygen supplied to the combustion chamber.

52. The internal combustion engine method of claim 51, further including ejecting one or more of water or water vapors from the combustion chamber, the water or water vapors formed from combustion of the hydrogen and oxygen in the combustion chamber.

53. The internal combustion engine method of claim 51, wherein supplying the hydrogen and oxygen to the combustion chamber includes supplying in an amount that provides for the formulation of water after combustion of the mixture.

54. The internal combustion engine method of claim 51, wherein the initiation of combustion includes providing a spark in the combustion chamber.

55. The internal combustion engine method of claim 51, wherein the combustion chamber is a first combustion chamber, and the method further includes providing hydrogen and oxygen to a second combustion chamber of the engine, and initiating combustion of a mixture of only hydrogen and oxygen supplied to the second combustion chamber.

56. The internal combustion engine method of claim 55, wherein the initiation of combustion in the first and second combustion chamber are substantially simultaneous.

57. The internal combustion engine method of claim 56, wherein the combustion in the first and second combustion chambers applies a force in the same direction a same piston assembly.

58. The internal combustion engine method of claim 57, further including providing hydrogen and oxygen to a third combustion chamber of the engine, and initiating combustion of a mixture of only hydrogen and oxygen supplied to the third combustion chamber to apply an opposite force to the piston assembly.

59. The internal combustion engine method of claim 51, further including providing motive power to a mobile machine based on power from the internal combustion engine.

60. The internal combustion engine method of claim 51, further including converting motive power from the engine to electrical power.

61. A combustion chamber fluid pump, comprising:
a combustion chamber having a fluid provided therein,
a supply tube for providing a combustible gas within the combustion chamber,
an ignition source for igniting the gas provided to the combustion chamber,
a neck portion in communication with the combustion chamber and having a first and a second check valve,
the first check valve for coupling to a fluid supply to supply fluid to the neck portion via the first check valve and thereby supply fluid to the combustion chamber, and
the second check valve for coupling to a fluid reservoir for receiving fluid flowing through the neck portion from the combustion chamber when combustible gas is provided in the combustion chamber and ignited.

62. A combustion chamber fluid pump according to claim 61, further comprising a baffle provided to divide the neck portion, wherein the first and second check valves are provided on a same side of the divided neck portion.

63. A method of operating a combustion chamber fluid pump, comprising:
providing a fluid within a combustion chamber,
providing a combustible gas to the combustion chamber,
providing an ignition source for igniting the combustible gas in the combustion chamber,
igniting the gas to produce a heat wave that forces fluid through a neck portion attached to the combustion chamber and further through a first one-way valve to a fluid reservoir, and
providing fluid from a fluid supply to the combustion chamber via a second one-way valve.

64. A desalinization unit, comprising,
a first electrode and a second electrode for receiving a voltage applied there across,
a tap to provide a supply of sea water between the first and second electrodes, wherein the sea water is capable of providing a conductive path between the first and second electrodes, and
a collector for collecting matter precipitated out of the sea water when the voltage is applied across the first and second electrodes, wherein the collector is a removable portion of the unit.

65. A method of operating a unit for removing foreign matter from a conductive solution, comprising,
providing a first electrode and a second electrode capable of receiving a voltage,
providing a conductive solution containing between the first and second electrodes, wherein the solution provides a conductive path between the first and second electrodes,
applying a voltage across the first and second electrodes,
precipitating out the foreign matter within the solution by electrolyzing the solution due to the voltage applied across the first and second electrodes, and
collecting the foreign matter from the unit.

66. A method according to claim 65, wherein the foreign matter is a mineral.

67. A method according to claim 65, wherein the conductive solution is non-potable water, the method further comprising:
providing hydrogen and oxygen resulting from the electrolyzation of the non-potable water to a chamber, and
combusting the hydrogen and oxygen to form water.

68. A hydrogen filling station, comprising:
a unit capable of producing on demand hydrogen including:
a plurality of anode-cathode electrode pairs,
a conductive solution confined between the plurality of electrode pairs and providing a conductive path therebetween, and
a voltage supply for supplying a voltage across the electrode pairs to electrolyze the solution and produce on demand hydrogen, and
a filling means coupled to the unit for receiving hydrogen produced by the unit.

69. A method of producing a nitrogen rich compound, comprising:
operating an electrolysis unit to produce hydrogen,
providing hydrogen and air to an engine,
combusting the hydrogen and air within the engine,
capturing an exhaust from the engine, and
extracting the nitrogen rich compound from the exhaust.

70. An oxygen generator, comprising:
a fuel cell,
a unit capable of electrolyzing a conductive solution, and
an oxygen line,
wherein the fuel cell is configured to provide electricity to the unit and the unit is configured to provide hydrogen to the fuel cell and oxygen to the oxygen line.

71. A method for operating an oxygen generator, comprising:
configuring a unit capable of electrolyzing a conductive solution to produce hydrogen and oxygen,
supplying a fuel cell with the hydrogen produced by the unit and configuring the fuel cell to provide electrical power to the unit, and
providing oxygen from the unit to an oxygen line.

72. A system for load leveling an electrical grid, comprising:
a controller, and
a unit configured to store hydrogen and oxygen and capable of supplying power when the hydrogen and oxygen recombine,
wherein the controller is connected to the grid and the unit and the controller directs power to the unit when demand on the grid is low.

73. A method for operating a system for load leveling an electrical grid, comprising:
monitoring an electrical demand on the grid,
directing power to a unit capable of electrolyzing and storing hydrogen and oxygen when a demand on the grid is low, and
supplying power to the grid from the unit when demand on the grid is high.

74. A system, comprising:
a unit configured to produce electrical power using stored hydrogen and oxygen, and
a power supply configured to provide power to the unit.

75. The system according to claim 74, wherein the power supply is an alternative energy power supply.

76. The system according to claim 74, further comprising:
a generator capable of providing supplemental power to the unit.

77. The system according to claim 74, wherein the unit is a first unit, the system further comprising:
a second unit configured to produce hydrogen and oxygen, and
a load capable of receiving hydrogen and oxygen,
wherein the first unit provides electrical power to the second unit.

78. The system according to claim 77, wherein the load is a combined engine and alternator for producing power.

79. The system according to claim 77, wherein the load is a chamber capable of receiving and combusting hydrogen and oxygen to form water.

80. The system according to claim 77, wherein the load is a storage means to receive and store hydrogen and oxygen.

81. A method of operating a system, comprising:
configuring a first unit to produce electrical power by reverse electrolysis of stored hydrogen and oxygen,
supplying power to the first unit from a power supply and storing power therein,
configuring a second unit to produce hydrogen and oxygen,
powering the second unit using power stored by the first unit, and
providing hydrogen and oxygen from the second unit to a load.

82. An impact accelerator, comprising:
a housing including:
a combustion chamber including:
a hydrogen injector, and
an oxygen injector, and
a reciprocating hammer, and
an anvil located at an end of the housing to receive an impact from the hammer resulting from combustion of hydrogen and oxygen provided to the combustion chamber by the hydrogen and oxygen injectors.

83. An impact accelerator of claim 82, further including a spark plug extending into the combustion chamber.

84. An impact accelerator of claim 82, further including a water ejector selectively fluidly coupled to the combustion chamber.

85. An impact accelerator of claim 82, wherein the hydrogen injector and the oxygen injector are fluidly connected to a hydrogen and oxygen production unit.

86. An impact accelerator of claim 82, wherein at least one of the hydrogen injector and the oxygen injector are fluidly coupled to a supply plenum.

87. An impact accelerator of claim 82, wherein the housing is cylindrical and the hydrogen and oxygen injectors are located at one end portion of the cylindrical housing, and the anvil is located at an opposite end portion of the cylindrical housing.

88. A method of operating an impact accelerator, comprising:
providing a housing including:
a combustion chamber including an end plate, the end plate having openings for a hydrogen injector for providing hydrogen, and an oxygen injector for providing oxygen,
a reciprocating hammer, and
an anvil located to receive an impact from the hammer,
combusting hydrogen and oxygen in the combustion chamber in a manner to cause the hammer to impact the anvil, and
injecting hydrogen and oxygen after the hammer impacts the anvil to prevent the hammer from striking the end plate.

89. An accelerator generator, comprising:
a housing including:
a first combustion chamber including,
a first hydrogen injector, and
a first oxygen injector, and
a second combustion chamber including,
a second hydrogen injector, and
a second oxygen injector,
a reciprocating hammer capable of magnetically coupling, and
a toroidal coil located to magnetically couple with the reciprocating hammer such that an electrical output is produced when the hammer is forced through the toroidal coil by combustion occurring in the first and second combustion chambers.

90. A method of operating an accelerator generator, comprising:
providing a housing including:
a first combustion chamber including:
a first hydrogen injector, and
a first oxygen injector, and
a second combustion chamber including:
a second hydrogen injector, and
a second oxygen injector,
providing a reciprocating hammer capable of magnetically coupling within the housing between the first and second chamber, and
providing a toroidal coil, such that the coil is magnetically coupled with the hammer when the hammer passes through the coil,
providing hydrogen and oxygen within the first combustion chamber, and
igniting the hydrogen and oxygen to propel the hammer towards the second combustion chamber and through the coil to produce electricity within the coil.

91. An impact accelerator generator, comprising:
a housing including:
a combustion chamber including:
a hydrogen injector, and
a oxygen injector, and
a second combustion chamber including:
a second hydrogen injector, and
a second oxygen injector,
a reciprocating hammer capable of magnetically coupling, and
a toroidal coil located to magnetically couple with the reciprocating hammer such that an electrical output is produced by the coil when the hammer is forced through the toroidal coil by combustions occurring in the first and second combustion chambers.

92. A method of operating an impact accelerator generator, comprising:
providing a housing including:
a combustion chamber including:
a hydrogen injector, and
an oxygen injector, and
a reciprocating hammer capable of magnetically coupling, and
providing a toroidal coil, such that the coil is magnetically coupled with the hammer when the hammer passes through the coil,
providing hydrogen and oxygen within the combustion chamber, and
igniting the hydrogen and oxygen to propel the hammer through the coil to produce electricity within the coil.

93. A capacitor, comprising:
a plurality of electrodes,
a conductive solution providing a conductive path between the plurality of electrodes, and
a first terminal and a second terminal providing a voltage across the plurality of electrodes.

94. A capacitor according to claim 93, wherein at least one of the plurality of electrodes is comprised of carbon.

95. A capacitor according to claim 93, wherein the conductive solution comprises water and an electrolyte.

96. A capacitor according to claim 95, wherein the electrolyte is NaCl.

97. A capacitor according to claim 93, wherein the capacitor is an electrolysis unit.

98. A cell for use in a unit for producing a gas, comprising:
a back wall,
a side wall extending upwardly from and around a periphery of the back wall to define an inner region of the cell,
a first electrode and a second electrode each disposed in the back wall and within the inner region, the first electrode being spaced apart from the second electrode,
a first ridge disposed on the back wall and extending from an end portion of the first ridge,
a second ridge disposed on the back wall and extending from an end portion of the second ridge, the first ridge being spaced apart from the second ridge.

99. An electrode for use in an electrolysis unit, the unit including a plurality of electrodes arranged in sequence, the electrode comprising:
an electrode body having first and second adjacent through holes formed therein for passage therethrough of a fluid contained, and
a notch communicating between one of the holes and an edge of the body for receiving the fluid.

100. An electrical insulator for use in an electrolysis unit, the unit including at least two electrodes in contact with and separated by the insulator, each of the two electrodes having first and second adjacent through holes formed therein, the insulator comprising:
an insulator body having a cross section generally corresponding to a cross section of the electrodes and having left side and right side portions,
wherein the insulator body includes at least one pass-through orifice in one of the left side and right side portions and no pass-through orifice in the other of the left side and right side portions.

101. A voltage doubler circuit, comprising:
a transformer including a primary winding and a secondary winding,
a first rectifier having first and second input terminals and positive and negative output terminals,
a second rectifier having first and second input terminals and positive and negative output terminals;
a first capacitor having first and second ends;
a second capacitor having first and second ends;
a third capacitor having first and second ends;
a fourth capacitor having first and second ends;
the second end of the first capacitor coupled to the first end of the second capacitor and to a second end of the transformer primary winding and the second input terminal of the first rectifier, the second end of the third capacitor coupled to the first end of the fourth capacitor and to a first end of the transformer secondary winding and the second input terminal of the second rectifier;
a first end of the transformer primary winding for coupling to a first terminal of an AC input line and the first input terminal of the first rectifier for coupling to a second terminal of the AC input line;
the first end of the first capacitor and the second end of the second capacitor respectively coupled to the positive and negative output terminals of the first rectifier;
the first end of the third capacitor and the second end of the fourth capacitor respectively coupled to the positive and negative output terminals of the second rectifier,
an electrolysis device having positive and negative terminals;
a first diode being forward conductive from an anode terminal to a cathode terminal, the first diode cathode coupled to the positive terminal of the electrolysis device and the first diode anode coupled to the first end of the first capacitor and the positive terminal of the first rectifier; and
a second diode being forward conductive from an anode terminal to a cathode terminal, the second diode cathode coupled to the positive terminal of the electrolysis device and the second diode anode coupled to the first end of the third capacitor and the positive terminal of the second rectifier.

102. A driver circuit for driving electrolysis devices, comprising:
a first transformer including a primary winding and a secondary winding;
a second transformer including a primary winding and a secondary winding;
a first rectifier having first and second input terminals and positive and negative output terminals;
a second rectifier having first and second input terminals and positive and negative output terminals;
an electrical load having first and second terminals;
an electrolysis device having positive and negative terminals;
the first and second inputs of the first rectifier coupled between first and second ends of the first transformer secondary winding, respectively;
the first and second inputs of the second rectifier coupled between first and second ends of the second transformer secondary winding, respectively;
a first diode being forward conductive from an anode terminal to a cathode terminal, the first diode anode terminal for coupling to a first terminal of an AC power supply, the first diode cathode terminal coupled to a first end of the first transformer primary winding;
a second diode being forward conductive from an anode terminal to a cathode terminal;
a third diode being forward conductive from an anode terminal to a cathode terminal, the third diode cathode terminal coupled to the electrical load second terminal, the third diode anode terminal coupled to a second end of the first transformer primary winding and the anode of the second diode, the cathode of the second diode coupled to the first end of the first transformer primary winding;
a fourth diode being forward conductive from an anode terminal to a cathode terminal, the cathode terminal of the fourth diode for coupling to the first terminal of the AC power supply, the anode terminal of the fourth diode coupled to a first end of the second transformer primary winding;
a fifth diode being forward conductive from an anode terminal to a cathode terminal;
a sixth diode being forward conductive from an anode terminal to a cathode terminal, the cathode terminal of the sixth diode coupled to a second end of the second transformer primary winding and to the cathode terminal of the fifth diode, the anode terminal of the sixth diode coupled to the second terminal of the electrical load, the anode terminal of the fifth diode coupled to the first end of the second transformer primary winding;
the first terminal of the electrical load for coupling to a second terminal of the AC power supply; and
the positive and negative terminals of the second electrolysis device respectively coupled to the first rectifier positive output terminal and the second rectifier negative output terminal.

103. An impact accelerator method, comprising:
supplying hydrogen to a combustion chamber;
supplying oxygen to a combustion chamber;
initiating combustion of a mixture of the hydrogen and oxygen supplied to the combustion chamber to force a hammer element against an anvil of the impact accelerator.

104. The impact accelerator method of claim 103, further including ejecting one or more of water or water vapors from the combustion chamber, the water or water vapors formed from combustion of the hydrogen and oxygen in the combustion chamber.

105. The impact accelerator method of claim 103, wherein supplying the hydrogen and oxygen to the combustion chamber includes supplying in an amount that provides for the formulation of water after combustion of the mixture.

106. The impact accelerator method of claim 103, wherein the initiation of combustion includes providing a spark in the combustion chamber.

107. A combustion chamber pump method, comprising:
supplying at least one combustible fluid to a combustion chamber; and
initiating combustion of the combustible fluid supplied to the combustion chamber to force pumping fluid out of a pumping chamber.

108. The combustion chamber pump method of claim 107, wherein the supplying of at least one combustible fluid to the combustion chamber includes supplying hydrogen and oxygen only to the combustion chamber.

109. The combustion chamber pump method of claim 108, wherein supplying the hydrogen and oxygen to the combustion chamber includes supplying in an amount that provides for the formulation of water after combustion of the mixture.

110. The combustion chamber pump method of claim 107, wherein the pumping fluid is water.

111. The combustion chamber pump method of claim 107, wherein the initiation of combustion includes providing a spark in the combustion chamber.

112. A combustion chamber pump, comprising:
a combustion chamber including
at least one working fluid inlet, and
an ignition source; and
a pumping chamber including
a pumping fluid inlet; and
a pumping fluid outlet.

113. The combustion chamber pump of claim 112, wherein the at least one working fluid inlet includes a first working fluid inlet and a second working fluid inlet.

114. The combustion chamber pump of claim 113, wherein the first working fluid inlet is coupled to a hydrogen supply, and the second working fluid inlet is coupled to an oxygen supply.

115. The combustion chamber pump of claim 112, wherein the pumping fluid inlet is coupled to a water supply.

116. The combustion chamber pump of claim 112, wherein the pumping fluid inlet includes a one way valve allowing pumping fluid into the pumping chamber, and the pumping fluid outlet includes a one way valve allowing pumping fluid to exit the pumping chamber.

117. The combustion chamber pump of claim 112, wherein the combustion chamber is separated from the pumping chamber by the interface between the working fluid and the pumping fluid.

118. The combustion chamber pump of claim 112, further including a pump housing having a neck portion, the neck portion forming at least a portion of the pumping chamber.

119. A combustion chamber pump method, comprising:
supplying at least one combustible fluid to a combustion chamber; and
initiating combustion of the combustible fluid supplied to the combustion chamber to force pumping fluid out of a pumping chamber.

120. The combustion chamber pump method of claim 119, wherein the supplying of at least one combustible fluid to the combustion chamber includes supplying hydrogen and oxygen only to the combustion chamber.

121. The combustion chamber pump method of claim 119, wherein supplying the hydrogen and oxygen to the combustion chamber includes supplying in an amount that provides for the formulation of water after combustion of the mixture.

122. The combustion chamber pump method of claim 119, wherein the pumping fluid is water.

123. The combustion chamber pump method of claim 119, wherein the initiation of combustion includes providing a spark in the combustion chamber.
